(19) United States
(12) Patent Application Publication
(10) Pub. No.: US 2026/0230648 A1
(43) Pub. Date: Aug. 6, 2026

(54) METHOD FOR ENCODING, METHOD FOR DECODING, AND STORAGE MEDIUM

(71) Applicant: GUANGDONG OPPO MOBILE TELECOMMUNICATIONS CORP., LTD., Dongguan (CN)

(72) Inventor: Fan WANG, Dongguan (CN)

(73) Assignee: GUANGDONG OPPO MOBILE TELECOMMUNICATIONS CORP., LTD., Dongguan (CN)

(21) Appl. No.: 19/629,770

(22) Filed: Mar. 26, 2026

Related U.S. Application Data
(63) Continuation of application No. PCT/CN2023/122976, filed on Sep. 28, 2023.

(51) Int. Cl. H04N 19/60; H04N 19/107; H04N 19/124; H04N 19/176; H04N 19/184; H04N 19/70; H04N 19/82

(52) U.S. Cl. CPC H04N 19/60; H04N 19/107; H04N 19/124; H04N 19/176; H04N 19/184; H04N 19/70; H04N 19/82

(57) ABSTRACT

A method for decoding includes: a prediction mode of a current block is determined; at least one context model is determined according to the prediction mode of the current block; a bitstream is decoded according to the at least one context model to determine a bin string of the current block, where the bin string includes at least one binary symbol; inverse binarization processing is performed on the bin string to determine a value of first syntax identification information; and when the first syntax identification information indicates that the current block uses a first transform mode, a transform kernel of the current block is determined, and inverse transform is performed on transform coefficients of the current block according to the transform kernel to determine a residual block of the current block.

### CROSS REFERENCE TO RELATED APPLICATION

This is a continuation of International Application No. PCT/CN2023/122976 filed on Sep. 28, 2023, the disclosure of which is hereby incorporated by reference in its entirety.

### TECHNICAL FIELD

Embodiments of the present disclosure relate to the technical field of video encoding and decoding, and particularly relate to a method for encoding, a method for decoding, and a storage medium.

### BACKGROUND

With the improvement of people's requirements for video display quality, high-resolution videos such as high-definition and ultra-high-definition videos have emerged. However, high-resolution videos typically contain more information and therefore require more bandwidth. To reduce bandwidth requirements, video coding standards involving video compression have been introduced.

Intra prediction and inter prediction are included in video coding standards. Where intra prediction predicts the current block based on the reconstructed pictures around the current block, while inter prediction predicts the current block based on pictures of the same object at different times. The statistical rules of the residuals between the two are different, which leads to low compression efficiency, although Low Frequency Non-Separable Transform (LFNST) or Non-Separable Primary Transform (NSPT) can be used in the transform process.

### BRIEF DESCRIPTION OF THE DRAWINGS

FIG. 1 is a schematic flowchart of a hybrid coding framework.

FIG. 2 is a schematic structural diagram of a Group Of Pictures (GOP).

FIG. 3A is a schematic diagram of a block partitioning structure.

FIG. 3B is another schematic diagram of a block partitioning structure.

FIG. 3C is yet another schematic diagram of a block partitioning structure.

FIG. 4 is a schematic diagram of a spatial/temporal block position relationship of a current block.

FIG. 5 is a schematic diagram of motion information of a current block and a co-located block.

FIG. 6 is a schematic diagram of a motion shift using a co-located reference picture.

FIG. 7 is a schematic diagram of a distribution using MVD characteristics.

FIG. 8A is a schematic diagram of an affine motion using two control points.

FIG. 8B is a schematic diagram of an affine motion using three control points.

FIG. 9 is a schematic diagram of an affine motion of deriving motion vectors based on sub-blocks.

FIG. 10 is a schematic diagram of multiple mode weights in a GPM mode.

FIG. 11 is a schematic diagram of a bilateral matching motion information.

FIG. 12 is a schematic diagram of template matching of a current block.

FIG. 13 is a schematic diagram of a reference sample of a current block.

FIG. 14 is a schematic diagram of multiple reference lines of a current block.

FIG. 15 is a first schematic diagram of multiple prediction modes corresponding intra prediction.

FIG. 16 is a second schematic diagram of multiple prediction modes corresponding intra prediction.

FIG. 17 is a third schematic diagram of multiple prediction modes corresponding intra prediction.

FIG. 18 is a fourth schematic diagram of multiple prediction modes corresponding intra prediction.

FIG. 19 is a schematic diagram of screen content encoding.

FIG. 20 is a schematic bar diagram of a gradient and intra prediction mode.

FIG. 21 is a schematic diagram of a weighted merge of three intra prediction modes.

FIG. 22 is a schematic diagram of reference samples of a chroma component and a luma component.

FIG. 23 is a schematic diagram of grouping of a multi-model CCLM.

FIG. 24 is a schematic diagram of prediction of a multi-model CCLM.

FIG. 25 is a schematic diagram of a reference area of an intra-CCCM.

FIG. 26 is a schematic diagram illustrating a luma gradient calculation of a GLM.

FIG. 27 is a schematic diagram of prediction of an inter-CCCM.

FIG. 28 is a schematic diagram of DCT transform.

FIG. 29 is a schematic diagram of a base picture of a DCT transform.

FIG. 30 is a schematic flowchart without LFNST transform.

FIG. 31 is a schematic flowchart with LFNST transform.

FIG. 32 is a detailed schematic flowchart with LFNST transform.

FIG. 33 is a schematic diagram of a base picture of multiple transform kernel sets.

FIG. 34 is a schematic diagram of a base picture of NSPT transform.

FIG. 35 is a schematic diagram of a structure in which luma and chroma are separately partitioned.

FIG. 36 is a schematic diagram of network architecture of video encoding and decoding according to an embodiment of the present disclosure.

FIG. 37 is a schematic block diagram of a system composition of an encoder according to an embodiment of the present disclosure.

FIG. 38 is a schematic block diagram of a system composition of a decoder according to an embodiment of the present disclosure.

FIG. 39 is a first schematic flowchart of a method for decoding according to an embodiment of the present disclosure.

FIG. 40 is a schematic diagram of a statistical result of lfnst_nspt_idx corresponding to an intra prediction mode according to an embodiment of the present disclosure.

FIG. 41 is a schematic diagram of a statistical result of lfnst_nspt_idx corresponding to an inter prediction mode according to an embodiment of the present disclosure.

FIG. 42A is a schematic diagram of a single texture feature according to an embodiment of the present disclosure.

FIG. 42B is another schematic diagram of a single texture feature according to an embodiment of the present disclosure.

FIG. 42C is a schematic diagram of a bidirectional texture feature according to an embodiment of the present disclosure.

FIG. 43 is a second schematic flowchart of a method for decoding according to an embodiment of the present disclosure.

FIG. 44 is a third schematic flowchart of a method for decoding according to an embodiment of the present disclosure.

FIG. 45 is a fourth schematic flowchart of a method for decoding according to an embodiment of the present disclosure.

FIG. 46 is a first schematic flowchart of a method for encoding according to an embodiment of the present disclosure.

FIG. 47 is a second schematic flowchart of a method for encoding according to an embodiment of the present disclosure.

FIG. 48 is a schematic block diagram of signalling a syntax element value in a bitstream according to an embodiment of the present disclosure.

FIG. 49 is a schematic block diagram of decoding a syntax element value from a bitstream according to an embodiment of the present disclosure.

FIG. 50 is a schematic structural diagram of an encoder according to an embodiment of the present disclosure.

FIG. 51 is a schematic diagram of a hardware structure of an encoder according to an embodiment of the present disclosure.

FIG. 52 is a schematic structural diagram of a decoder according to an embodiment of the present disclosure.

FIG. 53 is a schematic diagram of a hardware structure of a decoder according to an embodiment of the present disclosure.

FIG. 54 is a schematic structural diagram of an encoding and decoding system according to an embodiment of the present disclosure.

### DETAILED DESCRIPTION

In order to understand characteristics and technical contents of the embodiments of the disclosure more thoroughly, implementations of the embodiments of the disclosure will be described in detail below with reference to the drawings. The drawings are only for the purpose of reference and explanation, and are not intended to limit the embodiments of the disclosure.

Unless otherwise defined, all technical and scientific terms used here have the same meanings as those usually understood by technicians in the technical field to which the disclosure belongs. The terms used here are only for the purpose of describing the embodiments of the disclosure, and are not intended to limit the disclosure.

In the following descriptions, reference is made to “some embodiments” which describe a subset of all possible embodiments; however, it may be understood that “some embodiments” may be the same or different subsets of all possible embodiments, and may be combined with each other without conflict.

It should also be pointed out that terms “first\second\third” involved in the embodiments of the disclosure are only intended to distinguish similar objects and do not represent a specific sequence of the objects. It may be understood that “first\second\third” may be interchanged in a specific order or sequence if allowable, such that the embodiments of the disclosure described here may be implemented in an order besides that illustrated or described here.

It may be understood that in a video picture, a Coding Block (CB) is usually characterized by using a first colour component, a second colour component, and a third colour component. The three colour components are a luma component, a blue chroma component, and a red chroma component respectively. Specifically, the luma component is usually represented by a symbol Y, the blue chroma component is usually represented by a symbol Cb or U, and the red chroma component is usually represented by a symbol Cr or V; in this way, the video picture may be represented in a YCbCr format or a YUV format.

Nouns and terms involved in the embodiments of the disclosure are described first before further describing the embodiments of the disclosure in detail. The nouns and terms involved in the embodiments of the disclosure are applicable to the following explanations:
H.265/High Efficiency Video Coding (HEVC);
H.266/Versatile Video Coding (VVC);
VVC Test Model (VTM), a reference software testing platform for VVC;
Enhanced Compression Model (ECM), a platform for improving compression performance beyond VVC;
Joint Video Experts Team (JVET);
Coding Unit (CU);
Coding Tree Unit (CTU);
Largest Coding Unit (LCU);
Motion Vector (MV);
Prediction Unit (PU);
Transform Unit (TU);
Merge;
Skip;
Quantization Parameter (QP);
Merge with Motion Vector Difference (MMVD);
Motion Vector Prediction (MVP);
Temporal Motion Vector Prediction (TMVP);
Subblock-based Temporal Motion Vector Prediction (SbTMVP);
Discrete Cosine Transform (DCT);
Discrete Sine Transform (DST);
Multiple Transform Selection (MTS);
Low Frequency Non-Separable Transform (LFNST);
Non-Separable Primary Transform (NSPT);
Context-based Adaptive Binary Arithmetic Coding (CABAC).

At present, general video encoding and decoding standards adopt a block-based hybrid coding framework. Each picture or sub-picture or frame in a video is partitioned into largest coding units or coding tree units of squares of the same size (such as 256×256, 128×128, 64×64, etc.). Each largest coding unit or coding tree unit may be partitioned into rectangular coding units according to rules. The coding unit may be further partitioned into prediction units, transform units, and the like. The hybrid coding framework includes a Prediction module, a Transform/Quantization module, a Entropy Coding module, a Inverse Quantization/Inverse Transform module, a In Loop Filter module and other modules. The prediction module may include Intra Prediction and Inter Prediction, and the Inter Prediction may include Motion Estimation and Motion Compensation. Because there is a strong correlation between neighbouring samples one picture of the video, the spatial redundancy between the neighbouring samples can be eliminated by using the intra prediction method in video encoding and decoding technologies. In addition, due to the strong similarity between neighbouring pictures in the video, the temporal redundancy between the neighbouring pictures is eliminated by using the inter prediction method in video encoding and decoding technologies, so that the coding efficiency can be improved.

The basic flow of the video codec is as follows: at the encoding end, a picture is partitioned into blocks, intra prediction or inter prediction is performed on the current block to generate a prediction block of the current block, the prediction block is subtracted from the original block of the current block to obtain a residual block, the residual block is transformed and quantized to obtain a quantization coefficient matrix, and the quantization coefficient matrix is entropy encoded and output to a bitstream. At the decoding end, intra prediction or inter prediction is performed on the current block to generate a prediction block of the current block, on the other hand, a bitstream is parsed to obtain a quantization coefficient matrix, the quantization coefficient matrix is inversely quantized and inversely transformed to obtain a residual block, and the prediction block and the residual block are added to obtain a reconstructed block. The reconstructed block constitutes a reconstructed picture, and picture-based or block-based in loop filtering is performed on the reconstructed picture to obtain a decoded picture. The encoding end also needs similar operations as the decoding end to obtain the decoded picture. The decoded picture may be used as a reference picture for inter prediction for subsequent pictures. Block partitioning information, as well as mode information or parameter information such as prediction information, transform information, quantization information, entropy coding information, in-loop filtering information, etc. determined by the encoding end need to be output to the bitstream if necessary. The decoding end, by parsing the bitstream and analyzing existing information, determines the same block partitioning information, as well as mode information or parameter information such as prediction information, transform information, quantization information, entropy coding information, in-loop filtering information, etc. as those at the encoding end, so as to ensure that the decoded picture obtained by the encoding end is the same as the decoded picture obtained by the decoding end. The decoded picture obtained by the encoding end is usually referred to as the reconstructed picture. The current block may be partitioned into prediction units during predicting, the current block may be partitioned into transform units during transforming, and the partitioning of the prediction unit and the transform unit may be different. The above is the basic flow of the video codec under the block-based hybrid coding framework. With the development of the technology, some modules or steps of the framework or the flow may be optimized. The embodiments of the present disclosure are applicable to, but are not limited to, the basic flow of the video codec under the block-based hybrid coding framework.

In addition, in the embodiments of the present disclosure, the Current Block (CB) may be a current coding unit, a current prediction unit, a current transform unit, or the like. Due to the needs of parallel processing, a picture can be partitioned into slices, etc. The slices in the same picture can be processed in parallel, that is to say, there is no data dependence between them. The term “frame” is a common expression, generally understood as one frame being one picture. The frame described in the embodiments of the present disclosure may also be replaced with a picture, a slice, or the like.

It is understood that within prediction techniques, intra prediction and inter prediction will be described in detail separately below.

### (1) Inter Prediction.

Inter prediction uses temporal correlation to eliminate redundancy. To avoid perceptible stuttering, typical video frame rates are 30 frames per second, 50 frames per second, 60 frames per second, or even 120 frames per second. In such a video, the correlation between neighbouring frames in the same scene is high, and the inter-prediction technology uses this correlation to predict the content to be encoded currently with reference to the content of the already encoded/decoded frames. Inter prediction can greatly improve the coding performance.

The most basic inter-prediction method is translational prediction. Translational prediction assumes that the content to be predicted undergoes translational motion between the current picture and the reference picture. For example, if the content of the current block (coding unit or prediction unit) undergoes translational motion between the current picture and the reference picture, then this content can be found from the reference picture through a motion vector and used as the prediction block of the current block. Translational motion accounts for a large proportion in the video, and the stationary background, the overall translational object and the translation of the lens can all be processed by translational prediction.

Some contents in the natural video are not simply translational. For example, there may be subtle changes during translation, including changes in shape, colour, etc. Bidirectional prediction finds two reference blocks from the reference picture and weighted averages the two reference blocks to obtain a prediction block as similar as possible to the current block. For some scenes, finding one reference block from the front and one from the back of the current frame for weighted averaging may result in a better match to the current block than a single reference block. Based on this, bidirectional prediction further improves the compression performance over unidirectional prediction.

The Picture Order Count (POC) can be used as an identifier of the picture. In a video sequence, each picture has a unique POC, and in the embodiments of the present disclosure, it is considered that the order of the POC and the playback order are the same. A P picture (P Frame) is a picture that can only be predicted using a reference picture whose POC is before the current picture. The current reference picture has only one Reference Picture List (RPL), denoted as RPL0. The reference picture list RPL0 contains only reference pictures whose POC is before the current picture. A B picture (B frame) could originally be predicted using reference pictures whose POC is before the current picture and reference pictures whose POC is after the current picture. The B picture has two reference picture lists, denoted RPL0 and RPL1. One configuration method is that RPL0 contains only reference pictures whose POC is before the current picture, and RPL1 contains only reference pictures whose POC is after the current picture. For a current block, it may reference only a reference block of a certain picture in RPL0, which is also called forward prediction; it may reference only a reference block of a certain picture in RPL1, which is also called backward prediction; or it may simultaneously reference a reference block of a certain picture in RPL0 and a reference block of a certain picture in RPL1, which is also called bidirectional prediction. A simple method of referencing two reference blocks simultaneously is to average the samples at the corresponding position of each of the two reference blocks to obtain the prediction block of the current block. Later, the B picture was no longer restricted to having RPL0 contain only reference pictures whose POC is before the current picture and RPL1 contain only reference pictures whose POC is after the current picture. Therefore, RPL0 may also contain reference pictures whose POC is after the current picture, and RPL1 may also contain reference pictures whose POC is before the current picture. The current block may also simultaneously refer to reference pictures whose POC is before the current picture and reference pictures whose POC is after the current picture. Such B picture is also called a generalized B picture.

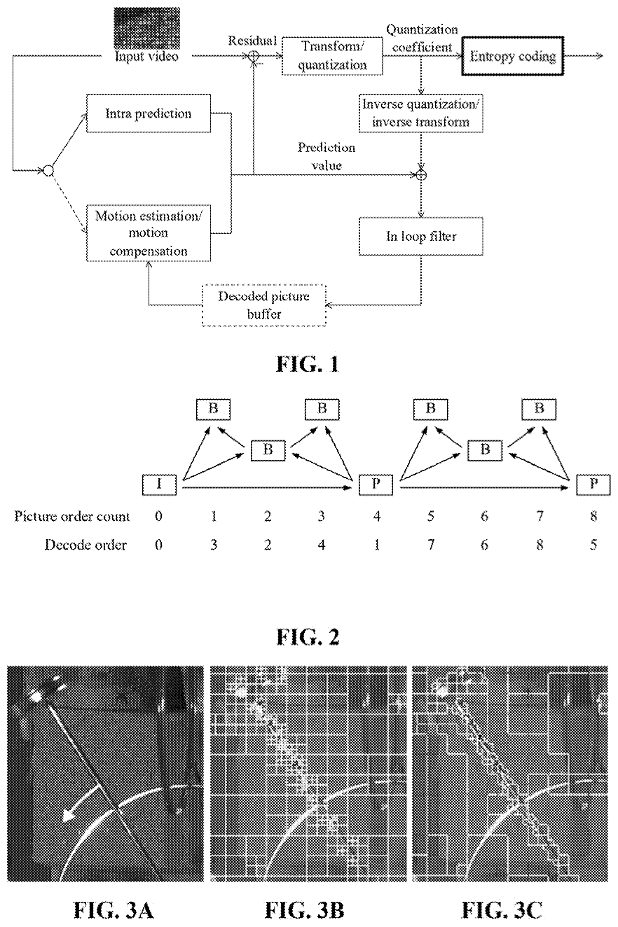

Because the encoding and decoding order of Random Access (RA) configuration is different from the POC order. In this way, the B picture can refer to the information before the current picture and the information after the current picture, thereby obviously improving the coding performance. Exemplarily, a classical GOP structure of RA is shown in FIG. 2. In FIG. 2, an arrow indicates a reference relationship, and since an I picture does not need a reference picture, a P picture having a POC of 4 will be decoded after an I picture having a POC of 0 is decoded, and an I picture having a POC of 0 may be referred to when decoding a P picture having a POC of 4. After the P picture having a POC of 4 is decoded, then the B picture having a POC of 2 is decoded, while the I picture having a POC of 0 and the P picture having a POC of 4 may be referred to when decoding the B picture having a POC of 2, and so on. In this way, according to FIG. 2, when the POC order is {0 1 2 3 4 5 6 7 8}, the corresponding decoding order is {0 3 2 4 1 7 6 8 5}.

The encoding and decoding order of the Low Delay (LD) configuration is the same as the POC order. So that the current picture can only refer to the information before the current picture. The Low Delay configuration is divided into Low Delay P and Low Delay B. Low Delay P is the conventional Low Delay configuration. Its typical structure is IPPP . . . , that is, an I picture is encoded/decoded first, and the subsequent pictures are all P pictures. The typical structure of Low Delay B is IBBB . . . , which is different from Low Delay P in that each inter picture is a B picture, that is, using two reference picture lists, the current block can simultaneously refer to a reference block of a certain picture in RPL0 and a reference block of a certain picture in RPL1.

In general, the compression efficiency of the RA configuration is higher than that of the LD configuration, and the compression efficiency of the LDB configuration is higher than that of the LDP configuration. On the one hand, it is because the bidirectional prediction can refer to backward information, and on the other hand, it is because the bidirectional prediction can reduce prediction errors through some techniques, such as weighted average.

A reference picture list of the current picture may have at most several reference pictures, such as 2, 3, or 4, etc. When encoding a certain current picture, which reference pictures in each of RPL0 and RPL1 are determined by a certain configuration or algorithm, which is not the focus of discussion in the embodiments of the present disclosure. But the same reference picture may appear in both RPL0 and RPL1 simultaneously. That is, the codec allows the current block to simultaneously refer to two reference blocks of the same reference picture. The codec usually uses the index (idx) value in the reference picture list to correspond to the reference picture. If a reference picture list has a length of 4, the index has four values: 0, 1, 2, 3. Exemplarily, if RPL0 of the current picture has four reference pictures with POC of 5, 4, 3, 0. Then, index 0 of RPL0 corresponds to the reference picture of POC 5, index 1 of RPL0 corresponds to the reference picture of POC 4, index 2 of RPL0 corresponds to the reference picture of POC 3, and index 3 of RPL0 corresponds to the reference picture of POC 0.

It will also be understood that inter prediction uses motion information to represent “motion”. The basic motion information includes information of a reference picture and information of a motion vector (MV). In order for a block to be able to use bidirectional prediction, it naturally needs to be able to find two reference blocks, so it needs two sets of reference picture information and motion vector information. Each set of them can be understood as unidirectional motion information, and combining these two sets forms bidirectional motion information. In specific implementation, the unidirectional motion information and the bidirectional motion information can use the same data structure, except that for bidirectional motion information, two sets of reference picture information and motion vector information are valid, while for unidirectional motion information, one set of reference picture information and motion vector information is invalid. The valid can also be understood as “used”, and the invalid can also be understood as “not used”.

VVC supports two reference picture lists, denoted as RPL0 and RPL1. For the above-described bidirectional motion information, the VVC uses the reference picture index refIdxL0 corresponding to RPL0, the motion vector mvL0 corresponding to RPL0, the reference picture index refIdxL1 corresponding to RPL1, and the motion vector mvL1 corresponding to RPL1. Here, the reference picture index corresponding to RPL0 and the reference picture index corresponding to RPL1 can be understood as the above-described reference picture information. The VVC indicates whether the motion information corresponding to RPL0 is used and whether the motion information corresponding to RPL1 is used by two pieces of identification information, which are denoted as predFlagL0 and predFlagL1, respectively. It can also be understood that predFlagL0 and predFlagL1 indicate whether the above-mentioned unidirectional motion information is “valid”. Therefore, although the data structure of motion information is not explicitly mentioned in the VVC, it represents motion information collectively using the reference picture index, the motion vector, and the “validity” flag corresponding to each reference picture list. The standard text of VVC does not use “motion information” but rather “motion vector”, and it could be considered that the reference picture index and the flag indicating whether the corresponding motion information is used are attributes of the motion vector. “Motion information” is still used herein for convenience of description, but it should be understood that “motion vector” may also be used for description. The “motion information” may also be referred to as a “motion parameter”.

For a two-dimensional picture, the motion vector can be represented by (x, y), that is, a horizontal component and a vertical component. Since videos are represented in samples, and there is a distance between samples, the motion of an object between neighbouring pictures may not always correspond to an integer sample distance. For example, in a distant-view video, the distance between two samples is 1 meter on a distant-view object, and the object moves 0.5 meters within the time between two frames. This kind of scene cannot be well represented by the integer sample motion vectors. Therefore, motion vectors can achieve fractional sample precision, such as ½ sample precision, ¼ sample precision, ⅛ sample precision, 1/16 sample precision, to represent motion more finely. Sample values of fractional sample positions in the reference picture are obtained by interpolation.

Both unidirectional prediction and bidirectional prediction in the translational prediction described above are block-based, such as coding unit or prediction unit. That is, a sample matrix is used as a unit for prediction. The most basic blocks are rectangular blocks, such as squares and rectangles. Video encoding and decoding standards such as HEVC and VVC allow encoders to determine the size and partition mode of coding units and prediction units according to the content of the video. Areas with simple textures or motions tend to use larger blocks and areas with complex textures or motions tend to use smaller blocks. The deeper the level of block partitioning, the more complex blocks that are closer to the actual texture or motion can be partitioned, but the overhead of representing these partitions is correspondingly greater. The motion information may also need to be transmitted in the bitstream. Moreover, in general, the finer the blocks are partitioned, the greater the overhead of motion information typically is.

The most primitive method of expressing motion information is to signal complete motion information directly. Later, experts found that motion vector prediction (MVP) plus motion vector difference (MVD) can be used to represent motion vectors, that is, MV=MVP+MVD. Where the more accurate the MVP is, the smaller the MVD is, which takes up less overhead in the bitstream.

It will also be understood that for the merge mode, a piece of motion information is required for each inter coding block. In order to simplify the problem, it is assumed that the partition of CU is equal to the partition of PU and is equal to the partition of TU, that is, a coding unit has a prediction unit of the same size and position, and a transform unit of the same size and position. In fact, as the partition of CU becomes more flexible, VVC tends to weaken PU and TU compared to HEVC. Differences in any link among prediction, transform, quantization and entropy coding may lead to CU partitioning. For example, if the motion information of two areas is different, the encoder may partition the two areas into different CUs. For example, if the motion information of two areas is the same or similar, but the residual characteristics are very different, then the encoder may also partition the two areas into different CUs. How to partition is determined according to the overall compression efficiency, and does not entirely depend on a certain factor. Thus, it is possible for the same object or areas with the same or similar motion to be partitioned into different CUs.

FIG. 3A to FIG. 3C are schematic block partitioning structures of HEVC. As shown in FIG. 3A to FIG. 3C, FIG. 3A is the original picture, in FIG. 3A there is an iron rod moving in the direction indicated by the arrow, and the background area moves less. FIG. 3B shows the block partitioning situation in HEVC, and FIG. 3C removes the boundaries of blocks with the same motion information in FIG. 3B. It can be seen that many neighbouring blocks use the same motion information. In such cases, encoding motion information separately for each block would cause significant waste. The complete motion information mentioned above for VVC includes the reference picture index, MV, and the flag of whether or not to be used of RPL0, and the reference picture index, MV, and the flag of whether or not to be used of RPL1. The basic principle of merge mode is that the current block can inherit the motion information of neighbouring blocks, including the information of reference pictures and motion vectors.

The merge mode can construct a merge candidate list. If the current block uses the merge mode, an index can indicate which motion information the current block merges, thus avoiding the need to encode the complete motion information. When constructing the merge candidate list, motion information of spatial neighbouring blocks, temporal motion information, motion information of spatial non-neighbouring blocks, motion information of temporal non-neighbouring blocks, history-based motion information, merge motion information, etc. of the current block can be added.

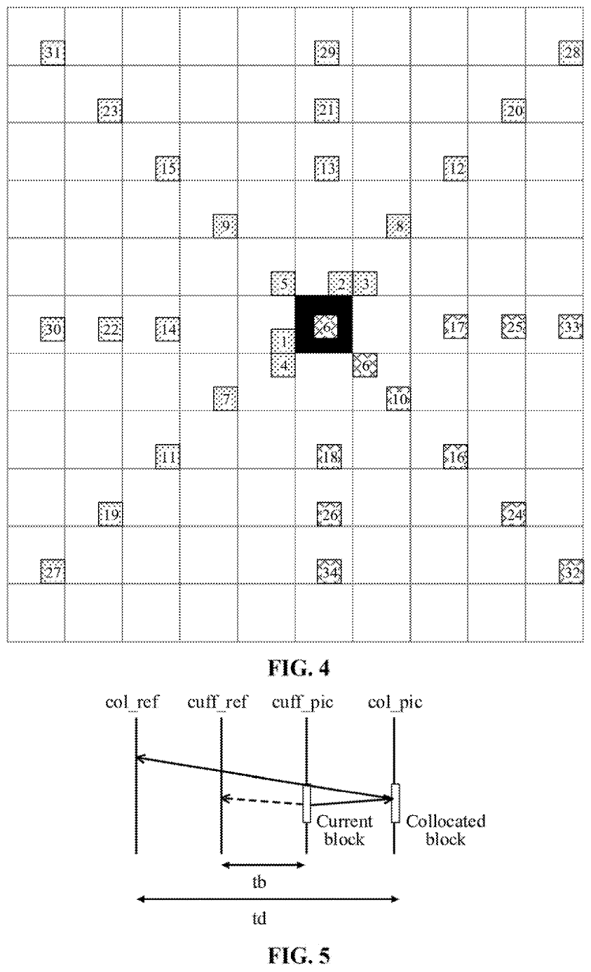

The spatial neighbouring blocks refer to blocks adjacent to the current block in the same picture, and the spatial non-neighbouring blocks refer to blocks not adjacent to the current block in the same picture. The temporal motion information and the motion information of temporal non-neighbouring blocks refer to motion information at a specified position on a collocated reference picture. Exemplarily, as shown in FIG. 4, the black-filled block is the current block, where positions 1, 2, 3, 4, and 5 are positions of spatial neighbouring blocks used for merge, and other dot-filled blocks correspond to positions of spatial non-neighbouring blocks used for merge; position 6 is the position used for temporal motion information, if the position corresponding to the bottom-right corner of the current block is unavailable, the position corresponding to the center of the current block is used; other grid-filled blocks correspond to positions used for motion information of temporal non-neighbouring blocks. The temporal motion information is derived according to the motion information at the corresponding position of the collocated reference picture, and the specific derivation method is described below. It should be noted that the background grid in FIG. 4 is only a schematic diagram of sample coordinates, and is not a specific block partition.

History-based motion information is position-independent. The codec maintains a first-in-first-out motion information list. Every time a block is encoded/decoded, the codec updates the list with the motion information of the block, ensuring no duplication with existing motion information in the list during update. History-based movement information is obtained from this list.

It can also be understood that for temporal motion information (vector) derivation, temporal motion information prediction is used as a supplement to spatial motion information prediction. Generally, the correlation between neighbouring areas on the same picture is stronger than that on different pictures. However, there are situations where temporal motion information is more useful. To give a simple example, suppose the current block and its surrounding neighboring blocks in the current picture belong to different objects with completely different motions, while the motion of a block belonging to the same object as the current block in a certain reference picture can provide better motion information prediction for the current block.

The motion vector of a collocated block (here, the block from which the temporal motion information is acquired is called a collocated block) on the collocated reference picture is a vector from the collocated reference picture col_pic to the reference picture col_ref of the collocated block. Specifically, as shown in FIG. 5, for the current block, the required motion vector is a vector from the current picture curr_pic to the reference picture curr_ref of the current block. Let the POC distance between col_pic and col_ref be td, and the POC distance between curr_pic and curr_ref be tb. Assuming that the motion on the collocated block is invariant to the motion on the current block, the scale can be determined according to td and tb. If the motion vector of the collocated block is (col_mv_x, col_mv_y), the temporal motion vector prediction (tmvp_x, tmvp_y) can be derived as follows: tmvp_x=col_mv_x*tb/td, tmvp_y=col_mv_y*tb/td.

In VVC, the minimum unit for storing motion information on the collocated reference picture is 4×4. That is, each 4×4 sub-block stores a set of motion information. It can be understood that if the cost of hardware implementation is not considered, the collocated reference picture can also store a set of motion information per sample.

It can also be understood that subblock-based temporal motion vector prediction, i.e., SbTMVP, is introduced in VVC. Generally, MVP and TMVP are for the entire block, that is, the entire block shares the same MVP. SbTMVP is based on sub-blocks, so that SbTMVP can obtain an MVP for each sub-block. This is also the essential difference between SbTMVP and TMVP.

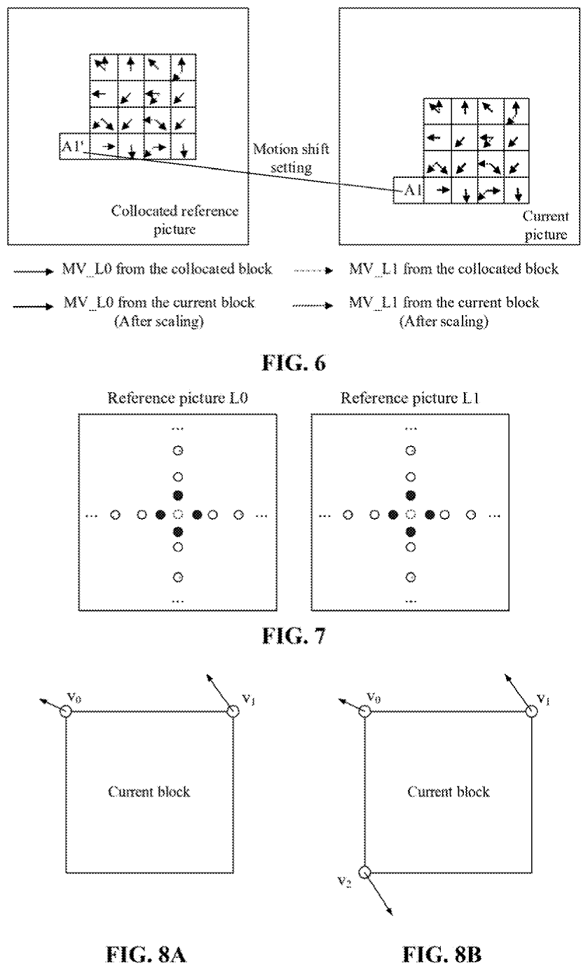

On the other hand, TMVP uses the position of the bottom-right corner of the current block or the position of the center of the current block to locate the collocated block, while SbTMVP determines the position according to a motion offset found from the motion of the surrounding blocks. In VVC, if the block at the position A1 refers to the collocated reference picture, the motion shift is set to the motion vector used by A1 referencing the collocated reference picture. Otherwise, the motion shift is set to (0, 0). As shown in FIG. 6, the position is found according to the motion shift, and then the MV corresponding to the position of each sub-block in the “collocated block” is scaled to obtain the MVP of each sub-block.

It is also understood that for the merge with motion vector difference, that is, MMVD, the motion information in the merge candidate list directly selected by the merge mode is used as the motion information of the current block. In the actual video, there may be some differences between the actual motion vector of the current block and the selected motion vector in the merge candidate list. MMVD is a special merge mode in VVC, which encodes the MVD in this case with an efficient method. Ordinary merge does not require encoding/decoding MVD. Ordinary inter mode requires direct encoding/decoding of MVD. MMVD takes advantage of the characteristic that MVD is more distributed in a single horizontal direction or a single vertical direction, with more MVD with smaller values and less MVD with larger values, as shown in FIG. 7. In FIG. 7, circles of different shapes may represent MVD of different values.

MMVD can only represent the MVD of specific values in some specific directions, but it cannot represent any MVD. It uses mmvd_direction_idx to represent the direction of the MVD (it can also be understood as whether the x and y components of the MVD are non-zero and their signs), and uses mmvd_distance_idx to represent the absolute value magnitude MmvdDistance of the non-zero component (x or y) of the MVD.

Here, Table 1 shows a schematic relationship of mmvd_distance_idx[x0][y0] and MmvdDistance[x0][y0].

TABLE 1

| | MmvdDistance[x0][y0] | |
|---|---|---|
| mmvd_distance_idx[x0][y0] | ph_mmvd_fullpel_only_flag == 0 | ph_mmvd_fullpel_only_flag == 1 |
| 0 | 1 | 4 |
| 1 | 2 | 8 |
| 2 | 4 | 16 |
| 3 | 8 | 32 |
| 4 | 16 | 64 |
| 5 | 32 | 128 |
| 6 | 64 | 256 |
| 7 | 128 | 512 |

Where ph_mmvd_fullpel_only_flag is a picture header flag, and two different combinations of MMVDs can be set.

Here, Table 2 shows a schematic relationship of mmvd_direction_idx[x0][y0] and MmnvdSign[x0][y0].

TABLE 2

| mmvd_direction_idx[x0][y0] | MmvdSign[x0][y0][0] | MmvdSign[x0][y0][1] |
|---|---|---|
| 0 | +1 | 0 |
| 1 | −1 | 0 |
| 2 | 0 | +1 |
| 3 | 0 | −1 |

Where the MVD of the MMVD is obtained as follows:

$$MmvdOffset [ x 0 ] [ y 0 ] [ 0 ] = ( MmvdDistance [ x 0 ] [ y 0 ] << 2 ) * MmvdSign [ x 0 ] [ y 0 ] [ 0 ] ; \\ MmvdOffset [ x 0 ] [ y 0 ] [ 1 ] = ( MmvdDistance [ x 0 ] [ y 0 ] << 2 ) * MmvdSign [ x 0 ] [ y 0 ] [ 1 ] .$$

It can also be understood that for Affine, the simplest and commonly used translational motion was introduced earlier. In the real world, motion is not only translation, but also many forms such as zooming out, zooming in, rotating, and moving perspective (perspective: objects close to the lens appear larger, while those far from the lens appear smaller), and there are many irregular forms of motion. Affine can be used to represent more complex motions than translation. As shown in FIG. 8A and FIG. 8B, Affine uses a linear model to calculate the motion vector of each sub-block or each sample in the current block based on the motion vectors of two control points (four parameters, one motion vector including two parameters x and y) or three control points (six parameters). Where FIG. 8A provides the case of 2 control points, e.g., v₀, v₁; FIG. 8B Provides a case of 3 control points, e.g., v₀, v₁, v₂.

For the 4-parameter affine model, the motion vector at position (x, y) within the current block is derived by the following formula:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} \qquad ( 1 )$$

For the 6-parameter affine model, the motion vector at position (x, y) within the current block is derived by the following formula:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad ( 2 )$$

Where (mv₀ₓ, mv_{0y}) is a motion vector of a control point at the top-left corner of the current block, (mv₁ₓ, mv_{1y}) is a motion vector of a control point at the top-right corner of the current block, and (mv₂ₓ, mv_{2y}) is a motion vector of a control point at the bottom-left corner of the current block.

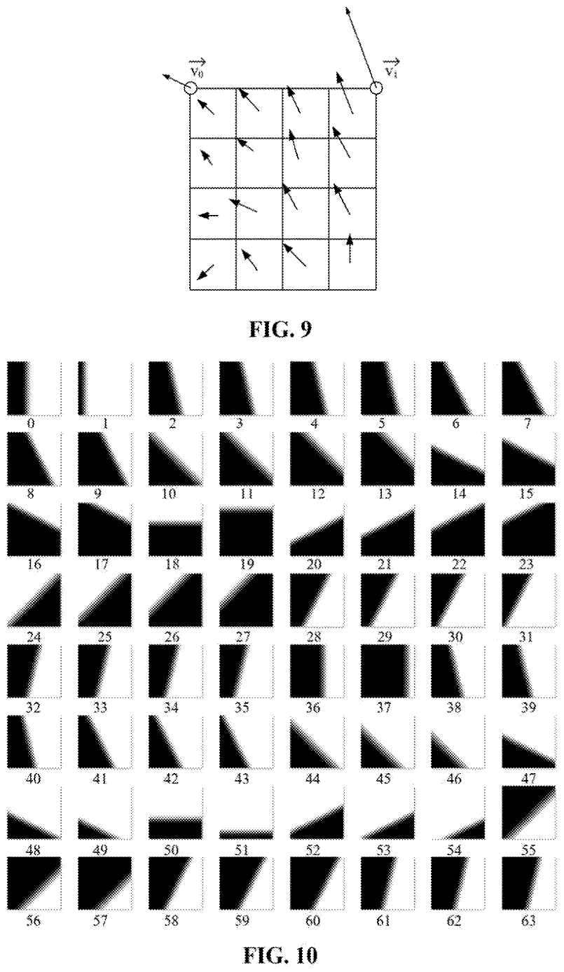

In order to simplify the complexity of hardware implementation, Affine used in VVC partitions the current block into 4×4 sub-blocks, calculates an MV for each sub-block and performs motion compensation. FIG. 9 is a schematic diagram of Affine partitioning motion vectors based on sub-blocks. It is understandable that with the enhancement of hardware processing capabilities, Affine can also achieve sample-based processing. That is, a motion vector is derived for each sample, and motion compensation is performed on a sample according to the motion vector. Here, Affine only needs a few control points to derive a respective motion vector for each sub-block or sample, and it can achieve more finer prediction than motion compensation based on the whole block. Compared to partitioning into smaller CUs, Affine incurs much less overhead.

It can also be understood that for the Geometric Partitioning Mode (GPM), HEVC supports CTUs with a maximum size of 64×64, and quadtree partitioning can be performed recursively. VVC supports a set of more flexible block partitioning methods than HEVC, supporting CTUs with a maximum size of 128×128, including quadtree, ternary tree, and binary tree partitioning. Although block partitioning of these partitioning methods is becoming more and more flexible, whether it is CU, PU or TU, it can only be partitioned into rectangular blocks. It should be noted that VVC has weakened the partition of PU and TU. The boundaries of textures or motions in natural videos are various. For example, when encountering an oblique object boundary, if you simply use rectangular blocks to approximate the boundary, many small blocks will be partitioned, which will obviously increase the overhead. The GPM geometry partitioning mode can better handle textures and boundaries in natural videos.

The GPM uses two prediction blocks with the same size as the current block. In the prediction block of the GPM, some sample positions use 100% of the sample value of the position corresponding to the first prediction block, and some sample positions use 100% of the sample value of the position corresponding to the second prediction block. In the boundary area or transition area, the sample values of the positions corresponding to the two prediction blocks are used in a certain proportion. The weight of the boundary area is also gradually transitioned. Certainly, the transition area may not be used for scenarios such as screen content encoding. How these weights are allocated is determined by the “partitioning” mode of GPM. The weight of each sample position is determined according to the “partitioning” mode of the GPM. Certainly, in some cases, such as when the block size is very small, some GPM modes may not guarantee that some sample positions will 100% use the sample value of the position corresponding to the first prediction block, and some sample positions will 100% use the sample value of the position corresponding to the second prediction block. It can also be considered that GPM uses two prediction blocks with different sizes from the current block, that is, each takes the required part and eliminates the part with a weight of 0.

FIG. 10 is a schematic diagram of the weights of 64 modes of GPM mode on square blocks in VVC. As shown in FIG. 10, black indicates that the weight value of the position corresponding to the first prediction block is 0%, white indicates that the weight value of the position corresponding to the first prediction block is 100%, and gray area indicates that the weight value of the position corresponding to the first prediction block is a certain weight value greater than 0% and less than 100% according to different colour depths. The weight value of the position corresponding to the second reference block is 100% minus the weight value of the position corresponding to the first reference block.

GPM can be considered a prediction mode or prediction method because it ultimately produces a prediction block. GPM can also be considered a “partitioning” mode, as it simulates partitioning of the prediction block, similar to implementing PU partitioning, but without substantial partitioning. The first prediction block and the second prediction block used by the GPM may be a prediction block generated by intra prediction, a prediction block generated by inter unidirectional prediction, or a prediction block generated by inter bidirectional prediction.

It will also be understood that the bitrate of general consumer video is limited, so video compression usually seeks a compromise between bitstream overhead and distortion. Taking block partitioning as an example, for the same content, within a certain range, the finer the partitioning, the greater the overhead and the less distortion; the coarser the partitioning, the less overhead and the greater the distortion. Taking the encoding of motion information as an example, for the same content, within a certain range, the more accurate the motion information, the greater the overhead and the less distortion; the coarser the motion information, the less overhead and the greater the distortion. Some decoder-side methods use the decoder-side information for processing and calculation without occupying overhead, so as to improve the motion information, improve the prediction effect and reduce the distortion. Not occupying overhead means there is no instruction from the encoder according to the original picture, and it is automatically processed according to available information. Two typical decoder-side methods in VVC are Decoder side Motion Vector Refinement (DMVR) and Bi-Directional Optical Flow (BDOF), which will be introduced in detail below.

In one possible implementation, for DMVR, a condition for DMVR activation in VVC is that the two reference pictures of the current block are one preceding and the other following the current picture, and the distances of the two reference pictures from the current picture are equal. Another activation condition is that the current CU uses an entire-block merge mode (including skip), where “entire-block” means not including subblock-based merge such as SbTMVP and affine merge, because the motion vector in the merge mode is prone to inaccuracy. There are some other conditions that will not be repeated here. The DMVR in VVC uses bilateral matching (BM), that is, calculates the matching cost for the reference blocks on both sides, such as the sum of absolute differences (SAD). DMVR searches the matching cost of MVs around the original MV. When moving, the MVs of the two reference pictures move mirror-wise, that is, one moves by MV_{diff} from the original MV and the other moves by −MV_{diff}, as shown in FIG. 11. In FIG. 11, the two reference pictures include a reference picture L0 (refPic in ListL0) and a reference picture L1 (refPic in ListL1). Fractional sample search is also supported during search, so DMVR may find MVs with higher accuracy than the original MV. According to certain rules, generally, the integer sample MV within a certain range is searched first, the integer sample MV with the lowest matching cost is found, and then the fractional sample MV is searched on the basis of the integer sample MV. If an MV with a smaller matching cost than the original MV is found, the MV with a smaller matching cost is used for motion compensation prediction. Theoretically, the refined MV by DMVR could be stored and used by surrounding blocks. For example, when constructing the merge candidate list for the current block, if the surrounding blocks refines the MV by DMVR, using the refined MV to build the merge candidate list could achieve a better compression effect. However, for hardware implementation considerations, VVC does not do this.

DMVR can be processed based on subblocks. Actually, in VVC, if the horizontal or vertical dimension of a block is greater than 16 samples, the sub-block is partitioned in the size of 16 samples. This aspect is based on the consideration of hardware implementation complexity, because DMVR needs to search at the decoding end, and limiting the size of sub-blocks can reduce the cost of caching. On the other hand, the processing of partitioning into sub-blocks provides better flexibility. Each sub-block can independently improve the MV, which achieves the effect of improving the partitioning accuracy to a certain extent, which also improves the compression efficiency.

In another possible implementation, for BDOF, BDOF is also a typical decoder-side method. As its name suggests, BDOF improves MV and prediction based on the principle of optical flow. Optical flow is the instantaneous velocity of sample motion of a spatially moving object on the observation imaging plane. There are some basic assumptions of optical flow, such as constant brightness, that is, when the same object moves between different pictures, its brightness does not change. Time continuity or motion is small motion. That is, the change in time does not cause a drastic change in the target position.

A condition for BDOF activation in VVC is that the two reference pictures of the current block are one preceding and the other following the current picture, and the distances of the two reference pictures from the current picture are equal. In VVC, for each 4×4 sub-block, BDOF will derive a motion vector deviation (vₓ, v_{y}), which is calculated by minimizing the difference between the prediction values in the two directions. This motion vector deviation is also used to adjust the prediction value in the corresponding sub-block. The derivation process is as follows:

First, the horizontal and vertical gradients

$$( \frac{\partial {I}^{( k )}}{\partial x} ( i , j ) and \frac{\partial {I}^{( k )}}{\partial y} ( i , j ) ,$$

where k=0,1) of the two prediction blocks are calculated, the details are as follows:

$$\frac{\partial {I}^{( k )}}{\partial x} ( i , j ) = ( ( {I}^{( k )} ( i + 1 , j ) >> shift1 ) - ( {I}^{( k )} ( i - 1 , j ) >> shift1 ) ) \qquad ( 3 )$$

$$\frac{\partial {I}^{( k )}}{\partial y} ( i , j ) = ( ( {I}^{( k )} ( i , j + 1 ) >> shift1 ) - ( {I}^{( k )} ( i , j - 1 ) >> shift1 ) ) \qquad ( 4 )$$

Where I^{(k)}(i,j) is the prediction value of the coordinates (i,j) of the reference picture list k (k=0,1), shift1 is calculated based on luma bit depth bitDepth: shift1=max(6, bitDepth−6).

Secondly, S₁, S₂, S₃, S₅ and S₆ are calculated as follows:

$${S}_{1} = {\sum }_{( i , j ) ∈ Ω} Abs ( {ψ}_{x} ( i , j ) ) \qquad ( 5 )$$

$${S}_{2} = {\sum }_{( i , j ) ∈ Ω} {ψ}_{x} ( i , j ) \cdot Sign ( {ψ}_{y} ( i , j ) ) \qquad ( 6 )$$

$${S}_{3} = {\sum }_{( i , j ) ∈ Ω} θ ( i , j ) \cdot Sign ( {ψ}_{x} ( i , j ) ) \qquad ( 7 )$$

$${S}_{5} = {\sum }_{( i , j ) ∈ Ω} Abs ( {ψ}_{y} ( i , j ) ) \qquad ( 8 )$$

$${S}_{6} = {\sum }_{( i , j ) ∈ Ω} θ ( i , j ) \cdot Sign ( {ψ}_{y} ( i , j ) ) \qquad ( 9 )$$

Where

$${ψ}_{x} ( i , j ) = ( \frac{\partial {I}^{( 1 )}}{\partial x} ( i , j ) + \frac{\partial {I}^{( 0 )}}{\partial x} ( i , j ) ) >> {n}_{a} \qquad ( 10 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) >> {n}_{a} \qquad ( 11 )$$

$$θ ( i , j ) = ( {I}^{( 1 )} ( i , j ) >> {n}_{b} ) - ( {I}^{( 0 )} ( i , j ) >> {n}_{b} ) \qquad ( 12 )$$

Where Ω is a 6×6 window around a current 4×4 sub-block, nₐ is min (1, bitDepth−11), n_{b} is min (4, bitDepth−8).

Thirdly, the motion vector deviation (vₓ, v_{y}) is calculated as follows:

$${v}_{x} = {S}_{1} > 0 ? clip 3 ( - t {h}_{BIO}^{′} , t {h}_{BIO}^{′} , - ( ( {S}_{3} \cdot {2}^{{n}_{b} - {n}_{a}} ) >> ⌊ {log}_{2} {S}_{1} ⌋ ) ) : 0 \qquad ( 13 )$$

$${v}_{y} = {S}_{5} > 0 ? clip 3 ( - t {h}_{BIO}^{′} , t {h}_{BIO}^{′} , - ( ( {S}_{6} \cdot {2}^{{n}_{b} - {n}_{a}} - ( ( {v}_{x} {S}_{2 , m} ) << {n}_{{S}_{2}} + {v}_{x} {S}_{2 , s} ) / 2 ) >> ⌊ {log}_{2} {S}_{5} ⌋ ) ) : 0 \qquad ( 14 )$$

Where,

$${S}_{2 , m} = {S}_{2} >> {n}_{{S}_{2}} , {S}_{2 , s} = {S}_{2} \& ( {2}^{{n}_{{s}_{2}}} - 1 ) , t {h}_{BIO}^{′} = {2}^{max ( 5 , BD - 7 )} ,$$

└⋅┘ is a downward round, nₛ_{₂}=12, and BD is a bit depth bitDepth.

Fourthly, according to the motion vector deviation and gradient, each prediction value within the 4×4 sub-block is adjusted as follows:

$$b ( x , y ) = rnd ( \text{} ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) \text{} / 2 ) \qquad ( 15 )$$

The prediction value of the final BDOF is calculated as follows:

$${pred}_{BDOF} ( x , y ) = ( {I}^{( 0 )} ( x , y ) + {I}^{( 1 )} ( x , y ) + b ( x , y ) + {o}_{offset} ) >> shift \qquad ( 16 )$$

Where, o_{offset} and shift are calculated from the bit depth of the luma. nₐ, n_{b} and shift are processes for reducing the bit width in the calculation process.

In this way, the motion vector deviation of BDOF can achieve high accuracy, thus making the prediction more accurate, and the subblock-based processing also improves the flexibility. These two aspects are similar to DMVR.

It is also understood that both DMVR and BDOF have the effect of improving motion vectors. DMVR is based on block matching, and BDOF is based on optical flow principle. They can be used in combination. Exemplarily, it may be referred to as Multi-pass Decoder-side Motion Vector Refinement (MDMVR).

First step: entire block-based bidirectional matching motion vector refinement. Second step: subblock-based bidirectional matching motion vector refinement. The sub-block size of this step may be 16×16. Third step: subblock-based bidirectional optical flow motion vector refinement. The sub-block size of this step may be 8×8. At present, further steps can be enriched on this basis, such as a fourth step, which is 4×4 subblock-based bidirectional optical flow motion vector refinement. Alternatively, another point-based bidirectional optical flow motion vector refinement, etc.

It can also be understood that the method of Template Matching (TM) was first used in inter prediction, and it uses the correlation between neighbouring samples to use some areas around the current block as templates. When the current block is encoded/decoded, the left and top sides of the current block have already been encoded/decoded according to the coding order. Certainly, when the existing hardware decoder is implemented, it may not be guaranteed that when the current block starts decoding, the left and top sides of the current block have already been decoded. Here, we are talking about inter blocks. For example, in HEVC, the inter coding block does not require the surrounding reconstructed samples when generating a prediction block, so the prediction process of the inter block can be performed in parallel. However, an intra coding block must require the reconstructed samples on the left and top sides as reference samples. Theoretically, the left and top sides are available, which means that corresponding adjustments to the hardware design can be achieved. Relatively speaking, the right and bottom sides are not available under the coding order of current standards such as VVC.

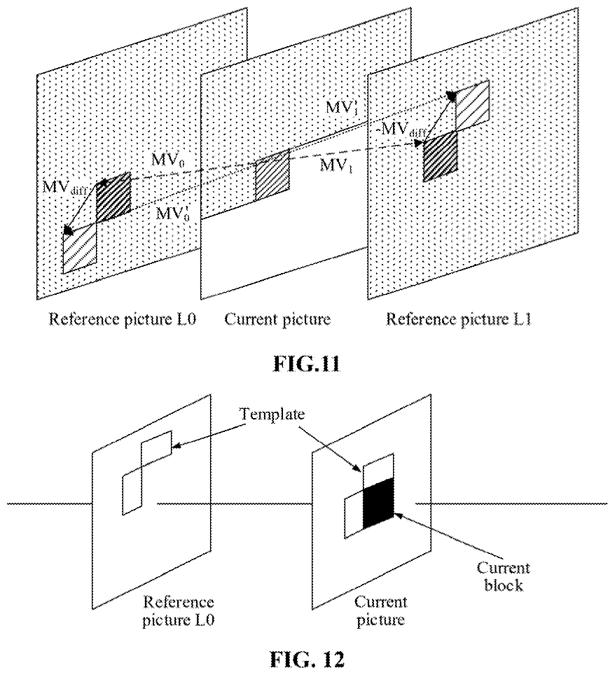

As shown in FIG. 12, the rectangular areas on the left side and the top side of the current block are set as templates, and the height of the template portion on the left side is generally the same as the height of the current block, and the width of the template portion on the top side is generally the same as the width of the current block, but it is needless to say, they may be different. The best matching position of the template is sought in the reference picture L0 to determine the motion information or motion vector of the current block. This process can be roughly described as starting from a starting position in a certain reference picture and searching within a certain surrounding range. Search rules can be predefined, such as search range and step size, etc. For each moved position, the matching degree between the template corresponding to the position and the template around the current block is calculated. The so-called matching degree can be measured by some distortion costs, such as the Sum of Absolute Differences (SAD), the Sum of Absolute Transformed Differences (SATD), Mean-Square Error (MSE), etc. Generally, the transform used for SATD is Hadamard transform, and smaller SAD, SATD, MSE values indicate higher matching degree. The cost is calculated with the prediction block of the template corresponding to the position and the reconstructed block of the template around the current block. In addition to the search for the integer sample position, the search for the fractional sample position may be performed, and the motion information of the current block may be determined according to the searched position with the highest matching degree. With the correlation between neighbouring samples, the motion information appropriate for the template may also be the motion information appropriate for the current block. Certainly, the template matching method may not be applicable to all blocks, so some methods can be used to determine whether the current block uses the above template matching method, such as using a control switch to indicate whether the template matching method is used in the current block. One name for this template matching method is Decoder side Motion Vector Derivation (DMVD). Both the encoder and the decoder can use the template to search to derive motion information or find better motion information on the basis of the original motion information. It does not need to transmit specific motion vectors or motion vector differences, but both the encoder and the decoder search under the same rule to ensure the consistency of encoding and decoding. The template matching method can improve the compression performance, but it needs to “search” on the decoder side, which brings a certain degree of complexity on the decoder side.

### (2) Intra Prediction.

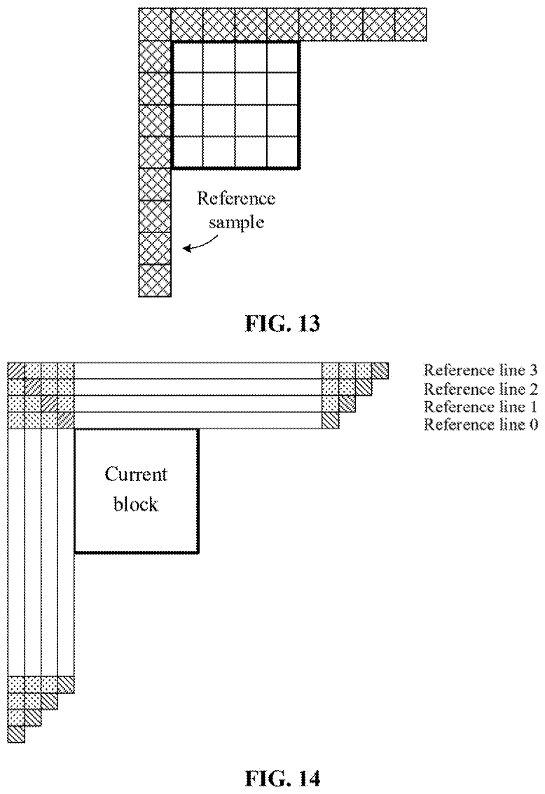

There is a strong spatial correlation between neighbouring parts or neighbouring samples in a picture. Intra prediction is a prediction method that uses the spatial correlation between the encoded/decoded samples around the current block and the samples inside the current block. Exemplarily, as shown in FIG. 13, 4×4 white-filled samples are the current block, and grid-filled samples on the left column and the top row of the current block are reference samples of the current block, and intra prediction uses these reference samples to predict the current block. These reference samples may already be all available, i.e., all have been encoded/decoded. There may also be some parts that are not available, for example, if the current block is the leftmost side of the entire frame, then the reference sample on the left side of the current block is not available. Or when encoding/decoding the current block, the bottom-left part of the current block has not been encoded/decoded, so the reference sample at the bottom-left is not available. In the case where the reference sample is not available, the reference sample or certain values or certain methods that are available may be used for padding, or no padding may be applied.

It should also be noted that the Multiple reference line (MRL) intra prediction method can use more reference samples to improve coding efficiency. As shown in FIG. 14, here is a schematic diagram using four reference rows/columns.

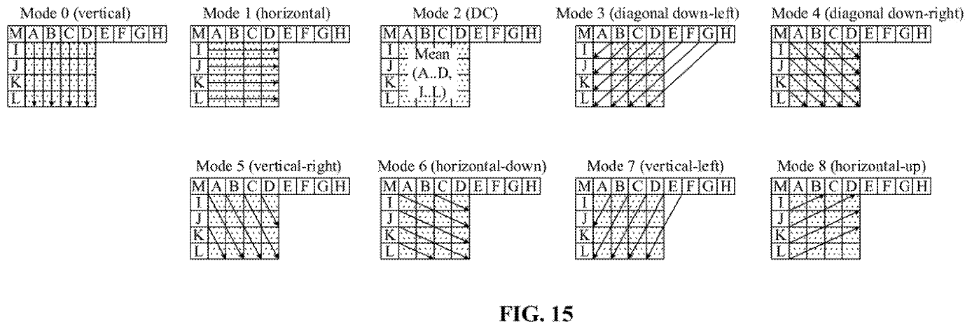

There are a plurality of prediction modes for intra prediction, and as shown in FIG. 15, there are nine modes for intra prediction of 4×4 blocks in H.264. Where mode 0 (vertical mode) copies the samples above the current block to the current block in the vertical direction as the prediction value, mode 1 (horizontal mode) copies the left reference sample to the current block in the horizontal direction as the prediction value, mode 2 (DC mode) copies the average value of eight points A to D and I to L as the prediction value of all points, and modes 3 to 8 copy reference samples to the corresponding position of the current block according to a certain angle respectively. Since some positions in the current block may not exactly correspond to reference samples, it may be necessary to use a weighted average of the reference sample, or fractional samples of the interpolated reference sample.

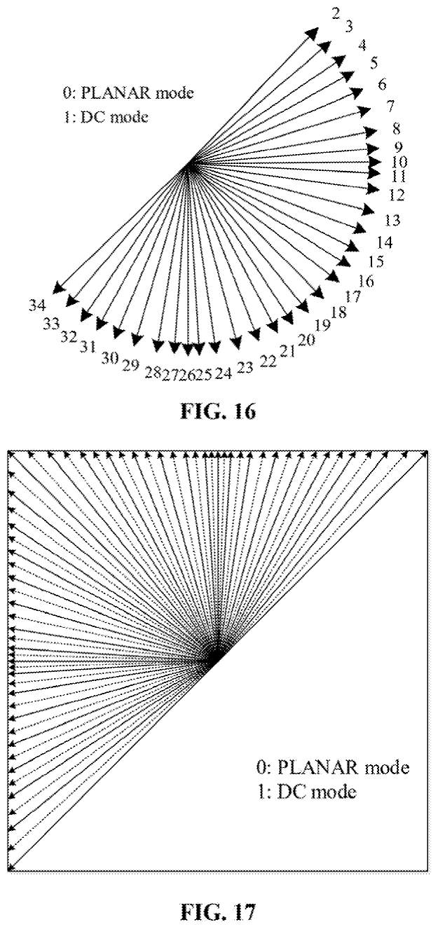

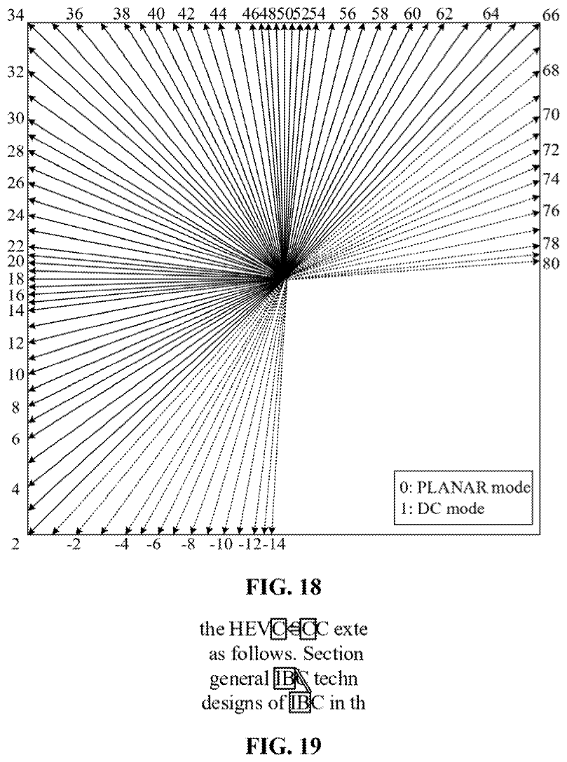

In addition, there are PLANE, PLANAR and other modes, and with the development of technology and the expansion of blocks, there are more and more angle prediction modes. For example, the intra prediction modes used by HEVC include PLANAR, DC and 33 angle modes, a total of 35 prediction modes, as shown in FIG. 16 for details. The intra modes used by VVC include PLANAR, DC and 65 angle modes, a total of 67 prediction modes, as shown in FIG. 17 for details. Certainly, in addition to the above 67 modes, VVC also provides wide-angle modes for some rectangular blocks with large differences in length and width. For example, the modes indicated by the dotted lines in the figure are −14~−1 and 67~80. They will replace some conventional modes, as shown in FIG. 18 for details.

It is also understood that Intra Block Copy (IBC) can significantly improve the compression efficiency of Screen Content Coding (SCC), and thus IBC is used for SCC from HEVC to VVC. Screen content is different from camera captured content. It is generated by a computer. The screen content has no noise, contains text, computer graphics, etc., and has clear boundaries. There is a lot of repetitive content in the screen content, as shown in FIG. 19.

In the embodiment of the present disclosure, it can be considered that IBC applies the inter prediction method to intra prediction. Where the inter prediction uses a reference block on a reference picture to generate a prediction block of the current block, the reference picture is not the current picture. IBC finds reference blocks from already encoded/decoded parts (or reconstructed parts) of the current picture to generate the prediction block of the current block. IBC may also be referred to as intra picture block compensation or Current Picture Referencing (CPR).

The IBC can use a block vector (BV) to represent the position difference between the current block and the reference block, which is similar to the inter prediction MV. The encoder determines the best matching block of the current block through the block matching method within the search range, and encodes the BV. There are many methods for encoding the BV, for example, the merge mode can be used, which is similar to inter prediction, and will not be repeated here.

IBC can be regarded as an intra prediction method, or it can be regarded as another kind of prediction method independent of intra prediction and inter prediction. IBC is highly efficient for screen content coding and also improves compression efficiency for natural sequences captured by cameras.

Intra Template Matching Prediction (IntraTMP) in ECM 10 can be regarded as a special IBC. IntraTMP also searches for reference blocks from already encoded/decoded parts of the current picture to generate the prediction block. IntraTMP takes the reconstructed samples within a certain range on the left side and top side of the current block as templates of the current block. For each searched BV, a template of a reconstructed sample reference block within a certain range on the left side and the top side of a reference block having the same size as the current block corresponding to the BV is determined, a matching cost between the template of the current block and the template of the reference block is calculated, and the reference block is determined according to the matching cost to generate a prediction block.

It is also understood that for Decoder-side Intra Mode Derivation (DIMD), the DIMD derives a prediction mode using the reconstructed samples on the left and top sides of the current block, but instead of predicting on the template, it analyzes the gradient of the reconstructed samples.

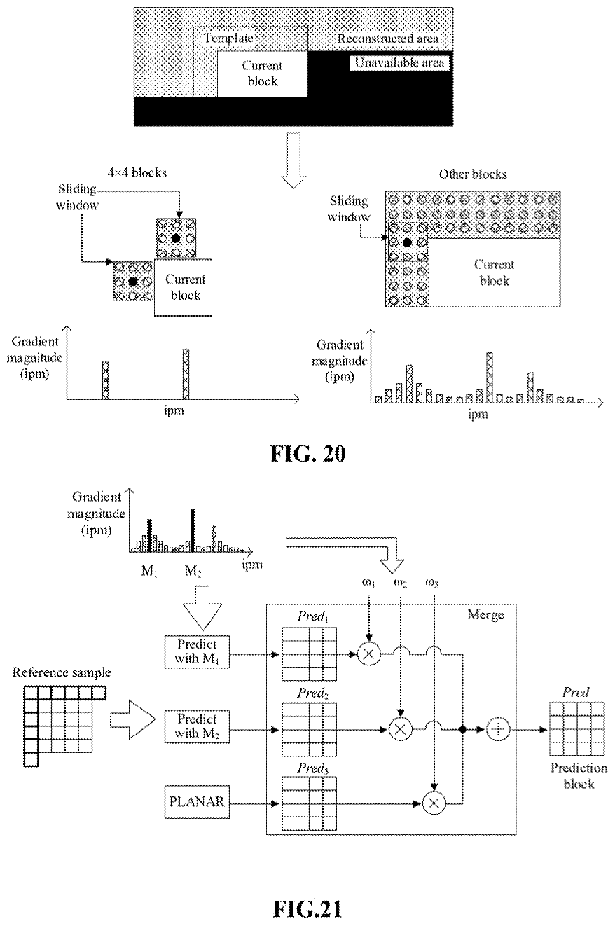

As shown in FIG. 20, DIMD analyzes the gradients of black points, such as horizontal gradients and vertical gradients, adapts an intra prediction mode according to its gradients, and analyzes all the points to be checked to obtain a result similar to the following histogram. That is, the statistics of the number of points matched by each intra prediction mode. Certainly, the so-called histogram is only to help understand, and the specific implementation can be implemented in many simple forms. The current DIMD selects the two highest intra prediction modes in the histogram, plus the PLANAR mode, and weights the prediction values of the three intra prediction modes. The weights are related to the analysis results. Exemplarily, as illustrated in FIG. 21, the three intra prediction modes include an M₁ mode, an M₂ mode, and a PLANAR mode. The prediction values obtained by the three intra prediction modes are respectively set to Pred₁, Pred₂, Pred₃, and the weight values of the three intra prediction modes are respectively set to w₁, w₂, w₃, and the specific calculation formulas are as follows:

$${w}_{1} = \frac{43}{64} \times \frac{ampl ( {M}_{1} )}{ampl ( {M}_{1} ) + ampl ( {M}_{2} )} \qquad ( 17 )$$

$${w}_{2} = \frac{43}{64} \times \frac{ampl ( {M}_{2} )}{ampl ( {M}_{1} ) + ampl ( {M}_{2} )} \qquad ( 18 )$$

$${w}_{3} = \frac{21}{64} \qquad ( 19 )$$

The final prediction block may be as follows:

$$Pred = {\sum }_{i = 1}^{3} {w}_{i} \times {Pred}_{i} \qquad ( 20 )$$

In summary, DIMD uses gradient analysis of reconstructed samples to screen intra prediction modes, and two intra prediction modes plus planar can be weighted according to the analysis results. The advantage of DIMD is that if the current block selects the DIMD mode, it does not need to indicate which intra prediction mode is used, but is derived by the decoder itself through the above process, which saves overhead to a certain extent.

It can also be understood that for Cross-Component Prediction (CCP), since there is a strong correlation between different components in the same space, video encoding and decoding technology can utilize this correlation to improve compression efficiency. In some cases, the first component of the same space will be encoded/decoded first, and then the second and third components will be encoded/decoded, so that the second and third components can utilize some information of the first component. For example, in the YUV format, the samples of U and V can be predicted with the reconstructed samples of Y at the corresponding position. If it is in the YUV4: 2: 0 format, the sample positions of U and V do not correspond to the position of Y one-to-one, and the corresponding reconstructed samples of Y can be found by downsampling and other methods for prediction.

A typical example of CCP in VVC is the Cross-Component Linear Model (CCLM). Other cross-component prediction technologies in ECM include Multi-Model CCLM (MM-CCLM), Convolutional Cross-Component Model (CCCM), Multi-Model CCCM (MM-CCCM), Gradient Linear Model (GLM), inter-CCCM, etc., and other derivative technologies will not be listed one by one. They are all technologies in which the second/third colour component uses some information of the first colour component, such as the reconstructed value, for prediction. Cross-component prediction techniques may be used for intra coding blocks as well as inter coding blocks. For example, inter-CCCM is a block used for inter coding.

### (1) Cross-Component Linear Model (CCLM).

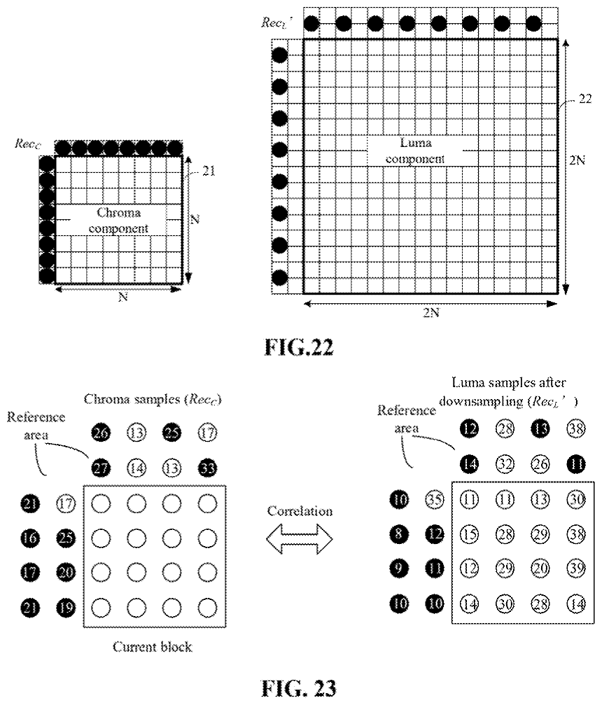

CCLM, as its name implies, is a prediction technique using a linear model of the first colour component and the second/third colour component for prediction. Specifically, as follows:

$${pred}_{C} ( i , j ) = α \cdot {rec}_{L}^{′} ( i , j ) + β \qquad ( 21 )$$

Where pred_{C}(i, j) represents the prediction value of the chroma sample at the position (i, j), rec_{L}′(i, j) represents the reconstructed value of the down-sampled luma sample at the position. The model parameters (a and P) of the CCLM are derived from the neighboring down-sampled luma samples and chroma samples of the current block. As an example, as shown in FIG. 22, a schematic diagram of sampling a luma component neighboring reference value and a chroma component neighboring reference value of a current block is shown here. In (a), the bold larger box is used to highlight the chroma block 21, while the gray solid circles indicate the neighboring reference values of the chroma block 21. In (b), the bold larger box is used to highlight the luma block 22, while the grey solid circles indicate the neighbouring reference values of the luma block 22. Where the chroma block 21 has a size of N×N, and the luma block 22 has a size of 2N×2N. Here, the neighbouring reference values of the chroma block 21 and the neighbouring reference values of the luma block 22 are both used to derive model parameters a and p.

The basic principle is to derive a linear model by using the neighbouring luma and chrominance samples of the current block, and then apply this linear model to the current block, and determine the prediction value of chroma according to the reconstructed value of luma and this linear model.

### (2) Multi-Model CCLM.

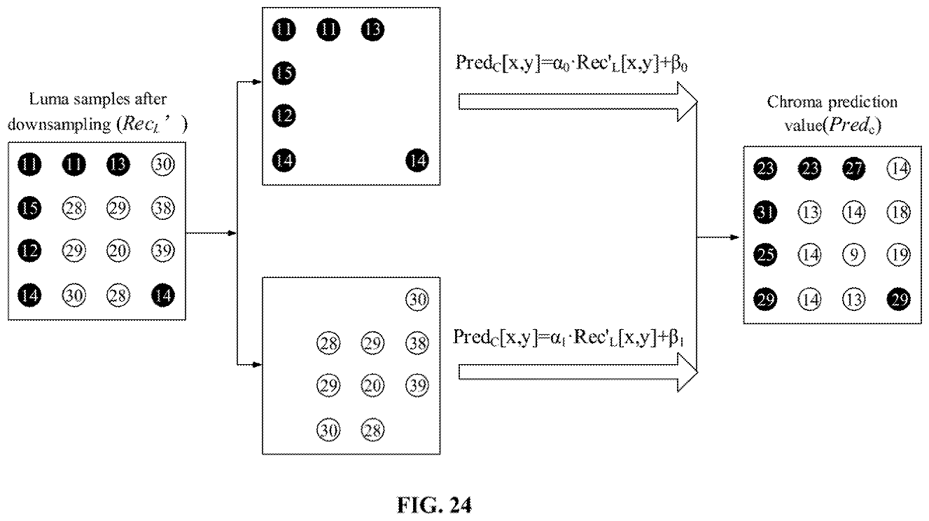

MM-CCLM is an extension of CCLM, which uses only one linear model in the current block, and MM-CCLM uses multiple linear models as the name suggests, specifically, two linear models are used in ECM-10. In order to derive two linear models, the neighbouring luma samples on the left and top side of the current block used to derive the linear model are partitioned into two groups, and the threshold of the grouping is the median value of these luma sample values. When predicting the current block, the luma samples of the current block are also partitioned into two groups by using the threshold, and their respective models are used for prediction. FIG. 23 is a schematic diagram of grouping of an MM-CCLM, and FIG. 24 is a schematic diagram of prediction of an MM-CCLM.

### (3) Convolutional Cross-Component Model (CCCM).

Similar to CCLM, CCCM also derives a cross-component model based on the reconstructed parts on the left and top sides of the current block, but CCCM uses a larger reconstruction area, and it can derive a nonlinear model. Another difference is that CCLM uses a down-sampled luma value to predict a chroma value, while CCCM uses the luma reconstructed value of the position corresponding to the chroma sample and the luma reconstructed values of the top, bottom, left and right positions around it.

Specifically, CCCM uses a 7-tap convolution filter including five spatially neighbouring samples, C (center) is the luma sample corresponding to the current chroma sample, N (north) is the luma sample above C, S (south) is the luma sample below C, W (west) is the luma sample on the left side of C, and E is the luma sample on the right side of C. There is also a nonlinear term P, P=(C×C+midVal)>>bitDepth. Where midVal means median value, and bitDepth means bit width. For the case of 10-bit, P=(C×C+512)>>10. There is also an offset term B, set to the median value, which is 512 for the 10-bit case. Prediction values of Chroma Samples predChromaVal=C₀C+C₁N+C₂S+C₃E+C₄ W+C₅P+C₆B.

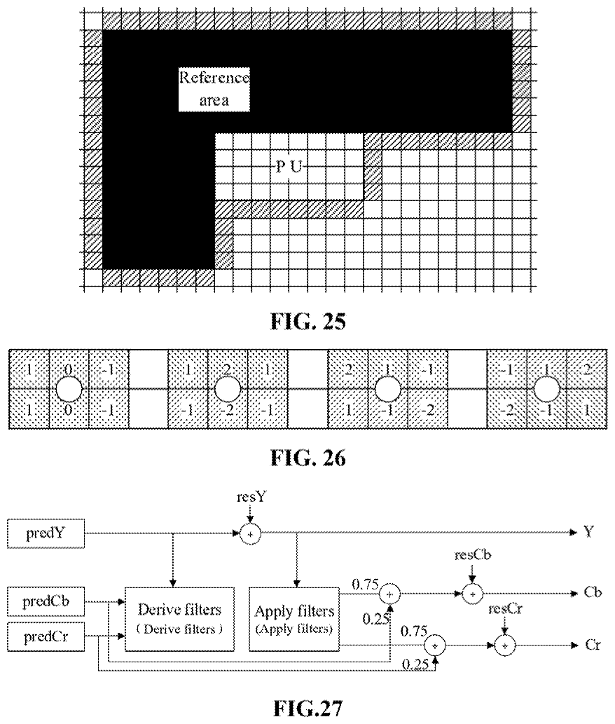

To determine C₀, C₁, C₂, C₃, C₄, C₅, C₆, CCCM applies the same model to predict the chroma in the reference area as shown in FIG. 25 and compares it with the reconstructed chroma values to solve for C₀, C₁, C₂, C₃, C₄, C₅, C₆ that minimize the mean square error.

### (4) Multi-Model Convolution Cross-Component Model (MM-CCCM).

Similar to MM-CCLM, multiple models are applied to the current block. Where two models are used in ECM-10, and the derivation method also uses a threshold to partition the reconstructed luma samples and the luma samples of the current block into two groups, respectively derive CCCM models, respectively predict and combine them into a prediction block.

### (5) Gradient Linear Model (GLM).

GLM is a method of predicting chroma based on the gradient of luma. There are 2 GLM modes here, one mode is 2-parameter GLM and one mode is 3-parameter GLM. Where:

The formula of 2-parameter GLM is pred_{C}(i, j)=α·grad_{L}(i,j)+β;

The formula of 3-parameter GLM is pred_{C}(i,j)=α₀·grad_{L}(i,j)+α₁·rec_{L}′(i,j)+β.

Here, the 2-parameter GLM replaces the reconstructed sample value of the down-sampled luma in the CCLM with the luma gradient. The 3-parameter GLM is based on CCLM and adds a luma gradient. There are four calculation methods for the luma gradient as shown in FIG. 26. The filter blocks correspond to the luma samples, and the circles correspond to the chroma sample. This is a set of filters designed for the YUV4: 2: 0 format.

### (6) Inter-CCCM.

Intra prediction and inter prediction are different. Intra prediction uses reconstructed samples around the current block to predict the inside of the current block, while inter prediction uses pictures of the same object at different times for prediction. The most basic thing for inter prediction is translational motion, that is, a motion vector is used to find a reference block and the reference block is used as the prediction block. Since it is the same object found from different times, the reference picture contains the same number of components as the current picture. For a sequence in YUV format, all three components of YUV can obtain prediction values from the reference block. The above-mentioned cross-component models such as CCLM and CCCM all follow an intra-like approach, that is, the surrounding reconstructed samples are used to derive the model, while the inter-CCCM uses the prediction block of the original inter prediction to derive the cross-component model (filter coefficients), as shown in FIG. 27. Where resY, resCb, and resCr represent a luma residual value, a blue chroma residual value, and a red chroma residual value, respectively. Then the addition operation is performed in combination with the corresponding prediction values to obtain the luma reconstructed value Y, the blue chroma reconstructed value Cb and the red chroma reconstructed value Cr. That is, after the luma reconstruction is performed, the derived model (filter coefficient) is applied to the luma reconstructed value to obtain a second chroma prediction value, and the original prediction value and the second prediction value obtained by inter-CCCM are weighted as a new prediction value. inter-CCCM converts the reconstructed value including luma residual into chroma prediction through the model, thereby improving compression efficiency.

Further, the transform technology will be described below.

During coding, the current general hybrid coding framework performs prediction first. Prediction exploits spatial or temporal correlation to obtain a picture identical or similar to the current block For a block, it is possible for the prediction block to be exactly the same as the current block, but it is difficult to guarantee this for all blocks in a video, especially for natural or camera-captured videos. It is difficult to completely predict the irregular motion, distortion, occlusion, brightness and other changes in the video. Therefore, the hybrid coding framework will subtract the predicted picture from the original picture of the current block to obtain the residual picture, or subtract the prediction block from the current block to obtain the residual block. The residual block is usually much simpler than the original picture, so prediction can significantly improve the compression efficiency. The residual block is also not directly encoded, but usually transformed first. Transform is to transform the residual picture from the spatial domain to the frequency domain, and remove the correlation of the residual picture. After the residual picture is transformed into the frequency domain, because the energy is mostly concentrated in the low frequency area, the transformed non-zero coefficients are mostly concentrated in the top-left corner. Quantization is then used for further compression. Moreover, since the human eye is insensitive to high frequencies, larger quantization step sizes can be used in high frequency areas.

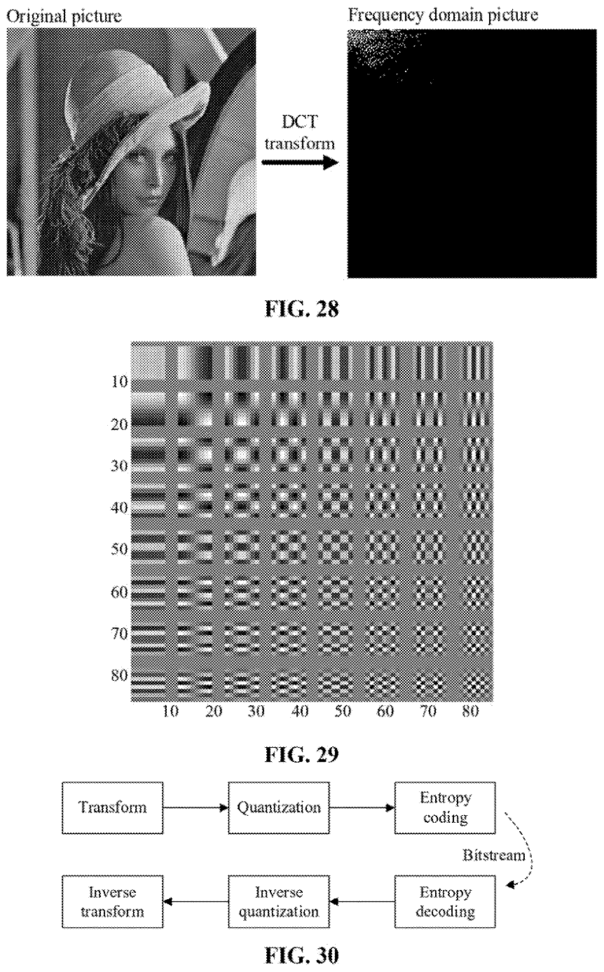

FIG. 28 is a schematic diagram of DCT transform. As shown in FIG. 28, only the top-left corner area of the original picture has non-zero coefficients after DCT transform. Certainly, this example performs DCT transform on the entire picture. In video encoding and decoding, the picture is partitioned into blocks for processing, so the transform is also block-based.

Transform is very useful in common video compression, but not all blocks have to be transformed. In some cases, not transforming yields better compression effect. Therefore, in some standards such as VVC, the encoder can choose whether to use transform for the current block. Where a DCT2 type (DCT-II) is the most commonly used transform in video compression standards, and its transformed base picture is shown in FIG. 29.

In addition, a DCT8 type (DCT-VIII) and a DST7 type (DST-VII) can also be used in VVC. The basic formulas of these transforms are shown in Table 3, where the basic transform formulas of DCT2, DCT8, and DST7 for N point inputs are shown.

TABLE 3

| Transform Type | Basis function Tᵢ(j), i, j = 0, 1, ... , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Since the pictures are all two-dimensional, and the calculation amount and memory overhead of directly performing two-dimensional transform are unacceptable to the hardware conditions at that time, the above-mentioned DCT2, DCT8, and DST7 transforms used in the standard are split into two steps of one-dimensional transforms in horizontal and vertical directions. For example, the horizontal direction transform is performed first and then the vertical direction transform is performed, or the vertical direction transform is performed first and then the horizontal direction transform is performed.

### (1) Multiple Transform Selection (MTS).

VVC supports transform kernels such as DCT2, DCT8, and DST7. For a block, the encoder can select an appropriate transform kernel and transmit the index to the bitstream. The decoder determines the transform kernel of the inverse transform according to the index. Different transform kernels can be selected for the horizontal direction and the vertical direction, such as DCT8 for the horizontal direction and DST7 for the vertical direction. This technique is generally referred to as MTS.

### (2) Low Frequency Non-Separable Transform (LFNST).

The above transform method is more effective for horizontal and vertical textures, but the effect on oblique textures will be worse. Indeed, horizontal and vertical textures are the most common, so the above transform methods are very useful to improve compression efficiency. As the demand for compression efficiency continues to increase, if the oblique texture can be processed more effectively, the compression efficiency can be further improved.

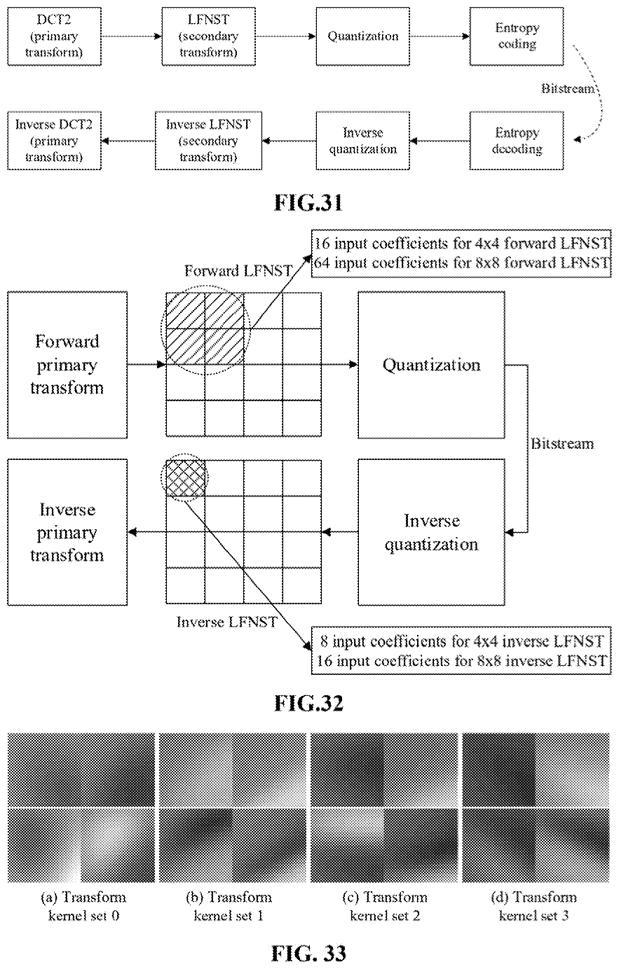

To handle the residuals of oblique textures more efficiently, the LFNST transform is used in VVC. The above transforms such as DCT2, DCT8, and DST7 are referred to as primary transforms. At the encoding end of VVC, LFNST is used after DCT2 transform and before quantization. At the decoding end of VVC, LFNST is used after inverse quantization and before DCT2 inverse transform. Because it is transformed on the basis of DCT2 (primary transform), LFNST is a secondary transform. FIG. 30 is a schematic flowchart of encoding and decoding without LFNST (secondary transform), and FIG. 31 is a schematic flowchart of encoding and decoding with LFNST (secondary transform). Certainly, the encoder can directly inverse quantize the stored quantization coefficients without entropy decoding, because entropy coding is lossless.

FIG. 32 is a detailed schematic flowchart of encoding and decoding with LFNST (secondary transform). As shown in FIG. 32, at the encoding end, the forward primary transform is first performed, and then the LFNST performs a secondary transform on the low frequency coefficients in the top-left corner after the primary transform. Exemplarily, there are 16 input coefficients for a 4×4 LFNST and 64 input coefficients for an 8×8 LFNST. Then, the coefficients after LFNST transform are quantized, and the quantization coefficients are signalled in the bitstream. At the decoding end, the transform coefficients can be obtained by decoding the bitstream and inverse quantization. Then, in the inverse LFNST transform, there are 8 input coefficients for 4×4 inverse LFNST and 16 input coefficients for 8×8 inverse LFNST. Finally, the residual block can be obtained by inverse primary transform.

That is, at the encoding end, the LFNST performs a secondary transform on the low frequency coefficients in the top-left corner after the primary transform. The primary transform concentrates energy to the top-left corner by decorrelating the picture. The secondary transform decorrelates the low frequency coefficients of the primary transform, and the result is intuitively shown in FIG. 32. On the encoder side, 16 coefficients are input to the 4×4 LFNST, and the output is 8 coefficients; 64 coefficients are input to an 8×8 LFNST, and the output is 16 coefficients. On the decoder side, 8 coefficients are input to the 4×4 inverse LFNST, and the output is 16 coefficients; 16 coefficients are input to an 8×8 inverse LFNST, and the output is 64 coefficients.

FIG. 33 shows some base pictures of LFNST in VVC. Some obvious oblique textures can be seen according to FIG. 33. Where LFNST not only has transform kernels optimized for some oblique textures, but also has transform kernels optimized for flat gradient textures, such as transform kernel set 0 of LFNST in VVC.

LFNST is applied only to intra coding blocks. Angle prediction tiles the reference samples to the current block according to the specified angle as the prediction value, which means that the prediction block will have obvious directional texture, and the residual of the current block after angle prediction will also show obvious angular characteristics statistically. Therefore, the transform kernel selected by LFNST can be bound to the intra prediction mode, that is, after the intra prediction mode is determined, LFNST can only use a set of transform kernels corresponding to the intra prediction mode.

Specifically, LFNST in VVC has a total of 4 sets of transform kernels, and 2 transform kernels can be selected for each set. Table 4 shows the correspondence between the intra prediction mode and the transform kernel set. Note that the cross-component prediction modes used in chroma intra prediction are 81 to 83, but luma intra prediction does not have these modes. The transform kernels of the LFNST can be transposed to let one transform kernel set handle more angles correspondingly. Exemplarily, modes 13 to 23 and 45 to 55 all correspond to transform kernel set 2, but 13 to 23 are clearly close to the horizontal mode and 45 to 55 are clearly close to the vertical mode.

TABLE 4

| | Tr. set |
|---|---|
| IntraPredMode | index |
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

The LFNST of the VVC has a total of four sets of transform kernels, and which set is used for the LFNST is specified according to the intra prediction mode. This takes advantage of the correlation between the intra prediction mode and the transform kernel of the LFNST, thereby reducing the transmission of the transform kernel selecting the LFNST in the bitstream. Whether the current block will use LFNST, and if LFNST is used, whether to use the first or second in a set needs to be determined by the bitstream and some conditions.

In the subsequent evolution of ECM technology, LFNST is further expanded. LFNST has more transform kernel sets (35 sets in ECM). The correspondence between the transform kernel set index (LFNST set index) and the intra prediction mode (Intra pred. mode) is shown in Table 5. Each transform kernel set is more efficient for the texture of the corresponding angle. Here, 3 transform kernels can be selected for each transform kernel set.

TABLE 5

| | Intra pred. mode | | | | | | | | | | | | | | | | | | | | | | | |
|---|---|---|---|---|---|---|---|---|---|---|---|---|---|---|---|---|---|---|---|---|---|---|---|---|
| | −14 | −13 | −12 | −11 | −10 | −9 | −8 | −7 | −6 | −5 | −4 | −3 | −2 | −1 | 0 | 1 | 2 | 3 | 4 | 5 | 6 | 7 | 8 | 9 |
| LFNST set index | 2 | 2 | 2 | 2 | 2 | 2 | 2 | 2 | 2 | 2 | 2 | 2 | 2 | 2 | 0 | 1 | 2 | 3 | 4 | 5 | 6 | 7 | 8 | 9 |

| | Intra pred. mode | | | | | | | | | | | | | | | | | | | | | | | |
|---|---|---|---|---|---|---|---|---|---|---|---|---|---|---|---|---|---|---|---|---|---|---|---|---|
| | 10 | 11 | 12 | 13 | 14 | 15 | 16 | 17 | 18 | 19 | 20 | 21 | 22 | 23 | 24 | 25 | 26 | 27 | 28 | 29 | 30 | 31 | 32 | 33 |
| LFNST set index | 10 | 11 | 12 | 13 | 14 | 15 | 16 | 17 | 18 | 19 | 20 | 21 | 22 | 23 | 24 | 25 | 26 | 27 | 28 | 29 | 30 | 31 | 32 | 33 |
| | Intra pred. mode | | | | | | | | | | | | | | | | | | | | | | | |
| | 34 | 35 | 36 | 37 | 38 | 39 | 40 | 41 | 42 | 43 | 14 | 45 | 46 | 47 | 48 | 49 | 50 | 51 | 52 | 53 | 54 | 55 | 56 | 57 |
| LFNST set index | 34 | 33 | 32 | 31 | 30 | 29 | 28 | 27 | 26 | 25 | 24 | 23 | 22 | 21 | 20 | 19 | 18 | 17 | 16 | 15 | 14 | 13 | 12 | 11 |

| | Intra pred. mode | | | | | | | | | | | | | | | | | | | | | | |
|---|---|---|---|---|---|---|---|---|---|---|---|---|---|---|---|---|---|---|---|---|---|---|---|
| | 58 | 59 | 60 | 61 | 62 | 63 | 64 | 65 | 66 | 67 | 68 | 69 | 70 | 71 | 72 | 73 | 74 | 75 | 76 | 77 | 78 | 79 | 80 |
| LFNST set index | 10 | 9 | 8 | 7 | 6 | 5 | 4 | 3 | 2 | 2 | 2 | 2 | 2 | 2 | 2 | 2 | 2 | 2 | 2 | 2 | 2 | 2 | 2 |

### (3) Non-Separable Primary Transform (NSPT).

LFNST is a horizontal and vertical non-separable transform, and DCT2 can be referred to as a primary transform because there is a secondary transform. In this way, it can be said that it is a compromise between performance and complexity to go through DCT2 first and then LFNST, because directly performing inseparable primary transform is more efficient, but it has higher complexity, for example, the amount of calculation and the storage space of the transform kernel are higher.

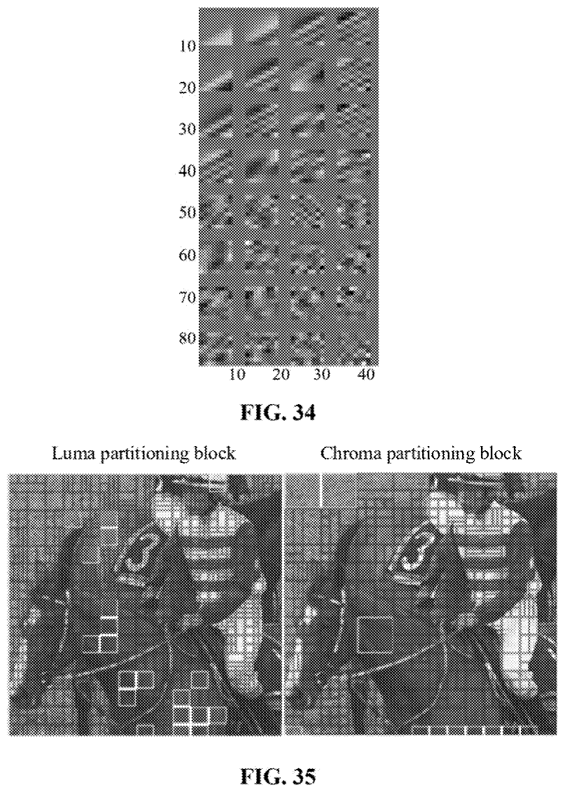

In ECM10, some small blocks can use NSPT, while large blocks still use DCT2+LFNST. For example, the sizes of small blocks include 4×4, 4×8, 8×4, 8×8, 4×16, 16×4, 8×16, 16×8, 8×32, 32×8. In the ECM 10, the NSPT also matches the transform kernel set according to the intra prediction mode. The matching method can refer to the method of LFNST, and each transform kernel set has three transform kernels to select. As an example, an 8×8 base picture of the NSPT in the ECM 10 is shown in FIG. 34, which corresponds to the inter angle prediction mode 7, and it can be seen that it is better to process the texture of the corresponding angle. It should be noted that NSPT is only applied to intra coding blocks.

Further, for the partitioning technique, it can be divided into a Single tree partitioning and a Dual tree partitioning. Where the luma and chroma in the Single tree are partitioned together, and one CU includes luma blocks and chroma blocks at the same position. In Dual tree, luma and chroma are partitioned separately, and one CU has only luma blocks or only chroma blocks. There is only Single tree in HEVC. Dual tree is introduced in VVC, but P and B slice in VVC can only use Single tree. I slice in VVC can be used with Dual tree. As shown in FIG. 35, luma and chroma are separately partitioned, and it can be seen that luma has a finer partition than chroma, because luma has more detail than chroma, and generally luma requires better quality than chroma.

As can be seen from the above, LFNST and NSPT can be applied to an intra coding block or an inter coding block. Although for transform, residual blocks and transform coefficients are provided here, only transform and inverse transform are required. But in fact, the current block may or may not use LFNST/NSPT, and there are multiple transform kernels that can be selected in a transform kernel set of LFNST/NSPT. That is, the encoder can choose whether to use LFNST/NSPT and which transform kernel of the LFNST/NSPT to use. If LFNST/NSPT is not used, other transform methods may be selected, such as horizontal and vertical primary transforms selected from DCT2, DCT8, DST7.

In addition, the residuals generated by intra prediction and inter prediction are statistically quite different. Intra prediction can predict the current block according to the reconstructed pictures around the current block. If the original picture of the current block has changes that the reconstructed pictures around the current block do not have, it is difficult for intra prediction to obtain a good prediction block, which also means that the residual is relatively large. Inter prediction uses pictures of the same object at different times to predict the current block. If the objects in the current block do not change significantly or are occluded in the time interval between the reference picture and the current picture, inter prediction can get a good prediction block, which also means that the residual is usually relatively small. Certainly, there will also be poor prediction in inter prediction, such as obvious changes in objects and occlusion. Fundamentally speaking, good content cannot be found from other encoded pictures, leading to significant residual. Simply put, because there are essential differences between intra prediction and inter prediction, the statistical rules of their residuals are different. This results in that although both LFNST/NSPT can be used for intra prediction and inter prediction, there are still differences.

An embodiment of the present disclosure provides a method for encoding, which includes: determining a prediction mode of a current block; determining at least one context model according to the prediction mode of the current block; determining a value of first syntax identification information, and performing binarization processing on the value of the first syntax identification information to determine a bin string of the current block, where the bin string includes at least one binary symbol; and encoding at least one binary symbol in the bin string according to the at least one context model, and signalling obtained encoded bits in a bitstream. An embodiment of the present disclosure further provides a method for decoding, which includes: determining a prediction mode of a current block; determining at least one context model according to the prediction mode of the current block; decoding a bitstream according to the at least one context model to determine a bin string of the current block, where the bin string includes at least one binary symbol; performing inverse binarization processing on the bin string to determine a value of first syntax identification information; and when the first syntax identification information indicates that the current block uses a first transform mode, determining a transform kernel of the current block, and performing inverse transform on transform coefficients of the current block according to the transform kernel to determine a residual block of the current block.

In this way, both the encoder side and the decoder side first determine at least one context model according to the prediction mode of the current block, and then encode/decode the bin string corresponding to the first syntax identification information according to the determined at least one context model. That is, different context models can be selected for the intra prediction mode or the inter prediction mode, so that the encoding and decoding method conforming to the distribution characteristics of the bin string of LFNST/NSPT in the inter prediction mode can be used, thereby not only improving the compression efficiency, that is, the video encoding and decoding efficiency, but also improving the encoding and decoding performance.

Hereinafter, the embodiments of the present disclosure will be described in detail with reference to the drawings.

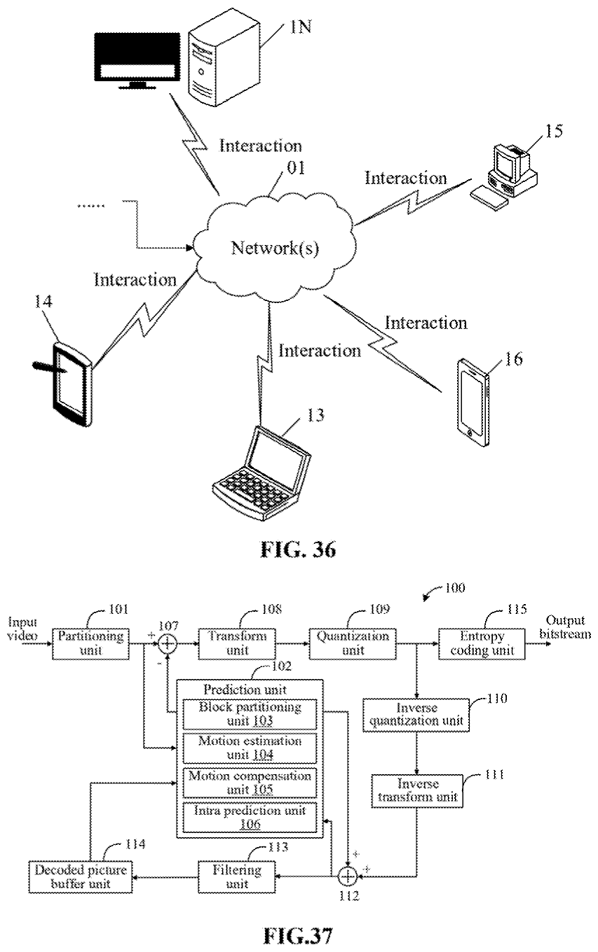

FIG. 36 is a schematic diagram of network architecture of video encoding and decoding according to an embodiment of the present disclosure. As shown in FIG. 36, the network architecture includes one or more electronic devices 13 to 1N and a communication network 01, here the electronic devices 13 to 1N may perform video interaction through the communication network 01. The electronic devices may be various types of devices with video encoding and decoding functions during implementation, for example, the electronic devices may include a phone, a tablet computer, a personal computer, a personal digital assistant, a navigator, a digital phone, a video phone, a television, a sensor device, a server, or the like, which is not limited in the embodiments of the disclosure.

In an embodiment of the present disclosure, a network architecture of a video encoding and decoding system including a decoding method and an encoding method is provided herein. Where the decoder or encoder in the embodiment of the present disclosure may be the electronic device described above. That is, the electronic device in the embodiment of the present disclosure has a video encoding and decoding function, and generally includes a video encoder (that is, an encoder) and a video decoder (that is, a decoder).

FIG. 37 is a schematic block diagram of a system composition of an encoder according to an embodiment of the present disclosure. As shown in FIG. 37, the encoder 100 may include a partitioning unit 101, a prediction unit 102, a first adder 107, a transform unit 108, a quantization unit 109, an inverse quantization unit 110, an inverse transform unit 111, a second adder 112, a filtering unit 113, a Decoded Picture Buffer (DPB) unit 114, and an entropy coding unit 115. Here, the input of the encoder 100 may be a video composed of a series of pictures or one still picture, and the output of the encoder 100 may be a bit stream (which may also be referred to as a “bitstream”) for representing a compressed version of the input video.

Where the partitioning unit 101 partitions the pictures in the input video into one or more Coding Tree Units (CTUs). The partitioning unit 101 partitions a picture into a plurality of tiles, and may further partition a tile into one or more bricks, where one or more complete and/or partial CTUs may be included in a tile or a brick. In addition, the partitioning unit 101 may form one or more slices, and one slice may include one or more tiles arranged in a raster order in a picture, or cover one or more tiles of the rectangular area in the picture. The partitioning unit 101 may also form one or more sub-pictures, where one sub-picture may include one or more slices, tiles, or bricks.

In the encoding process of the encoder 100, the partitioning unit 101 transmits the CTU to the prediction unit 102. Generally, the prediction unit 102 may be composed of a block partitioning unit 103, a Motion Estimation (ME) unit 104, a Motion Compensation (MC) unit 105, and an intra prediction unit 106. Specifically, the block partitioning unit 103 further partitions the input CTU into smaller Coding Units (CUs) iteratively using quadtree partitioning, binary tree partitioning, and ternary tree partitioning. The prediction unit 102 may acquire an inter prediction block of the CU using the ME unit 104 and the MC unit 105. The intra prediction unit 106 may acquire the intra prediction block of the CU using various intra prediction modes including the MIP mode. In an example, a motion estimation manner of rate distortion optimization may be invoked by the ME unit 104 and the MC unit 105 to obtain an inter prediction block, and a mode determination manner of rate distortion optimization may be invoked by the intra prediction unit 106 to obtain an intra prediction block.

The prediction unit 102 outputs the prediction block of the CU, and the first adder 107 calculates the difference between the CU and the prediction block of the CU in the output of the partitioning unit 101, that is, the residual CU. The transform unit 108 reads the residual CU and performs one or more transform operations on the residual CU to acquire coefficients. The quantization unit 109 quantizes the coefficients and outputs quantization coefficients (i.e., levels). The inverse quantization unit 110 performs a scaling operation on the quantization coefficients to output the reconstructed coefficients. The inverse transform unit 111 performs one or more inverse transforms corresponding to the transform in the transform unit 108 and outputs the reconstructed residual. The second adder 112 calculates the reconstructed CU by adding the reconstructed residual and the prediction block of the CU from the prediction unit 102. The second adder 112 also sends its output to the prediction unit 102 for use as an intra prediction reference. After all the CUs in the picture or sub-picture are reconstructed, the filtering unit 113 performs loop filtering on the reconstructed picture or sub-picture. Here, the filtering unit 113 includes one or more filters such as a de-blocking filter, a Sample Adaptive Offset (SAO) filter, an Adaptive Loop Filter (ALF), a Luma Mapping with Chroma Scaling (LMCS) filter, a neural network-based filter, and the like. Alternatively, when the filtering unit 113 determines that the CU is not used as a reference when encoding other CUs, the filtering unit 113 performs loop filtering on one or more target samples in the CU.

The output of the filtering unit 113 is a decoded picture or sub-picture, which is buffered to the DPB unit 114. The DPB unit 114 outputs a decoded picture or a sub-picture according to the timing and control information. Here, the picture stored in the DPB unit 114 may also be used as a reference for the prediction unit 102 to perform inter prediction or intra prediction. Finally, the entropy coding unit 115 converts parameters necessary for decoding pictures from the encoder 100 (such as control parameters and supplementary information, etc.) into binary forms, and signals such binary forms into the bitstream according to the syntax structure of each data unit, that is, the encoder 100 finally outputs the bitstream.

Further, the encoder 100 may include a first processor and a first memory in which a computer program is recorded. When the first processor reads and runs the computer program, the encoder 100 reads the input video and generates a corresponding bitstream. Additionally, the encoder 100 may also be a computing device having one or more chips. These units, which are implemented on-chip as integrated circuits, have connection and data exchange functions similar to the corresponding units in FIG. 37.

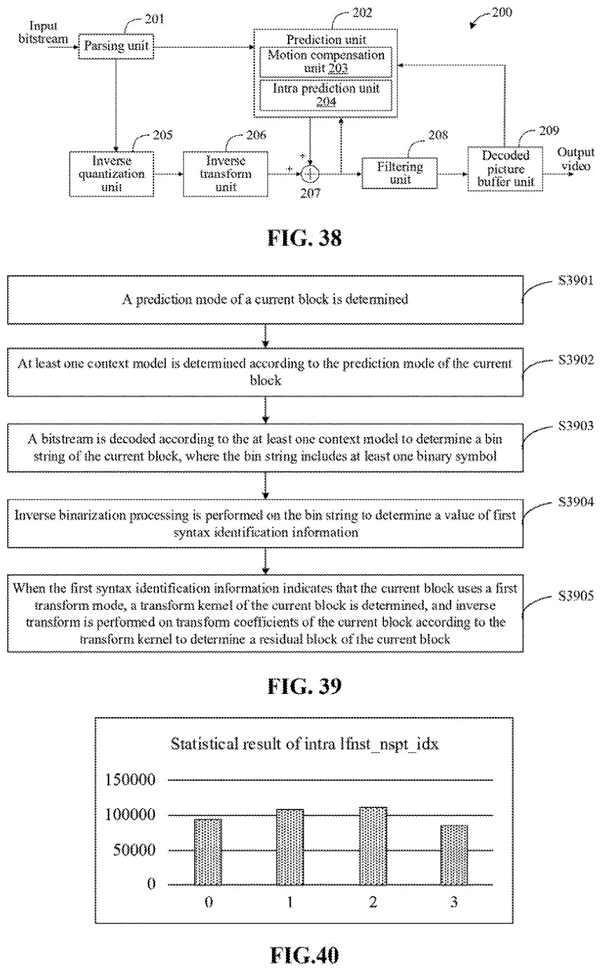

FIG. 38 is a schematic block diagram of a system composition of a decoder according to an embodiment of the present disclosure. As shown in FIG. 38, the decoder 200 may include a parsing unit 201, a prediction unit 202, an inverse quantization unit 205, an inverse transform unit 206, an adder 207, a filtering unit 208, and a decoded picture buffer unit 209. Here, the input of the decoder 200 is a bit stream representing a compressed version of a video or a still picture, and the output of the decoder 200 may be a decoded video composed of a series of pictures or a decoded still picture.

The input bitstream of the decoder 200 may be a bitstream generated by the encoder 100. The parsing unit 201 parses the input bitstream and acquires the value of the syntax element from the input bitstream. The parsing unit 201 converts the binary representation of the syntax element into a digital value and transmits the digital value to a unit in the decoder 200 to acquire one or more decoded pictures. The parsing unit 201 may also parse one or more syntax elements from the input bitstream to display the decoded picture.

In the decoding process of the decoder 200, the parsing unit 201 transmits the value of the syntax element and one or more variables for acquiring one or more decoded pictures set or determined according to the value of the syntax element to the unit in the decoder 200.

The prediction unit 202 determines a prediction block of a current coding block (e.g., CU). Here, the prediction unit 202 may include a motion compensation unit 203 and an intra prediction unit 204. Specifically, when the inter decoding mode is indicated for decoding the current coding block, the prediction unit 202 passes the relevant parameters from the parsing unit 201 to the motion compensation unit 203 to acquire the inter prediction block. When an intra prediction mode (including a MIP mode indicated based on the MIP mode index value) is indicated for decoding the current coding block, the prediction unit 202 transmits the relevant parameters from the parsing unit 201 to the intra prediction unit 204 to acquire the intra prediction block.

The inverse quantization unit 205 has the same function as the inverse quantization unit 110 in the encoder 100. The inverse quantization unit 205 performs a scaling operation on the quantization coefficients (i.e., levels) from the parsing unit 201 to obtain the reconstructed coefficients. The inverse transform unit 206 has the same function as the inverse transform unit 111 in the encoder 100. The inverse transform unit 206 performs one or more transform operations (i.e., the inverse of the one or more transform operations performed by the inverse transform unit 111 in the encoder 100) to obtain the reconstructed residual. The adder 207 performs an addition operation on its inputs (the prediction block from the prediction unit 202 and the reconstructed residual from the inverse transform unit 206) to obtain the reconstructed block of the current coding block. The reconstructed block is also transmitted to the prediction unit 202 to serve as a reference for other blocks encoded in the intra prediction mode.

After all the CUs in the picture or sub-picture are reconstructed, the filtering unit 208 performs loop filtering on the reconstructed picture or sub-picture. The filtering unit 208 includes one or more filters, such as a de-blocking filter, a sample adaptive compensation filter, an adaptive loop filter, a luma mapping with chroma scaling filter, a neural network-based filter, and the like. Alternatively, when the filtering unit 208 determines that the reconstructed block is not used as a reference when decoding other blocks, the filtering unit 208 performs loop filtering on one or more target samples in the reconstructed block. Here, the output of the filtering unit 208 is a decoded picture or sub-picture, which is buffered to the DPB unit 209. The DPB unit 209 outputs a decoded picture or a sub-picture according to the timing and control information. The pictures stored in the DPB unit 209 may also be used as a reference for performing inter prediction or intra prediction by the prediction unit 202.

Further, the encoder 200 may include a second processor and a second memory in which a computer program is recorded. When the first processor reads and runs the computer program, the decoder 200 reads the input bitstream and generates the corresponding decoded video. Additionally, the decoder 200 may also be a computing device having one or more chips. These units, which are implemented on-chip as integrated circuits, have connection and data exchange functions similar to the corresponding units in FIG. 38.

It should also be noted that when the embodiments of the present disclosure are applied to the encoder 100, the “current block” specifically refers to a block currently to be encoded in a video picture (which may also be simply referred to as a “encoding block”). When the embodiments of the present disclosure are applied to the decoder 200, the “current block” specifically refers to a block currently to be decoded in a video picture (which may also be simply referred to as a “decoding block”).

In an embodiment of the present disclosure, see FIG. 39, which shows a first schematic flowchart of a method for decoding according to an embodiment of the present disclosure. As shown in FIG. 39, the method may include the following operations.

At S3901: a prediction mode of a current block is determined.

It should be noted that, in the embodiment of the present disclosure, the method is applied to a decoder. Specifically, based on the composition structure of the decoder 200 shown in FIG. 38, the decoding method of the embodiment of the present disclosure can be applied to the intra prediction mode and/or the inter prediction mode, and here, the optimization scheme is mainly proposed for NSPT and LFNST transforms in the inter prediction mode, to improve the compression efficiency.

It should also be noted that, in the embodiment of the present disclosure, the prediction mode of the current block may include an inter prediction mode and/or an intra prediction mode. Where the intra prediction mode mainly predicts the current block according to the reconstructed area around the current block, and the inter prediction mode mainly predicts the current block according to the reference picture of the current block.

At S3902: at least one context model is determined according to the prediction mode of the current block.

Note that, in the embodiment of the present disclosure, it is determined that at least one context model corresponding to the inter prediction mode is different from at least one context model corresponding to the intra prediction mode. That is, the inter prediction mode and the intra prediction mode do not share a context model.

At S3903: a bitstream is decoded according to the at least one context model to determine a bin string of the current block, where the bin string includes at least one binary symbol.

At S3904: inverse binarization processing is performed on the bin string to determine a value of first syntax identification information.

It should also be noted that in the embodiment of the present disclosure, the number of context models is related to the number of binary symbols. If the bin string of the current block includes n binary symbols, then here, n context models need to be determined according to the prediction mode of the current block. Where each binary symbol is decoded using a context model. Here, n is a positive integer.

In one possible implementation, the bin string may use the same inverse binarization mode, but different context models, for the intra prediction mode and the inter prediction mode.

In some embodiments, decoding the bitstream according to the at least one context model to determine the bin string of the current block may include: when the prediction mode of the current block is an intra prediction mode, decoding the bitstream according to at least one first context model to determine a first bin string of the current block; or, when the prediction mode of the current block is an inter prediction mode, decoding the bitstream according to at least one second context model to determine a second bin string of the current block.

In embodiments of the present disclosure, the at least one first context model is different from the at least one second context model, i.e., the inter prediction mode and the intra prediction mode do not share the context model.

In some embodiments, performing the inverse binarization processing on the bin string to determine the value of the first syntax identification information may include: when the prediction mode of the current block is at least one of the intra prediction mode or the inter prediction mode, performing the inverse binarization processing on the bin string based on a first mode to determine the value of the first syntax identification information.

In the embodiment of the present disclosure, both the inter prediction mode and the intra prediction mode may perform decoding processing using the first mode. The first mode may be a Fixed-Length (FL) decoding mode, which may also be referred to as an FL decoding mode, that is, the same number of binary symbols is used to represent different values of the first syntax identification information. Alternatively, the first mode may be a truncated unary code mode, that is, different numbers of binary symbols are used to represent different values of the first syntax identification information. Alternatively, the first mode may even be another mode, such as a unary code mode, a K-order exponential Columbus decoding mode, and the like, which is not specifically limited here.

In an embodiment of the present disclosure, the first syntax identification information may be represented by lfnst_nspt_idx. For example, the value of lfnst_nspt_idx may be 0, 1, 2, or 3. If the first mode is the fixed-length decoding mode, the binarization table shown in Table 6 can be used. In Table 6, the value of the first syntax identification information uses two binary symbols, and both of these two binary symbols may be decoded using the context model. Where the first (binIdx equals to 0) binary symbol uses a context model and the second (binIdx equals to 1) binary symbol uses a context model.

TABLE 6

| | |
|---|---|
| The value of | BinIdx |

| lfnst_nspt_idx | 0 | 1 |
|---|---|---|
| 0 | 0 | 0 |
| 1 | 1 | 0 |
| 2 | 0 | 1 |
| 3 | 1 | 1 |

If the first mode is the truncated unary code mode, the binarization table shown in Table 7 can be used. In Table 7, the value of the first syntax identification information may use different bin string lengths. Where the three binary symbols in Table 7 can all be decoded by context models. Where the first (binIdx equals to 0) binary symbol uses a context model, the second (binIdx equals to 1) binary symbol uses a context model, and the third (binIdx equals to 2) binary symbol uses a context model.

TABLE 7

| The value of | BinIdx | | |
|---|---|---|---|
| lfnst_nspt_idx | 0 | 1 | 2 |
| 0 | 0 | | |
| 1 | 1 | 0 | |
| 2 | 1 | 1 | 0 |
| 3 | 1 | 1 | 1 |

It should be noted that, in the embodiment of the present disclosure, the decoding rule of the unary code is that when the binary symbol “x” to be decoded >=0, the decoded bin string may be composed of x number of “1”s followed by a “0”. For example, if x=5, the bin string is “111110” after decoding according to the unary code mode.

It should also be noted that in the embodiment of the present disclosure, the truncated unary code belongs to a variant of the unary code, and is used when the maximum value Max of the syntax element to be decoded is known. Assuming that the symbol to be decoded is x, if 0<x<Max, then the bin string corresponding to x adopts the unary code mode; if x=Max, then the bin string corresponding to x is all composed of 1 and has a length of Max. For example, assuming Max=6, if x=6, after decoding according to the truncated unary code mode, the bin string is “111111”; if x=3, the bin string is “1110” after decoding according to the truncated unary code mode.

It can be understood that in the embodiment of the present disclosure, both NSPT and LFNST are transforms that process textures of various angles, and there may be multiple transform kernels here, and one transform kernel may be specially optimized for a specific angle texture. In addition to angular textures, NSPT and LFNST also include transform kernels that handle gradient textures. In fact, these transform kernels can also be said to be the trained Karhunen-Loeve (KL) Transform (KLT). That is, both NSPT and LFNST can have multiple transform kernels, each of which is designed for a specific texture. Where specific textures include angle textures, gradient textures, etc. In addition, the gradient texture can be further expanded such as horizontal gradient texture, vertical gradient texture, oblique gradient texture, etc. Further, this scheme is not limited to non-separable transforms such as NSPT and LFNST, and can also be applied to separable transforms optimized for specific textures.

It should also be noted that, in the embodiment of the present disclosure, both the NSPT and the LFNST include a plurality of transform kernel sets, and each transform kernel set includes three optional transform kernels. In addition, if the LFNST/NSPT is not used, there are four possible options per block for the LFNST/NSPT. In the embodiment of the present disclosure, the syntax element lfnst_idx may be used to indicate whether LFNST is used and which LFNST transform kernel is used. lfnst_idx is equal to 0, indicating that the current block does not use LFNST; lfnst_idx is equal to 1, indicating that the current block uses the first transform kernel of LFNST; lfnst_idx is equal to 2, indicating that the current block uses the second transform kernel of LFNST. It should be noted that the transform kernel set may be determined by an intra prediction mode or a texture feature index, and no syntax element indication is required at this time. In addition, for a transform kernel set, only two transform kernels can be selected in some techniques, and three transform kernels can be selected in other techniques. Moreover, NSPT is used for small blocks of a certain size, which can also be three transform kernels. In the embodiment of the present disclosure, lfnst_nspt_idx may be used here to indicate whether LFNST/NSPT is used and which transform kernel of LFNST/NSPT is used. Because in one possible implementation it indicates the transform kernel index of NSPT for smaller blocks and the transform kernel index of LFNST for larger blocks. That is, the value of lfnst_nspt_idx may be 0, 1, 2, 3. Certainly, the embodiment of the present disclosure may continue to use the syntax element lfnst_idx, or may also use two syntax elements of lfnst_idx and nspt_idx, where lfnst_idx indicates whether to use LFNST and which transform kernel of LFNST to use, and nspt_idx indicates whether to use NSPT and which transform kernel of NSPT to use. They are substantially the same here and are not specifically limited herein.

For example, for the value of lfnst_nspt_idx in the intra prediction mode, the binarization mode may be as shown in Table 6. It can be seen that the binarization mode of lfnst_nspt_idx of the intra prediction mode uses two binary symbols, and both two binary symbols are decoded by context models. The first (binIdx equals to 0) binary symbol uses a context model and the second (binIdx equals to 1) binary symbol uses a context model.

It should be noted that the binarization mode and context model configuration set in this way are related to its statistical laws. As shown in FIG. 40, a schematic diagram of a statistical result of lfnst_nspt_idx corresponding to intra prediction modes in some techniques is shown here. Specifically, FIG. 40 is a statistical result of the value of intra lfnst_nspt_idx in the test sequence MarketPlace at all intra QP 32. According to FIG. 40, it can be seen that under this condition, for the value of lfnst_nspt_idx, the possibilities of the four options are almost the same, and the possibilities of 1 and 2 are even more than 0. It should be noted that this is only an example, and the statistical results corresponding to different test sequences and different QPs are different.

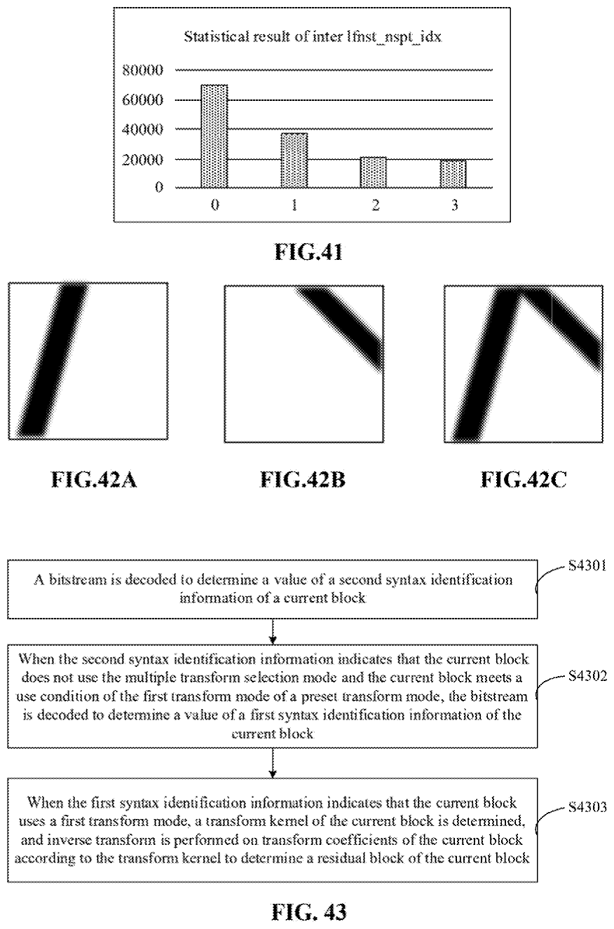

Further, using the same binarization mode, the statistical results of lfnst_nspt_idx corresponding to the inter prediction mode in some techniques calculated by lfnst_nspt_idx are shown in FIG. 41. Specifically, FIG. 41 is a statistical result of an inter lfnst_nspt_idx in the test sequence BasketballDrive at random access QP 32. According to FIG. 41, it can be seen that under this condition, there is a certain gap between the possibilities of the four options for the value of lfnst_nspt_idx. 0 is significantly higher than 1, 2, 3, and 1 is higher than 2, 3. It should be noted that this is only an example, and the statistical results corresponding to different test sequences and different QPs are different.

Based on theoretical analysis and statistical data of the probability distribution of the inter lfnst_nspt_idx, the embodiment of the present disclosure proposes a binarization mode of the inter lfnst_nspt_idx, as specifically shown in Table 7. According to Table 7, it can be seen that the binarization mode of inter lfnst_nspt_idx uses different bin string lengths, which is a truncated unary code mode. Here, the three binary symbols may all be decoded by context models. Where the first (binIdx equals to 0) binary symbol uses a context model, the second (binIdx equals to 1) binary symbol uses a context model, and the third (binIdx equals to 2) binary symbol uses a context model.

In another possible implementation, the bin string may use different inverse binarization modes and different context models for the intra prediction mode and the inter prediction mode.

In some embodiments, decoding the bitstream according to the at least one context model to determine the bin string of the current block may include: when the prediction mode of the current block is an intra prediction mode, decoding the bitstream according to at least one first context model and a first mode to determine a first bin string of the current block; or, when the prediction mode of the current block is an inter prediction mode, decoding the bitstream according to at least one second context model and a second mode to determine a second bin string of the current block.

In some embodiments, performing the inverse binarization processing on the bin string to determine the value of the first syntax identification information may include: when the prediction mode of the current block is the intra prediction mode, performing the inverse binarization processing on the bin string based on a first mode to determine the value of the first syntax identification information; or when the prediction mode of the current block is the inter prediction mode, performing the inverse binarization processing on the bin string based on a second mode to determine the value of the first syntax identification information.

In embodiments of the present disclosure, the at least one first context model is different from the at least one second context model, i.e., the inter prediction mode and the intra prediction mode do not share the context model. Further, the first mode is different from the second mode, that is, different binarization modes are used in the inter prediction mode and the intra prediction mode.

In a specific embodiment, the first mode may be a fixed-length decoding mode, and the second method may be a truncated unary code mode. As such, when the prediction mode of the current block is an intra prediction mode, the bitstream is decoded according to at least one first context model and a fixed-length decoding mode to determine a first bin string of the current block; or, when the prediction mode of the current block is an inter prediction mode, the bitstream is decoded according to at least one second context model and a truncated unary code mode to determine a second bin string of the current block. In this implementation, for different values of the first syntax identification information lfnst_nspt_idx, the length of the first bin string is unchanged, and the length of the second bin string is changed.

Simply put, different decoding methods and different context models can be used for the transform kernel index (i.e., the value of lfnst_nspt_idx) of the intra prediction mode and the inter prediction mode. Specifically, the context model used by lfnst_nspt_idx of the inter prediction mode is different from the context model used by lfnst_nspt_idx of the intra prediction mode, or lfnst_nspt_idx of the inter prediction mode and lfnst_nspt_idx of the intra prediction mode do not share the context model. Where one possible implementation is that lfnst_nspt_idx of the inter prediction mode and lfnst_nspt_idx of the intra prediction mode use the same binarization mode, but different context models. Another possible implementation is that lfnst_nspt_idx of the inter prediction mode and lfnst_nspt_idx of the intra prediction mode use different binarization modes, and different context models.

It should also be noted that in the embodiment of the present disclosure, the LFNST/NSPT may share one syntax element lfnst_nspt_idx, specifically, the transform kernel index of the NSPT is indicated for a smaller block, and the transform kernel index of the LFNST is indicated for a larger block. Alternatively, the LFNST/NSPT may use different syntax elements, for example, the LFNST uses the syntax element lfnst_idx and the NSPT uses the syntax element nspt_idx, but the above method is still applicable for the binarization of lfnst_idx and nspt_idx.

At S3905: when the first syntax identification information indicates that the current block uses a first transform mode, a transform kernel of the current block is determined, and inverse transform is performed on transform coefficients of the current block according to the transform kernel to determine a residual block of the current block.

Note that, in the embodiment of the present disclosure, determining the transform kernel of the current block may include: determining a transform kernel set of the current block; and determining a transform kernel of the current block according to the transform kernel set and the value of the first syntax identification information.

Herein when the current block uses the first transform mode, the value of the first syntax identification information further indicates a number of the transform kernel of the current block in the transform kernel set. In this way, according to the value of the transform kernel set and the first syntax identification information, the transform kernel of the current block can be determined.

Further, in the embodiment of the present disclosure, when intra prediction is performed on the current block, the transform kernel set of the current block may be determined according to the correspondence between the intra prediction mode and the transform kernel set. When inter prediction is performed on the current block, the transform kernel set of the current block may be determined according to the correspondence between the texture feature index (i.e., the virtual intra prediction mode) and the transform kernel set. Where the texture feature index of the current block may be derived using a prediction block or a reference block of the current block or a reconstructed area around the current block.

In some embodiments, determining the transform kernel set of the current block may include: when the prediction mode of the current block is the intra prediction mode, determining that the transform kernel set includes M candidate transform kernels; or when the prediction mode of the current block is the inter prediction mode, determining that the transform kernel set includes N candidate transform kernels. Where M and N are both positive integers, and M is greater than or equal to N.

That is, in the embodiment of the present disclosure, there may be more or less options for LFNST/NSPT, and the number of transform kernels available for LFNST/NSPT of inter prediction may be different from the number of transform kernels available for LFNST/NSPT of intra prediction. Exemplarily, since there are more residual for intra prediction and less residual for inter prediction, one transform kernel set for intra prediction has 3 transform kernels and one transform kernel set for inter prediction has 2 transform kernels. In this case, the value of lfnst_nspt_idx for inter prediction may be 0, 1, 2.

Exemplarily, Table 8 provides another binarization mode of lfnst_nspt_idx for inter prediction as shown below.

TABLE 8

| | |
|---|---|
| The value of | BinIdx |

| lfnst_nspt_idx | 0 | 1 |
|---|---|---|
| 0 | 0 | |
| 1 | 1 | 0 |
| 2 | 1 | 1 |

According to Table 8, it can be seen that the binarization mode of lfnst_nspt_idx of inter prediction may use different bin string lengths, which is a truncated unary code mode. The two binary symbols may both be decoded by context models. The first (binIdx equals to 0) binary symbol uses a context model and the second (binIdx equals to 1) binary symbol uses a context model.

Specifically, the context model used by lfnst_nspt_idx of the inter prediction is different from the context model used by lfnst_nspt_idx of the intra prediction, or lfnst_nspt_idx of the inter prediction and lfnst_nspt_idx of the intra prediction do not share the context model. In addition, LFNST/NSPT may each use different syntax elements, and the above method is still applicable.

In some embodiments, the method further includes: when M is greater than N, setting the N candidate transform kernels to be a subset of the M candidate transform kernels; or when M is equal to N, setting the N candidate transform kernels to be at least partially different from the M candidate transform kernels.

Note that, in the embodiment of the present disclosure, the transform kernel available for the inter LFNST/NSPT may be the same as the transform kernel available for the intra LFNST/NSPT. If the number of transform kernels available for inter LFNST/NSPT is less than the number of transform kernels available for intra LFNST/NSPT, then the transform kernels available for inter LFNST/NSPT may be a subset of the transform kernels available for intra LFNST/NSPT. For example, two transform kernels may be used for inter prediction, three transform kernels may be used for intra prediction, and the transform kernels available for inter prediction may be the first two or the last two or the first or third transform kernels available for intra prediction, which are not specifically limited herein.

Note that, in the embodiment of the present disclosure, the transform kernel available for the inter LFNST/NSPT may be different from the transform kernel available for the intra LFNST/NSPT. That is to say, the transform kernel is designed according to the residual characteristics of inter prediction and intra prediction respectively, so as to achieve higher compression efficiency. Exemplarily, three transform kernels may be used for inter prediction and three transform kernels may also be used for intra prediction, but the three transform kernels of inter prediction and the three transform kernels of intra prediction are partially or completely different.

That is, in the embodiment of the present disclosure, the transform kernel used for inter prediction and the transform kernel used for intra prediction may be the same, or may be partially or completely different. In addition, in the embodiment of the present disclosure, the available transform kernel refers to a transform kernel available in one transform kernel set.

In some embodiments, when determining the transform kernel set of the current block, the method may further include: determining at least one texture feature of the current block; and performing transform kernel training according to the at least one texture feature to determine the transform kernel set of the current block.

Note that, in the related art, intra prediction may correspond to one transform kernel set according to the intra prediction mode, and in the embodiment of the present disclosure, inter prediction may derive a virtual intra prediction mode (texture feature index) using a prediction block to correspond to one transform kernel set. Inter prediction may also derive different texture features than intra prediction, and correspondingly train the transform kernel with such texture features.

For example, at present, LFNST and NSPT train a relatively single texture feature, such as a texture in a specific direction, as shown in FIG. 42 A and FIG. 42B. It should be noted that this is only a schematic diagram, but for inter prediction, residuals appear more on the edges of objects. For example, if inter prediction often produces residuals with two directional textures, as shown in FIG. 42C, then such a transform kernel of LFNST/NSPT can also be trained. When analyzing the texture features of the current block (such as the process of deriving the virtual intra prediction mode described above), if it is found that the prediction block or the surrounding reconstructed area of the current block has textures in two directions, then the transform kernel with such texture features can be matched.

Hereinafter, the decoding order of the syntax elements will be described in detail in conjunction with the second identification information, the third syntax identification information, and the fourth syntax identification information.

In one possible implementation, for an inter prediction mode, referring to FIG. 43, the method may include operations as follows.

At S4301: a bitstream is decoded to determine a value of a second syntax identification information of a current block.

At S4302: when the second syntax identification information indicates that the current block does not use the multiple transform selection mode and the current block meets a use condition of the first transform mode, the bitstream is decoded to determine a value of a first syntax identification information of the current block.

At S4303: when the first syntax identification information indicates that the current block uses a first transform mode, a transform kernel of the current block is determined, and inverse transform is performed on transform coefficients of the current block according to the transform kernel to determine a residual block of the current block.

Note that, in the embodiment of the present disclosure, both the first syntax identification information and the second syntax identification information can be decoded using the context model. Specifically, in operation S4302, decoding the bitstream to determine the value of the first syntax identification information of the current block may include: decoding the bitstream according to at least one context model to determine a bin string of the first syntax identification information; and performing inverse binarization processing on the bin string of the first syntax identification information to determine the value of the first syntax identification information. For operation S4301, decoding the bitstream to determine the value of the second syntax identification information of the current block may include: decoding the bitstream according to at least one context model to determine a bin string of the second syntax identification information; and performing inverse binarization processing on the bin string of the second syntax identification information to determine the value of the second syntax identification information. Here, each binary symbol in the bin string uses a context model.

Further, in the embodiment of the present disclosure, the first syntax identification information is represented by lfnst_nspt_idx, and the second syntax identification information is represented by mts_idx. Where lfnst_nspt_idx is used to indicate whether the current block uses a first transform mode (i.e., LFNST/NSPT), and mts_idx is used to indicate whether the current block uses a multiple transform selection mode (i.e., MTS). That is, when the bitstream is decoded, the syntax element lfnst_nspt_idx of the LFNST/NSPT may follow the syntax element mts_idx of the MTS.

In some embodiments, if the value of the first syntax identification information is a first value, it may be determined that the current block does not use LFNST/NSPT. If the value of the first syntax identification information is the second value, it may be determined that the current block uses LFNST/NSPT and which transform kernel is used correspondingly. Where the first value may be set to 0, and the second value may be set to a non-zero value, such as 1, 2, 3, etc.

In some embodiments, if the value of the second syntax identification information is the first value, it may be determined that the current block does not use the multiple transform selection mode. If the value of the second syntax identification information is the second value, it may be determined that the current block uses the multiple transform selection mode and which transform kernel is used correspondingly. Where the first value may be set to 0, and the second value may be set to a non-zero value, such as 1, 2, 3, etc.

It should also be noted that, in the embodiment of the present disclosure, if the second syntax identification information indicates that the current block uses the multiple transform selection mode, it is no longer necessary to decode lfnst_nspt_idx, and at this time, a plurality of transform kernels of the current block may be determined, and the transform coefficients of the current block may be inversely transformed according to the plurality of transform kernels to determine a residual block of the current block. For example, mts_idx is used to indicate which (primary) transform kernel is used for the horizontal/vertical direction of the current block, respectively.

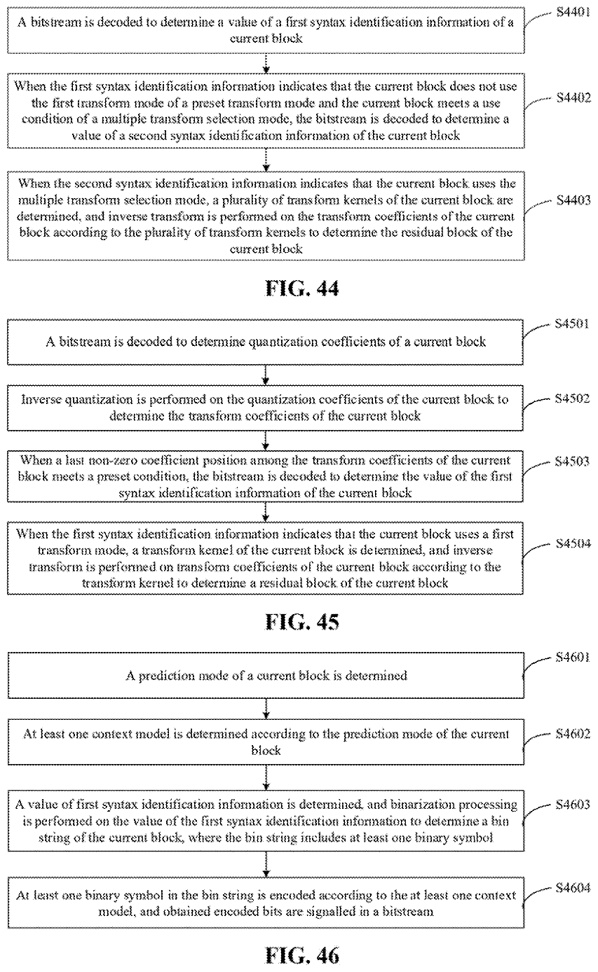

In another possible implementation, for an intra prediction mode, referring to FIG. 44, the method may include operations as follows.

At S4401: a bitstream is decoded to determine a value of a first syntax identification information of a current block.

At S4402: when the first syntax identification information indicates that the current block does not use the first transform mode and the current block meets a use condition of a multiple transform selection mode, the bitstream is decoded to determine a value of a second syntax identification information of the current block.

At S4403: when the second syntax identification information indicates that the current block uses the multiple transform selection mode, a plurality of transform kernels of the current block are determined, and inverse transform is performed on the transform coefficients of the current block according to the plurality of transform kernels to determine the residual block of the current block.

Note that in the embodiment of the present disclosure, for operation S4401, decoding the bitstream to determine the value of the first syntax identification information of the current block may include: decoding the bitstream according to at least one context model to determine a bin string of the first syntax identification information; and performing inverse binarization processing on the bin string of the first syntax identification information to determine the value of the first syntax identification information. For operation S4402, decoding the bitstream to determine the value of the second syntax identification information of the current block may include: decoding the bitstream according to at least one context model to determine a bin string of the second syntax identification information; and performing inverse binarization processing on the bin string of the second syntax identification information to determine the value of the second syntax identification information. Here, each binary symbol in the bin string uses a context model.

Further, in the embodiment of the present disclosure, the first syntax identification information is represented by lfnst_nspt_idx, and the second syntax identification information is represented by mts_idx. Where lfnst_nspt_idx is used to indicate whether the current block uses a first transform mode (i.e., LFNST/NSPT), and mts_idx is used to indicate whether the current block uses a multiple transform selection mode (i.e., MTS). That is, when the bitstream is decoded, the syntax element lfnst_nspt_idx of the LFNST/NSPT may precede the syntax element mts_idx of the MTS.

It should also be noted that, in the embodiment of the present disclosure, if the first syntax identification information indicates that the current block uses the first transform mode, it is no longer necessary to decode mts_idx, and at this time, the transform kernel of the LFNST/NSPT may be determined, and the transform coefficients of the current block may be inversely transformed according to the transform kernel to determine the residual block of the current block.

That is, in the embodiment of the present disclosure, the decoding order of the inter prediction and the intra prediction LFNST/NSPT and the MTS is different. Specifically, when the bitstream is decoded, the syntax element lfnst_nspt_idx of the LFNST/NSPT precedes the syntax element mts_idx of the MTS. That is, first parse lfnst_nspt_idx. If the value of lfnst_nspt_idx is 0 and the current situation meets the application conditions of MTS, then continue to parse mts_idx. Here, mts_idx indicates which (primary) transform kernel is used for the horizontal/vertical direction of the current block, respectively. Further, similarly in intra prediction, the analysis of lfnst_nspt_idx may precede mts_idx. In other words, whether to parse mts_idx depends on the value of lfnst_nspt_idx.

In an embodiment of the present disclosure, for the inter prediction of the current block, the parsing of mts_idx may precede lfnst_nspt_idx. In other words, whether to parse lfnst_nspt_idx depends on the value of mts_idx. That is, parse mts_idx first. If mts_idx is 0 and the current situation meets the application conditions of LFNST/NSPT, then continue to parse lfnst_nspt_idx.

It should be noted that in the embodiments of the present disclosure, the inter or inter prediction may be understood as referring to a block, a coding unit, or a transform unit of inter coding, and the intra or intra prediction may be understood as referring to a block, a coding unit, or a transform unit of intra coding.

It should also be noted that, in the embodiment of the present disclosure, two pieces of syntax identification information (third syntax identification information and fourth syntax identification information) may be used here instead of lfnst_nspt_idx. The third syntax identification information is denoted by nspt_idx and may be used to indicate whether the current block uses NSPT and which NSPT transform kernel is used correspondingly, and the fourth syntax identification information is denoted by lfnst_idx and may be used to indicate whether the current block uses LFNST and which LFNST transform kernel is used correspondingly.

In some embodiments, the method further includes: decoding the bitstream according to at least one third context model to determine a third bin string of the current block; performing inverse binarization processing on the third bin string to determine a value of third syntax identification information; and when the third syntax identification information indicates that the current block uses a non-separable primary transform mode, determining the transform kernel of the current block, and performing inverse transform on the transform coefficients of the current block according to the transform kernel to determine the residual block of the current block.

In some embodiments, the method further includes: decoding the bitstream according to at least one fourth context model to determine a fourth bin string of the current block; performing inverse binarization processing on the fourth bin string to determine a value of fourth syntax identification information; and when the fourth syntax identification information indicates that the current block uses a low frequency non-separable transform mode, determining the transform kernel of the current block, and performing inverse transform on the transform coefficients of the current block according to the transform kernel to determine the residual block of the current block.

That is, in the embodiment of the present disclosure, the LFNST/NSPT may each use different syntax elements, but the above method is still applicable. Specifically, intra prediction and inter prediction use different decoding methods for LFNST syntax elements and NSPT syntax elements, intra prediction and inter prediction use different context models for LFNST syntax elements and NSPT syntax elements, the number of transform kernels that can be used for intra prediction and inter prediction LFNST and NSPT is different, the transform kernels that can be used for intra prediction and inter prediction LFNST and NSPT are different, and the decoding order of intra prediction and inter prediction LFNST/NSPT and MTS is different.

It should also be noted that, in the embodiment of the present disclosure, the “inverse transform” of the transform coefficients by the decoding end may also be referred to as “transform” in the standard text. “Transform” and “inverse transform” herein correspond to two opposite processes. For example, “transform” converts values in the spatial domain into coefficients in the frequency domain, and then “inverse transform” converts coefficients in the frequency domain into values in the spatial domain. “Inverse” is relative to “forward”, and they are essentially transforms. It should be noted that if the standard only specifies decoding, then the “transform” in the standard text is the part of decoding, specifically referring to the “inverse transform” herein.

It is also understood that in the embodiment of the present disclosure, in addition to applying LFNST and NSPT to blocks of intra prediction/inter prediction, they may also be applied to blocks of Intra Block Copy (IBC), specifically, inter prediction may be replaced with IBC.

In yet another possible implementation, lfnst_nspt_idx may be parsed only when the last non-zero coefficient position of the current block meets certain conditions. Referring to FIG. 45, the method may include operations as follows.

At S4501: a bitstream is decoded to determine quantization coefficients of a current block.

At S4502: inverse quantization is performed on the quantization coefficients of the current block to determine the transform coefficients of the current block.

At S4503: when a last non-zero coefficient position among the transform coefficients of the current block meets a preset condition, the bitstream is decoded to determine the value of the first syntax identification information of the current block.

At S4504: when the first syntax identification information indicates that the current block uses a first transform mode, a transform kernel of the current block is determined, and inverse transform is performed on transform coefficients of the current block according to the transform kernel to determine a residual block of the current block.

Note that in the embodiment of the present disclosure, for operation S4503, decoding the bitstream to determine the value of the first syntax identification information of the current block may include: decoding the bitstream according to at least one context model to determine a bin string of the first syntax identification information; and performing inverse binarization processing on the bin string of the first syntax identification information to determine the value of the first syntax identification information.

It should also be noted that, in the embodiment of the present disclosure, when the first syntax identification information indicates that the current block does not use the first transform mode, the transform kernel of the second transform mode used by the current block is determined, and the transform coefficients of the current block are inversely transformed according to the transform kernel of the second transform mode to determine the residual block of the current block. Exemplarily, the first transform mode may be LFNST/NSPT, and the second transform mode may be MTS, but is not particularly limited.

In the related art, lfnst_nspt_idx is parsed only when certain conditions are met. One of the conditions is that the last non-zero coefficient position is greater than or equal to 1. The scanning of quantization coefficients is performed in a hierarchical diagonal scan mode. A coefficient block can be partitioned into 4×4 sub-blocks. The scanning between these 4×4 subblocks follows a diagonal scan order, and the scanning within each 4×4 subblock also follows a diagonal scan order. The position of the top-left corner (0, 0) of the current block is 0 in the scanning sequence, and the position of the last non-zero coefficient is greater than or equal to 1, which means that the current block has coefficients other than (0, 0). For the DCT2 transform, (0, 0) is the DC coefficient. That is to say, if the coefficients of the current block only have non-zero coefficients at the (0, 0) position or have no non-zero coefficients, then the syntax element lfnst_nspt_idx does not need to be parsed, and the default is 0. Because it is very unlikely that LFNST/NSPT can be used in this case, and this limitation can significantly reduce the unnecessary overhead of lfnst_nspt_idx. Moreover, the related art requires that the last non-zero coefficient position of all colour components need to be greater than or equal to 1. For example, for a block partitioned into a single tree in the YUV format, the last non-zero coefficient position of the three colour components Y, U, and V needs to be greater than or equal to 1.

In this way, for the inter prediction block, the residual is originally less than that of the intra prediction block, and considering that the quality requirement of the chroma component is much lower than that of the luma component, there will be more cases in the inter prediction block in which the luma component has a certain coefficient while the chroma component has no coefficient. Since this condition of LFNST/NSPT is designed for intra prediction, and at present, LFNST/NSPT can also be used for inter prediction, but their coefficients and residual rules are different, this restriction condition can be modified in the embodiment of the present disclosure.

In a possible implementation, the last non-zero coefficient position among the transform coefficients of the current block meets the preset condition may include: when the prediction mode of the current block is an intra prediction mode, a last non-zero coefficient position of all colour components in the transform coefficients of the current block is greater than or equal to a first threshold; or when the prediction mode of the current block is an inter prediction mode, a last non-zero coefficient position of a luma component in the transform coefficients of the current block is greater than or equal to the first threshold.

In another possible implementation, the last non-zero coefficient position among the transform coefficients of the current block meets the preset condition may include: when a partition type of the current block is dual tree partition, a last non-zero coefficient position of all colour components in the transform coefficients of the current block is greater than or equal to a first threshold; or when the partition type of the current block is single tree partition, a last non-zero coefficient position of a luma component in the transform coefficients of the current block is greater than or equal to the first threshold.

In the embodiment of the present disclosure, the first threshold may also be referred to as a minimum threshold. Where the first threshold may be set to 1, or may be a larger value, such as 2, 3, etc., which is not specifically limited here.

It should also be noted that the embodiment of the present disclosure does not limit the case where the last non-zero coefficient position is equal to the first threshold. That is, the last non-zero coefficient position among the transform coefficients of the current block meets the preset condition may further include: when the prediction mode of the current block is an intra prediction mode or dual tree partition, a last non-zero coefficient position of all colour components in the transform coefficients of the current block is greater than a first threshold; or when the prediction mode of the current block is an inter prediction mode or single tree partition, a last non-zero coefficient position of a luma component in the transform coefficients of the current block is greater than the first threshold.

Exemplarily, assuming that the minimum threshold is equal to 1, the correlation technique is still used for intra prediction blocks. That is, lfnst_nspt_idx is parsed only when the last non-zero coefficient position of all colour components is greater than or equal to 1. For an inter prediction block, lfnst_nspt_idx is parsed only when the last non-zero coefficient position of the Y component is greater than or equal to 1, and the U and V components are no longer required. Alternatively, for a dual tree partitioned block, lfnst_nspt_idx is parsed only when the last non-zero coefficient position of all its colour components is greater than or equal to 1. For a single tree partitioned block, lfnst_nspt_idx is parsed only when the last non-zero coefficient position of the Y component is greater than or equal to 1, and the U and V components are no longer required.

It is also understood that in the related art, lfnst_nspt_idx is parsed only when certain conditions are met. One of the conditions is that the position of the last non-zero coefficient cannot be greater than a threshold, which is the maximum possible number of coefficients of LFNST or NSPT minus one, which can be referred to herein as the maximum threshold, and the maximum threshold can be determined according to the size parameter of the current block, that is, the length and width. For example, when the encoding end LFNST performs a secondary transform on a 4×4 block, the input of the LFNST is the 4×4 DCT2 transformed coefficients, and the output is 8 coefficients, that is, the output of the LFNST may only have 8 coefficients at most for a 4×4 block. Then, for the decoder, if the last non-zero coefficient position of a 4×4 block exceeds 7, i.e., (8−1), it is definitely not the output of the LFNST, so that the decoder may know that the current block definitely does not use the LFNST, and there is no need to parse its syntax elements. This limitation can significantly reduce the unnecessary overhead of lfnst_nspt_idx. Furthermore, the related art requires that the last non-zero coefficient position of all colour components cannot be greater than its maximum threshold. For example, for a single tree partitioned block in YUV format, the last non-zero coefficient position of the three colour components Y, U, and V cannot be greater than its maximum threshold.

In this way, considering that this condition of LFNST/NSPT is designed for intra prediction, and at present, LFNST/NSPT can also be used for inter prediction, but their coefficients and residual rules are different, so this restriction condition can be modified.

In yet another possible implementation, the last non-zero coefficient position among the transform coefficients of the current block meets the preset condition may include: when the prediction mode of the current block is an intra prediction mode, a last non-zero coefficient position of all colour components in the transform coefficients of the current block is less than or equal to a second threshold; or when the prediction mode of the current block is an inter prediction mode, a last non-zero coefficient position of a luma component in the transform coefficients of the current block is less than or equal to a second threshold.

In yet another possible implementation, the last non-zero coefficient position among the transform coefficients of the current block meets the preset condition may include: when a partition type of the current block is dual tree partition, a last non-zero coefficient position of all colour components in the transform coefficients of the current block is less than or equal to a second threshold; or when the partition type of the current block is single tree partition, a last non-zero coefficient position of a luma component in the transform coefficients of the current block is less than or equal to a second threshold.

In the embodiment of the present disclosure, the second threshold may also be referred to as a maximum threshold. In a specific embodiment, the second threshold may be determined according to the size parameter of the current block. For example, the second threshold may be determined according to the length and width of the current block. In another specific embodiment, the second threshold may be set to a difference between a maximum value of the number of coefficients in the transform coefficients of the current block and one. For example, if the LFNST for the current block can output at most 8 coefficients, the second threshold may be set to 7.

It should also be noted that the embodiment of the present disclosure does not limit the case where the last non-zero coefficient position is equal to the second threshold. That is, the last non-zero coefficient position among the transform coefficients of the current block meets the preset condition may further include: when the prediction mode of the current block is an intra prediction mode or dual tree partition, a last non-zero coefficient position of all colour components in the transform coefficients of the current block is less than a second threshold; or when the prediction mode of the current block is an inter prediction mode or single tree partition, a last non-zero coefficient position of a luma component in the transform coefficients of the current block is less than the second threshold.

Exemplarily, the correlation technique is still used for intra prediction blocks. That is, lfnst_nspt_idx is parsed only when the last non-zero coefficient position of all colour components is not greater than its maximum threshold. For an inter prediction block, lfnst_nspt_idx is parsed only when the last non-zero coefficient position of the Y component is not larger than its maximum threshold, and the U and V components are no longer required. Alternatively, for a dual tree partitioned block, lfnst_nspt_idx is parsed only when the last non-zero coefficient position of all its components is not greater than the maximum threshold. For a single tree partitioned block, lfnst_nspt_idx is parsed only when the last non-zero coefficient position of the Y component is not greater than its maximum threshold, and the U and V components are no longer required.

That is, in the embodiment of the present disclosure, lfnst_nspt_idx may be parsed only when the last non-zero coefficient position of the Y component is greater than or equal to the minimum threshold, and the U and V components are no longer required. Alternatively, lfnst_nspt_idx may be parsed only when the last non-zero coefficient position of the Y component is not larger than the maximum threshold, and the U and V components may not be required.

Further, in some embodiments, the method further includes: determining a prediction block of the current block; and determining a reconstructed block of the current block according to the prediction block of the current block and the residual block of the current block.

Note that, in the embodiment of the present disclosure, if the prediction mode of the current block is the intra prediction mode, intra prediction is performed on the current block to determine the prediction block of the current block. Then, the prediction block of the current block and the residual block of the current block are added to determine the reconstructed block of the current block. Note that, in the embodiment of the present disclosure, if the prediction mode of the current block is the inter prediction mode, inter prediction is performed on the current block to determine the prediction block of the current block. Then, the prediction block of the current block and the residual block of the current block are added to determine the reconstructed block of the current block.

The embodiment provides a method for decoding, which includes: determining a prediction mode of a current block; determining at least one context model according to the prediction mode of the current block; decoding a bitstream according to the at least one context model to determine a bin string of the current block, where the bin string includes at least one binary symbol; performing inverse binarization processing on the bin string to determine a value of first syntax identification information; and when the first syntax identification information indicates that the current block uses a first transform mode, determining a transform kernel of the current block, and performing inverse transform on transform coefficients of the current block according to the transform kernel to determine a residual block of the current block. In this way, firstly, at least one context model is determined according to the prediction mode of the current block, and then the bin string corresponding to the first syntax identification information is decoded according to the determined at least one context model. In this way, different context models can be selected for the intra prediction mode or the inter prediction mode, so that a decoding method conforming to the distribution law of the bin string of the LFNST/NSPT in the inter prediction mode can be used, thereby not only improving the compression efficiency, but also improving the encoding and decoding performance.

In an embodiment of the present disclosure, see FIG. 46, which shows a schematic flowchart of a method for encoding according to an embodiment of the present disclosure. As shown in FIG. 46, the method may include the following operations.

At S4601: a prediction mode of a current block is determined.

It should be noted that, in the embodiment of the present disclosure, the method is applied to a encoder. Specifically, based on the composition structure of the encoder 100 shown in FIG. 37, the encoding method of the embodiment of the present disclosure can be applied to the intra prediction mode and/or the inter prediction mode, and here, the optimization scheme is mainly proposed for NSPT and LFNST transforms in the inter prediction mode, to improve the compression efficiency.

It should also be noted that, in the embodiment of the present disclosure, the prediction mode of the current block may include an inter prediction mode and/or an intra prediction mode. Where the intra prediction mode mainly predicts the current block according to the reconstructed area around the current block, and the inter prediction mode mainly predicts the current block according to the reference picture of the current block.

At S4602: at least one context model is determined according to the prediction mode of the current block.

Note that, in the embodiment of the present disclosure, it is determined that at least one context model corresponding to the inter prediction mode is different from at least one context model corresponding to the intra prediction mode. That is, the inter prediction mode and the intra prediction mode do not share a context model.

At S4603: a value of first syntax identification information is determined, and binarization processing is performed on the value of the first syntax identification information to determine a bin string of the current block, where the bin string includes at least one binary symbol.

At S4604: at least one binary symbol in the bin string is encoded according to the at least one context model, and obtained encoded bits are signalled in a bitstream.

It should also be noted that in the embodiment of the present disclosure, the number of context models is related to the number of binary symbols. If the bin string of the current block includes n binary symbols, then here, n context models need to be determined according to the prediction mode of the current block. Where each binary symbol is encoded using a context model. Here, n is a positive integer.

It should also be noted that, in the embodiment of the present disclosure, determining the value of the first syntax identification information may include: in a case that the current block does not use a first transform mode, determining that the value of the first syntax identification information is a first value; and/or, in a case that the current block uses the first transform mode, determining that the value of the first syntax identification information is a second value.

It should be noted that, in the embodiment of the present disclosure, the first value is different from the second value, and the first value and the second value may be in a parameter form or a numeric form. Specifically, the first value may be set to 0, and the second value may be set to a non-zero value, such as 1, 2, 3, etc.

It can be understood that in the embodiment of the present disclosure, both NSPT and LFNST are transforms that process textures of various angles, and there may be multiple transform kernels here, and one transform kernel may be specially optimized for a specific angle texture. In addition to angular textures, NSPT and LFNST also include transform kernels that handle gradient textures. In fact, these transform kernels can also be said to be the trained Karhunen-Loeve (KL) Transform (KLT). That is, both NSPT and LFNST can have multiple transform kernels, each of which is designed for a specific texture. Where specific textures include angle textures, gradient textures, etc. In addition, the gradient texture can be further expanded such as horizontal gradient texture, vertical gradient texture, oblique gradient texture, etc. Further, this scheme is not limited to non-separable transforms such as NSPT and LFNST, and can also be applied to separable transforms optimized for specific textures.

It should also be noted that, in the embodiment of the present disclosure, both the NSPT and the LFNST include a plurality of transform kernel sets, and each transform kernel set includes three optional transform kernels. When combined with the option of not applying LFNST/NSPT, this results in a total of four possible options per block for LFNST/NSPT. In the embodiment of the present disclosure, the syntax element lfnst_idx may be used to indicate whether LFNST is used and which LFNST transform kernel is used. lfnst_idx is equal to 0, indicating that the current block does not use LFNST; lfnst_idx is equal to 1, indicating that the current block uses the first transform kernel of LFNST; lfnst_idx is equal to 2, indicating that the current block uses the second transform kernel of LFNST. It should be noted that the transform kernel set may be determined by an intra prediction mode or a texture feature index, and no syntax element indication is required at this time. In addition, for a transform kernel set, only two transform kernels can be selected in some techniques, and three transform kernels can be selected in other techniques. Moreover, NSPT is used for small blocks of a certain size, which can also be three transform kernels. In the embodiment of the present disclosure, lfnst_nspt_idx may be used here to indicate whether LFNST/NSPT is used and which transform kernel of LFNST/NSPT is used. Because in one possible implementation it indicates the transform kernel index of NSPT for smaller blocks and the transform kernel index of LFNST for larger blocks. That is, the value of lfnst_nspt_idx may be 0, 1, 2, 3.

In the embodiment of the present disclosure, the first syntax identification information may be represented by lfnst_nspt_idx, it may continue to use the syntax element lfnst_idx, or may also use two syntax elements of lfnst_idx and nspt_idx, where lfnst_idx indicates whether to use LFNST and which transform kernel of LFNST to use, and nspt_idx indicates whether to use NSPT and which transform kernel of NSPT to use. They are substantially the same here and are not specifically limited herein.

In one possible implementation, the bin string corresponding to the first syntax identification information may use the same binarization mode, but different context models, for the intra prediction mode and the inter prediction mode.

In some embodiments, performing binarization processing on the value of the first syntax identification information to determine the bin string of the current block may include: when the prediction mode of the current block is at least one of the intra prediction mode or the inter prediction mode, performing binarization processing on the value of the first syntax identification information based on a first mode to determine the bin string of the current block.

In some embodiments, encoding at least one binary symbol in the bin string according to the at least one context model may include: when the prediction mode of the current block is an intra prediction mode, encoding at least one binary symbol in the bin string according to at least one first context model; or when the prediction mode of the current block is an inter prediction mode, encoding at least one binary symbol in the bin string according to the at least one second context model.

Note that in embodiments of the present disclosure, the at least one first context model is different from the at least one second context model, i.e., the inter prediction mode and the intra prediction mode do not share the context model.

It should be noted that, in the embodiment of the present disclosure, both the inter prediction mode and the intra prediction mode may perform encoding processing using the first mode. The first mode may be a Fixed-Length (FL) coding mode, which may also be referred to as an FL coding mode, that is, the same number of binary symbols is used to represent different values of the first syntax identification information. Alternatively, the first mode may be a truncated unary code mode, that is, different numbers of binary symbols are used to represent different values of the first syntax identification information. Alternatively, the first mode may even be another mode, such as a unary code mode, a K-order exponential Columbus coding mode, and the like, which is not specifically limited here.

For example, the value of lfnst_nspt_idx may be 0, 1, 2, or 3. If the first mode is the fixed-length coding mode, the binarization table shown in Table 6 can be used. In Table 6, the value of the first syntax identification information uses two binary symbols, and both of these two binary symbols may be encoded using the context model. Where the first (binIdx equals to 0) binary symbol uses a context model and the second (binIdx equals to 1) binary symbol uses a context model. Alternatively, if the first mode is the truncated unary code mode, the binarization table shown in Table 7 can be used. In Table 7, the value of the first syntax identification information may use different bin string lengths. Where the three binary symbols in Table 7 can all be encoded by context models. Where the first (binIdx equals to 0) binary symbol uses a context model, the second (binIdx equals to 1) binary symbol uses a context model, and the third (binIdx equals to 2) binary symbol uses a context model.

In another possible implementation, the bin string corresponding to the first syntax identification information may use different binarization modes and different context models, for the intra prediction mode and the inter prediction mode.

In some embodiments, performing binarization processing on the value of the first syntax identification information to determine the bin string of the current block may include: when the prediction mode of the current block is the intra prediction mode, performing binarization processing on the value of the first syntax identification information based on a first mode to determine a first bin string of the current block; or when the prediction mode of the current block is the inter prediction mode, performing binarization processing on the value of the first syntax identification information based on a second mode to determine a second bin string of the current block.

In some embodiments, encoding at least one binary symbol in the bin string according to the at least one context model may include: when the prediction mode of the current block is an intra prediction mode, encoding at least one binary symbol in the first bin string according to at least one first context model and a first mode; or when the prediction mode of the current block is an inter prediction mode, encoding at least one binary symbol in the second bin string according to the at least one second context model and a second mode.

Note that in embodiments of the present disclosure, the at least one first context model is different from the at least one second context model, i.e., the inter prediction mode and the intra prediction mode do not share the context model. Further, the first mode is different from the second mode, that is, different binarization modes are used in the inter prediction mode and the intra prediction mode.

In a specific embodiment, the first mode is a fixed-length coding mode, and the second method is a truncated unary code mode.

In this way, when the prediction mode of the current block is the intra prediction mode, the first bin string is encoded according to at least one first context model and a fixed-length coding mode. Alternatively, when the prediction mode of the current block is the inter prediction mode, the second bin string is encoded according to at least one second context model and the truncated unary code mode. In this implementation, for different values of the first syntax identification information lfnst_nspt_idx, the length of the first bin string is unchanged, and the length of the second bin string is changed.

Simply put, different encoding methods and different context models can be used for the transform kernel index (i.e., the value of lfnst_nspt_idx) of the intra prediction mode and the inter prediction mode. Specifically, the context model used by lfnst_nspt_idx of the inter prediction mode is different from the context model used by lfnst_nspt_idx of the intra prediction mode, or lfnst_nspt_idx of the inter prediction mode and lfnst_nspt_idx of the intra prediction mode do not share the context model. Where one possible implementation is that lfnst_nspt_idx of the inter prediction mode and lfnst_nspt_idx of the intra prediction mode use the same binarization mode, but different context models. Another possible implementation is that lfnst_nspt_idx of the inter prediction mode and lfnst_nspt_idx of the intra prediction mode use different binarization modes, and different context models.

It should also be noted that in the embodiment of the present disclosure, the LFNST/NSPT may share one syntax element lfnst_nspt_idx, specifically, the transform kernel index of the NSPT is indicated for a smaller block, and the transform kernel index of the LFNST is indicated for a larger block. Alternatively, the LFNST/NSPT may use different syntax elements, for example, the LFNST uses the syntax element lfnst_idx and the NSPT uses the syntax element nspt_idx, but the above method is still applicable for the binarization of lfnst_idx and nspt_idx.

Further, if the current block uses LFNST/NSPT, then in some embodiments, referring to FIG. 47, the method further includes operations as follows.

At S4701: a transform kernel of the current block is determined when the current block uses a first transform mode.

At S4702: a residual block of the current block is determined, and the residual block of the current block is transformed according to the transform kernel to determine transform coefficients of the current block.

At S4703: the transform coefficients of the current block are quantized to determine quantization coefficients of the current block.

At S4704: the quantization coefficients of the current block are encoded, and the obtained encoded bits are signalled in the bitstream.

Note that, in the embodiment of the present disclosure, when the current block uses LFNST/NSPT, first, the transform kernel and the residual block of the current block are determined, then the residual block of the current block is transformed according to the transform kernel to determine the transform coefficients of the current block, and finally the transform coefficients of the current block are encoded, and the obtained encoded bits are signalled in the bitstream.

Note that, in the embodiment of the present disclosure, determining the transform kernel of the current block may include: determining a transform kernel set of the current block; and determining a transform kernel of the current block according to the transform kernel set and the value of the first syntax identification information.

Herein when the current block uses the first transform mode, the value of the first syntax identification information further indicates a number of the transform kernel of the current block in the transform kernel set. In this way, according to the value of the transform kernel set and the first syntax identification information, the transform kernel of the current block can be determined.

Further, in the embodiment of the present disclosure, when intra prediction is performed on the current block, the transform kernel set of the current block may be determined according to the correspondence between the intra prediction mode and the transform kernel set. When inter prediction is performed on the current block, the transform kernel set of the current block may be determined according to the correspondence between the texture feature index (i.e., the virtual intra prediction mode) and the transform kernel set. Where the texture feature index of the current block may be derived using a prediction block or a reference block of the current block or a reconstructed area around the current block.

In some embodiments, determining the transform kernel set of the current block may include: when the prediction mode of the current block is the intra prediction mode, determining that the transform kernel set includes M candidate transform kernels; or when the prediction mode of the current block is the inter prediction mode, determining that the transform kernel set includes N candidate transform kernels. Where M and N are both positive integers, and M is greater than or equal to N.

That is, in the embodiment of the present disclosure, there may be more or less options for LFNST/NSPT, and the number of transform kernels available for LFNST/NSPT of inter prediction may be different from the number of transform kernels available for LFNST/NSPT of intra prediction. Exemplarily, since there are more residual for intra prediction and less residual for inter prediction, one transform kernel set for intra prediction has 3 transform kernels and one transform kernel set for inter prediction has 2 transform kernels. In this case, the value of lfnst_nspt_idx for inter prediction may be 0, 1, 2.

Exemplarily, the aforementioned Table 8 provides another binarization mode of lfnst_nspt_idx for inter prediction. According to Table 8, it can be seen that the binarization mode of lfnst_nspt_idx of inter prediction may use different bin string lengths, which is a truncated unary code mode. The two binary symbols may both be encoded by context models. The first (binIdx equals to 0) binary symbol uses a context model and the second (binIdx equals to 1) binary symbol uses a context model.

Specifically, the context model used by lfnst_nspt_idx of the inter prediction is different from the context model used by lfnst_nspt_idx of the intra prediction, or lfnst_nspt_idx of the inter prediction and lfnst_nspt_idx of the intra prediction do not share the context model. In addition, LFNST/NSPT may each use different syntax elements, and the above method is still applicable.

In some embodiments, the method further includes: when M is greater than N, setting the N candidate transform kernels to be a subset of the M candidate transform kernels; or when M is equal to N, setting the N candidate transform kernels to be at least partially different from the M candidate transform kernels.

Note that, in the embodiment of the present disclosure, the transform kernel available for the inter LFNST/NSPT may be the same as the transform kernel available for the intra LFNST/NSPT. If the number of transform kernels available for inter LFNST/NSPT is less than the number of transform kernels available for intra LFNST/NSPT, then the transform kernels available for inter LFNST/NSPT may be a subset of the transform kernels available for intra LFNST/NSPT. For example, two transform kernels may be used for inter prediction, three transform kernels may be used for intra prediction, and the transform kernels available for inter prediction may be the first two or the last two or the first or third transform kernels available for intra prediction, which are not specifically limited herein.

Note that, in the embodiment of the present disclosure, the transform kernel available for the inter LFNST/NSPT may be different from the transform kernel available for the intra LFNST/NSPT. That is to say, the transform kernel is designed according to the residual characteristics of inter prediction and intra prediction respectively, so as to achieve higher compression efficiency. Exemplarily, three transform kernels may be used for inter prediction and three transform kernels may also be used for intra prediction, but the three transform kernels of inter prediction and the three transform kernels of intra prediction are partially or completely different.

That is, in the embodiment of the present disclosure, the transform kernel used for inter prediction and the transform kernel used for intra prediction may be the same, or may be partially or completely different. In addition, in the embodiment of the present disclosure, the available transform kernel refers to a transform kernel available in one transform kernel set.

In some embodiments, when determining the transform kernel set of the current block, the method may further include: determining at least one texture feature of the current block; and performing transform kernel training according to the at least one texture feature to determine the transform kernel set of the current block.

Note that, in the related art, intra prediction may correspond to one transform kernel set according to the intra prediction mode, and in the embodiment of the present disclosure, inter prediction may derive a virtual intra prediction mode (texture feature index) using a prediction block to correspond to one transform kernel set. Inter prediction may also derive different texture features than intra prediction, and correspondingly train the transform kernel with such texture features.

In some embodiments, the method further includes: determining a value of the second syntax identification information of the current block; and encoding the value of the second syntax identification information, and signalling the obtained encoded bits in the bitstream.

Here, the second syntax identification information may be denoted by mts_idx for indicating whether the current block uses the multiple transform selection mode, and which (primary) transform kernel is used for the horizontal/vertical direction of the current block, respectively.

Further, if the current block does not use the MTS mode, it is determined that the value of the second syntax identification information is a first value. If the current block uses the MTS mode, it is determined that the value of the second syntax identification information is a second value. Where the first value may be set to 0, and the second value may be set to a non-zero value, such as 1, 2, 3, etc. Here, the magnitude of the second value depends on which transform kernel is used correspondingly for the current block.

In some embodiments, the method further includes: when the current block does not use the multiple transform selection mode and the current block meets a use condition of a first transform mode, performing the operation of determining the value of the first syntax identification information.

If the current block does not use LFNST/NSPT, it is determined that the value of the first syntax identification information is the first value. If the current block uses LFNST/NSPT, it is determined that the value of the first syntax identification information is a second value. Where the first value may be set to 0, and the second value may be set to a non-zero value, such as 1, 2, 3, etc. The magnitude of the second value depends on which transform kernel is used correspondingly for the current block.

Note that, in the embodiment of the present disclosure, both the first syntax identification information and the second syntax identification information can be encoded using the context model. In addition, the first syntax identification information is represented by lfnst_nspt_idx, and the second syntax identification information is represented by mts_idx. Where lfnst_nspt_idx is used to indicate whether the current block uses a first transform mode (i.e., LFNST/NSPT), and mts_idx is used to indicate whether the current block uses a multiple transform selection mode (i.e., MTS). That is, when the bitstream is signalled, the syntax element lfnst_nspt_idx of the LFNST/NSPT may follow the syntax element mts_idx of the MTS.

It should also be noted that, in the embodiment of the present disclosure, if the second syntax identification information indicates that the current block uses the multiple transform selection mode, it is no longer necessary to encode lfnst_nspt_idx, and at this time, a plurality of transform kernels of the current block may be determined, and the residual block of the current block may be transformed according to the plurality of transform kernels to determine the transform coefficients of the current block. For example, mts_idx may indicate which (primary) transform kernel is used for the horizontal/vertical direction of the current block, respectively.

In some embodiments, the method further includes: when the current block does not use a first transform mode and the current block meets a use condition of a multiple transform selection mode, performing an operation of determining a value of second syntax identification information of the current block.

Note that, in the embodiment of the present disclosure, both the first syntax identification information and the second syntax identification information can also be encoded using the context model. Where the first syntax identification information is represented by lfnst_nspt_idx, and the second syntax identification information is represented by mts_idx. Where lfnst_nspt_idx is used to indicate whether the current block uses a first transform mode (i.e., LFNST/NSPT), and mts_idx is used to indicate whether the current block uses a multiple transform selection mode (i.e., MTS). That is, when the bitstream is signalled, the syntax element lfnst_nspt_idx of the LFNST/NSPT may precede the syntax element mts_idx of the MTS.

It should also be noted that, in the embodiment of the present disclosure, if the current block uses the first transform mode, it is no longer necessary to encode mts_idx, and at this time, the transform kernel of the LFNST/NSPT can be determined, and the residual block of the current block can be transformed according to the transform kernel to determine the transform coefficients of the current block.

That is, in the embodiment of the present disclosure, the encoding order of the inter prediction and the intra prediction LFNST/NSPT and the MTS is different. Specifically, in the encoding process, the syntax element lfnst_nspt_idx of the LFNST/NSPT precedes the syntax element mts_idx of the MTS. That is, at the decoding end, lfnst_nspt_idx is parsed first. If the value of lfnst_nspt_idx is 0 and the current situation meets the application conditions of MTS, then continue to parse mts_idx. Here, mts_idx indicates which (primary) transform kernel is used for the horizontal/vertical direction of the current block, respectively. Further, similarly in intra prediction, the encoding of lfnst_nspt_idx may precede mts_idx. In other words, whether to encode mts_idx depends on the value of lfnst_nspt_idx.

In an embodiment of the present disclosure, for the inter prediction of the current block, the encoding of mts_idx may precede lfnst_nspt_idx. In other words, whether to encode lfnst_nspt_idx depends on the value of mts_idx. That is, at the decoding end, mts_idx is parsed first. If mts_idx is 0 and the current situation meets the application conditions of LFNST/NSPT, then continue to parse lfnst_nspt_idx.

It should be noted that in the embodiments of the present disclosure, the inter or inter prediction may be understood as referring to a block, a coding unit, or a transform unit of inter coding, and the intra or intra prediction may be understood as referring to a block, a coding unit, or a transform unit of intra coding.

It should also be noted that, in the embodiment of the present disclosure, two pieces of syntax identification information (third syntax identification information and fourth syntax identification information) may be used here instead of lfnst_nspt_idx. The third syntax identification information is denoted by nspt_idx and may be used to indicate whether the current block uses NSPT and which NSPT transform kernel is used correspondingly, and the fourth syntax identification information is denoted by lfnst_idx and may be used to indicate whether the current block uses LFNST and which LFNST transform kernel is used correspondingly.

In some embodiments, the method further includes: determining a value of third syntax identification information of the current block, where the third syntax identification information indicates whether the current block uses a non-separable primary transform mode; and encoding the value of the third syntax identification information, and signalling the obtained encoded bits in the bitstream.

In the embodiment of the present disclosure, if the current block does not use the non-separable primary transform mode, it is determined that the value of the third syntax identification information is the first value. If the current block uses the non-separable primary transform mode, it is determined that the value of the third syntax identification information is the second value.

In the embodiment of the present disclosure, when the current block uses the non-separable primary transform mode, the transform kernel of the current block is determined, and NSPT transform is performed on the residual block of the current block according to the transform kernel to determine the transform coefficients of the current block.

In some embodiments, the method further includes: determining a value of fourth syntax identification information of the current block, where the fourth syntax identification information indicates whether the current block uses a low frequency non-separable transform mode; and encoding the value of the fourth syntax identification information, and signalling the obtained encoded bits in the bitstream.

In the embodiment of the present disclosure, if the current block does not use the low frequency non-separable transform mode, it is determined that the value of the fourth syntax identification information is the first value. If the current block uses the low frequency non-separable transform mode, it is determined that the value of the fourth syntax identification information is the second value.

In the embodiment of the present disclosure, when the current block uses the low frequency non-separable transform mode, the transform kernel of the current block is determined, and LFNST transform is performed on the residual block of the current block according to the transform kernel to determine the transform coefficients of the current block.

It should also be noted that in the embodiment of the present disclosure, the first value may be set to 0, and the second value may be set to a non-zero value, such as 1, 2, 3, etc. Here, the magnitude of the second value depends on which transform kernel is used correspondingly for the current block.

That is, in the embodiment of the present disclosure, the LFNST/NSPT may each use different syntax elements, but the above method is still applicable. Specifically, intra prediction and inter prediction use different encoding methods for LFNST syntax elements and NSPT syntax elements, intra prediction and inter prediction use different context models for LFNST syntax elements and NSPT syntax elements, the number of transform kernels that can be used for intra prediction and inter prediction LFNST and NSPT is different, the transform kernels that can be used for intra prediction and inter prediction LFNST and NSPT are different, and the encoding order of intra prediction and inter pLFNST/NSPT and MTS is different.

It is also understood that in the embodiment of the present disclosure, in addition to applying LFNST and NSPT to blocks of intra prediction/inter prediction, they may also be applied to blocks of Intra Block Copy (IBC), specifically, inter prediction may be replaced with IBC.

In yet another possible implementation, lfnst_nspt_idx may be signalled in the bitstream only when the last non-zero coefficient position of the current block meets certain conditions. In some embodiments, the method further includes: when a last non-zero coefficient position among the transform coefficients of the current block meets a preset condition, performing the operations of determining the value of the first syntax identification information, and performing binarization processing on the value of the first syntax identification information to determine the bin string of the current block.

In the related art, lfnst_nspt_idx is encoded only when certain conditions are met. One of the conditions is that the last non-zero coefficient position is greater than or equal to 1. The scanning of quantization coefficients is performed in a hierarchical diagonal scan mode. A coefficient block can be partitioned into 4×4 sub-blocks. The scanning between these 4×4 subblocks follows a diagonal scan order, and the scanning within each 4×4 subblock also follows a diagonal scan order. The position of the top-left corner (0, 0) of the current block is 0 in the scanning sequence, and the position of the last non-zero coefficient is greater than or equal to 1, which means that the current block has coefficients other than (0, 0). For the DCT2 transform, (0, 0) is the DC coefficient. That is to say, if the coefficients of the current block only have non-zero coefficients at the (0, 0) position or have no non-zero coefficients, then the syntax element lfnst_nspt_idx does not need to be encoded, and the default is 0. Because it is very unlikely that LFNST/NSPT can be used in this case, and this limitation can significantly reduce the unnecessary overhead of lfnst_nspt_idx. Moreover, the related art requires that the last non-zero coefficient position of all colour components need to be greater than or equal to 1. For example, for a block partitioned into a single tree in the YUV format, the last non-zero coefficient position of the three colour components Y, U, and V needs to be greater than or equal to 1.

In this way, for the inter prediction block, the residual is originally less than that of the intra prediction block, and considering that the quality requirement of the chroma component is much lower than that of the luma component, there will be more cases in the inter prediction block in which the luma component has a certain coefficient while the chroma component has no coefficient. Since this condition of LFNST/NSPT is designed for intra prediction, and at present, LFNST/NSPT can also be used for inter prediction, but their coefficients and residual rules are different, this restriction condition can be modified in the embodiment of the present disclosure.

In a possible implementation, the last non-zero coefficient position among the transform coefficients of the current block meets the preset condition may include: when the prediction mode of the current block is an intra prediction mode, a last non-zero coefficient position of all colour components in the transform coefficients of the current block is greater than or equal to a first threshold; or when the prediction mode of the current block is an inter prediction mode, a last non-zero coefficient position of a luma component in the transform coefficients of the current block is greater than or equal to the first threshold.

In another possible implementation, the last non-zero coefficient position among the transform coefficients of the current block meets the preset condition may include: when a partition type of the current block is dual tree partition, a last non-zero coefficient position of all colour components in the transform coefficients of the current block is greater than or equal to a first threshold; or when the partition type of the current block is single tree partition, a last non-zero coefficient position of a luma component in the transform coefficients of the current block is greater than or equal to the first threshold.

In the embodiment of the present disclosure, the first threshold may also be referred to as a minimum threshold. Where the first threshold may be set to 1, or may be a larger value, such as 2, 3, etc., which is not specifically limited here.

It should also be noted that the embodiment of the present disclosure does not limit the case where the last non-zero coefficient position is equal to the first threshold. That is, the last non-zero coefficient position among the transform coefficients of the current block meets the preset condition may further include: when the prediction mode of the current block is an intra prediction mode or dual tree partition, a last non-zero coefficient position of all colour components in the transform coefficients of the current block is greater than a first threshold; or when the prediction mode of the current block is an inter prediction mode or single tree partition, a last non-zero coefficient position of a luma component in the transform coefficients of the current block is greater than the first threshold.

Exemplarily, assuming that the minimum threshold is equal to 1, the correlation technique is still used for intra prediction blocks. That is, lfnst_nspt_idx is encoded only when the last non-zero coefficient position of all colour components is greater than or equal to 1. For an inter prediction block, lfnst_nspt_idx is encoded only when the last non-zero coefficient position of the Y component is greater than or equal to 1, and the U and V components are no longer required. Alternatively, for a dual tree partitioned block, lfnst_nspt_idx is encoded only when the last non-zero coefficient position of all its colour components is greater than or equal to 1. For a single tree partitioned block, lfnst_nspt_idx is encoded only when the last non-zero coefficient position of the Y component is greater than or equal to 1, and the U and V components are no longer required.

It is also understood that in the related art, lfnst_nspt_idx is encoded only when certain conditions are met. One of the conditions is that the position of the last non-zero coefficient cannot be greater than a threshold, which is the maximum possible number of coefficients of LFNST or NSPT minus one, which can be referred to herein as the maximum threshold, and the maximum threshold can be determined according to the size parameter of the current block, that is, the length and width. For example, when the encoding end LFNST performs a secondary transform on a 4×4 block, the input of the LFNST is the 4×4 DCT2 transformed coefficients, and the output is 8 coefficients, that is, the output of the LFNST may only have 8 coefficients at most for a 4×4 block. Then, for the decoder, if the last non-zero coefficient position of a 4×4 block exceeds 7, i.e., (8−1), it is definitely not the output of the LFNST, so that the decoder may know that the current block definitely does not use the LFNST, and there is no need to encode its syntax elements. This limitation can significantly reduce the unnecessary overhead of lfnst_nspt_idx. Furthermore, the related art requires that the last non-zero coefficient position of all colour components cannot be greater than its maximum threshold. For example, for a single tree partitioned block in YUV format, the last non-zero coefficient position of the three colour components Y, U, and V cannot be greater than its maximum threshold.

In this way, considering that this condition of LFNST/NSPT is designed for intra prediction, and at present, LFNST/NSPT can also be used for inter prediction, but their coefficients and residual rules are different, so this restriction condition can be modified.

In yet another possible implementation, the last non-zero coefficient position among the transform coefficients of the current block meets the preset condition may include: when the prediction mode of the current block is an intra prediction mode, a last non-zero coefficient position of all colour components in the transform coefficients of the current block is less than or equal to a second threshold; or when the prediction mode of the current block is an inter prediction mode, a last non-zero coefficient position of a luma component in the transform coefficients of the current block is less than or equal to a second threshold.

In yet another possible implementation, the last non-zero coefficient position among the transform coefficients of the current block meets the preset condition may include: when a partition type of the current block is dual tree partition, a last non-zero coefficient position of all colour components in the transform coefficients of the current block is less than or equal to a second threshold; or when the partition type of the current block is single tree partition, a last non-zero coefficient position of a luma component in the transform coefficients of the current block is less than or equal to a second threshold.

In the embodiment of the present disclosure, the second threshold may also be referred to as a maximum threshold. In a specific embodiment, the second threshold may be determined according to the size parameter of the current block. For example, the second threshold may be determined according to the length and width of the current block. In another specific embodiment, the second threshold may be set to a difference between a maximum value of the number of coefficients in the transform coefficients of the current block and one. For example, if the LFNST for the current block can output at most 8 coefficients, the second threshold may be set to 7.

It should also be noted that the embodiment of the present disclosure does not limit the case where the last non-zero coefficient position is equal to the second threshold. That is, the last non-zero coefficient position among the transform coefficients of the current block meets the preset condition may further include: when the prediction mode of the current block is an intra prediction mode or dual tree partition, a last non-zero coefficient position of all colour components in the transform coefficients of the current block is less than a second threshold; or when the prediction mode of the current block is an inter prediction mode or single tree partition, a last non-zero coefficient position of a luma component in the transform coefficients of the current block is less than the second threshold.

Exemplarily, the correlation technique is still used for intra prediction blocks. That is, lfnst_nspt_idx is encoded only when the last non-zero coefficient position of all colour components is not greater than its maximum threshold. For an inter prediction block, lfnst_nspt_idx is encoded only when the last non-zero coefficient position of the Y component is not larger than its maximum threshold, and the U and V components are no longer required. Alternatively, for a dual tree partitioned block, lfnst_nspt_idx is encoded only when the last non-zero coefficient position of all its components is not greater than the maximum threshold. For a single tree partitioned block, lfnst_nspt_idx is encoded only when the last non-zero coefficient position of the Y component is not greater than its maximum threshold, and the U and V components are no longer required.

That is, in the embodiment of the present disclosure, lfnst_nspt_idx may be encoded only when the last non-zero coefficient position of the Y component is greater than or equal to the minimum threshold, and the U and V components are no longer required. Alternatively, lfnst_nspt_idx may be encoded only when the last non-zero coefficient position of the Y component is not larger than the maximum threshold, and the U and V components may not be required.

Further, in some embodiments, the method further includes: determining a prediction block of the current block; and determining the residual block of the current block according to an original block of the current block and the prediction block of the current block.

Note that, in the embodiment of the present disclosure, if the prediction mode of the current block is the intra prediction mode, intra prediction is performed on the current block to determine the prediction block of the current block. Then, the original block of the current block and the prediction block of the current block are subtracted to determine the residual block of the current block. Note that, in the embodiment of the present disclosure, if the prediction mode of the current block is the inter prediction mode, inter prediction is performed on the current block to determine the prediction block of the current block. Then, the original block of the current block and the prediction block of the current block are subtracted to determine the residual block of the current block.

In a possible implementation, transforming the residual block of the current block according to the transform kernel to determine the transform coefficients of the current block may include: performing non-separable primary transform on the residual block of the current block according to the transform kernel to determine the transform coefficients of the current block.

In a possible implementation, transforming the residual block of the current block according to the transform kernel to determine the transform coefficients of the current block may include: performing discrete cosine transform on the residual block of the current block to determine a transform block of the current block; and performing low frequency non-separable transform on the transform block of the current block according to the transform kernel to determine the transform coefficients of the current block.

That is, in the embodiment of the present disclosure, if lfnst_nspt_idx indicates that the current block uses the first transform mode, when transforming the residual block of the current block according to the transform kernel, it may include: if the size parameter of the current block meets the first condition, performing non-separable primary transform on the residual block of the current block according to the transform kernel to determine the transform coefficients of the current block. If the size parameter of the current block meets the second condition, performing discrete cosine transform on the residual block of the current block to determine a transform block of the current block; and performing low frequency non-separable transform on the transform block of the current block according to the transform kernel to determine the transform coefficients of the current block.

Here, the size parameter of the current block meets the first condition, which may include that the size parameter of the current block is small, for example, the size parameter of the current block is less than a certain threshold. That is, for a block with a smaller size, the transform kernel of NSPT is used here, that is, NSPT transform is performed on the residual block of the current block according to the transform kernel to determine the transform coefficients of the current block. The size parameter of the current block meets the second condition, which may include that the size parameter of the current block is large, for example, the size parameter of the current block is greater than a certain threshold. That is, for a larger-sized block, the transform kernel of LFNST is used here, that is, primary transform of DCT2 is performed on the residual block of the current block first, and then LFNST transform is performed on the transform block of the current block according to the transform kernel to determine the transform coefficients of the current block.

It should also be noted that in the embodiment of the present disclosure, the “transform” of the residual block at the encoding end may also be referred to as “forward transform”, and specifically refers to the transform from the spatial domain to the frequency domain to remove the correlation of the residual. It should be noted that if the standard only specifies decoding, then the “transform” in the standard text is the part of decoding, specifically referring to the “inverse transform” herein.

In another embodiment of the present disclosure, the embodiment of the present disclosure provides a bitstream, which is generated by bit encoding according to to-be-encoded information, where the to-be-encoded information includes at least one of: quantization coefficients of a current block, a value of first syntax identification information, a value of second syntax identification information, a value of third syntax identification information, or a value of fourth syntax identification information.

In an embodiment of the present disclosure, the first syntax identification information indicates whether the current block uses a first transform mode, the second syntax identification information indicates whether the current block uses a multiple transform selection mode, the third syntax identification information indicates whether the current block uses a non-separable primary transform mode, and the fourth syntax identification information indicates whether the current block uses a low frequency non-separable transform mode.

The embodiment provides a method for encoding, which includes: determining a prediction mode of a current block; determining at least one context model according to the prediction mode of the current block; decoding a bitstream according to the at least one context model to determine a bin string of the current block, where the bin string includes at least one binary symbol; performing inverse binarization processing on the bin string to determine a value of first syntax identification information; and when the first syntax identification information indicates that the current block uses a first transform mode, determining a transform kernel of the current block, and performing inverse transform on transform coefficients of the current block according to the transform kernel to determine a residual block of the current block. In this way, firstly, at least one context model is determined according to the prediction mode of the current block, and then the bin string corresponding to the first syntax identification information is encoded according to the determined at least one context model. In this way, different context models can be selected for the intra prediction mode or the inter prediction mode, so that an encoding method conforming to the distribution law of the bin string of the LFNST/NSPT in the inter prediction mode can be used, thereby not only improving the compression efficiency and the encoding efficiency, but also improving the encoding performance.

In another embodiment of the present disclosure, based on the encoding and decoding method described in the foregoing embodiments, considering that in the related art, each transform kernel set of LFNST/NSPT includes three optional transform kernels. When combined with the option of not applying LFNST/NSPT, this results in a total of four possible options per block for LFNST/NSPT. In the embodiment of the present disclosure, the syntax element lfnst_idx may be used to indicate whether LFNST transform kernel is used and which LFNST transform kernel is used. Lfnst_idx equals to 0 indicates that the current block does not use LFNST, lfnst_idx equals to 1 indicates that the current block uses the first transform kernel of LFNST, and lfnst_idx equals to 2 indicates that the current block uses the second transform kernel of LFNST. It should be noted that the transform kernel set is determined by the intra prediction mode and does not need to be indicated by a syntax element. Exemplarily, only two transform kernels can be selected in some techniques, and three transform kernels can be used in other techniques. Moreover, NSPT is used for small blocks of a certain size, which is also three transform kernels. Lfnst_nspt_idx may be used here to indicate whether LFNST/NSPT transform kernel is used and which transform kernel of LFNST/NSPT is used. Because in one implementation it indicates the transform kernel index of NSPT for smaller blocks and the index of LFNST for larger blocks. That is, the value of lfnst_nspt_idx may be 0, 1, 2, 3. Of course, it is also possible to continue to use the syntax element lfnst_idx, or use two syntax elements lfnst_idx and nspt_idx, which are substantially the same, and are not specifically limited here.

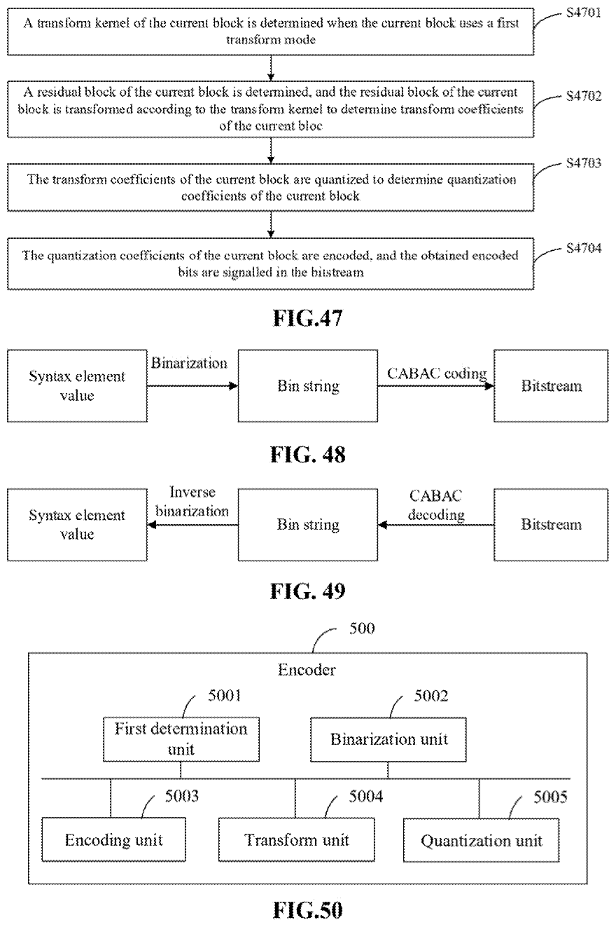

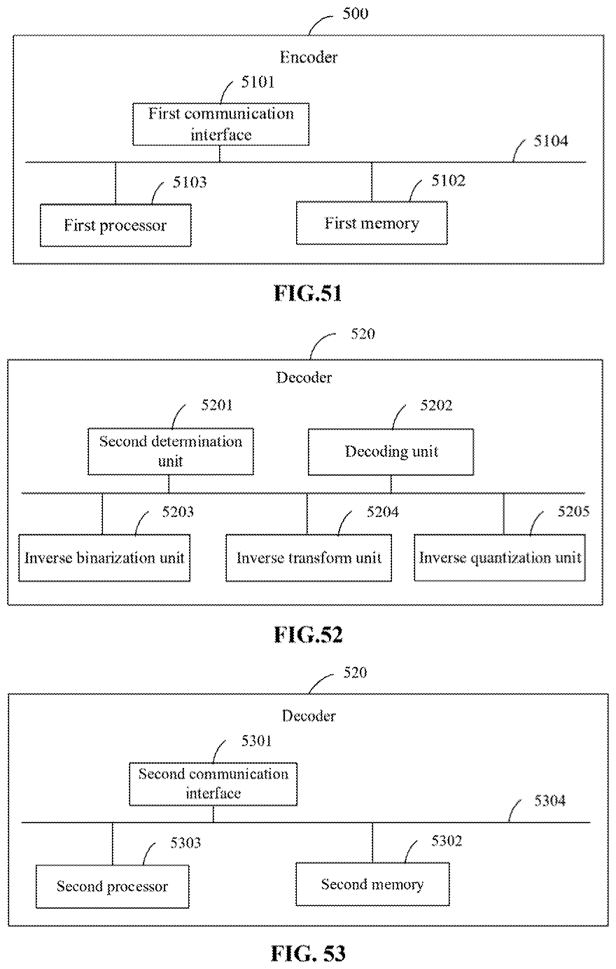

FIG. 48 shows a schematic block diagram of signalling a syntax element value in a bitstream, and FIG. 49 shows a schematic block diagram of decoding a syntax element value from a bitstream. During encoding, the syntax element value is binarized into a bin string, and the bin string is then encoded into a bit stream through CABAC. During decoding, when the decoder wants to parse a certain syntax element, it reads the bitstream, decodes a bin string through CABAC, and then obtains the syntax element value by performing inverse binarization on the bin string. During context-based adaptive binary arithmetic coding (CABAC), if a binary symbol uses a context model, the probability corresponding to the context model is used for encoding; otherwise, equal probability is used for encoding, and the same is true for decoding. It should be noted that the syntax element value here is the value of the syntax identification information in the foregoing embodiments.

In the related art, since the original encoding method of lfnst_nspt_idx is optimized for intra prediction, it can be directly referred to herein as a binarization mode of intra lfnst_nspt_idx, as specifically shown in Table 6. It can be seen that the binarization mode of lfnst_nspt_idx of the intra prediction mode uses two binary symbols, and both two binary symbols are decoded by context models. The first (binIdx equals to 0) binary symbol uses a context model and the second (binIdx equals to 1) binary symbol uses a context model.

The binarization mode and context model configuration set in this way are related to its statistical laws. FIG. 40 is a statistical result of the value of intra lfnst_nspt_idx in the test sequence MarketPlace at all intra QP 32. According to FIG. 40, it can be seen that under this condition, for the value of lfnst_nspt_idx, the possibilities of the four options are almost the same, and the possibilities of 1 and 2 are even more than 0. It should be noted that this is only an example, and the statistical results corresponding to different test sequences and different QPs are different.

Further, using the same binarization mode, FIG. 41 is a statistical result of an inter lfnst_nspt_idx in the test sequence BasketballDrive at random access QP 32. According to this, it can be seen that under this condition, there is a certain gap between the possibilities of the four options for the value of lfnst_nspt_idx. 0 is significantly higher than 1, 2, 3, and 1 is higher than 2, 3. It should be noted that this is only an example, and the statistical results corresponding to different test sequences and different QPs are different.

Based on theoretical analysis and statistical data of the probability distribution of the inter lfnst_nspt_idx, the embodiment of the present disclosure proposes a binarization mode of the inter lfnst_nspt_idx, as specifically shown in Table 7. From this, it can be seen that the binarization mode of inter lfnst_nspt_idx uses different bin string lengths, which is a truncated unary code. The three binary symbols may all be encoded by context models. Where the first (binIdx equals to 0) binary symbol uses a context model, the second (binIdx equals to 1) binary symbol uses a context model, and the third (binIdx equals to 2) binary symbol uses a context model.

That is, the context model used by inter lfnst_nspt_idx is different from the context model used by intra lfnst_nspt_idx, or inter lfnst_nspt_idx and intra lfnst_nspt_idx do not share the context model. One possible implementation is that inter lfnst_nspt_idx and intra lfnst_nspt_idx use the same binarization mode, but different context models. Another possible implementation is that inter lfnst_nspt_idx and intra lfnst_nspt_idx use different binarization modes and different context models.

It should also be noted that LFNST/NSPT may each use different syntax elements, and the principle of the above method remains unchanged.

In the embodiment of the present disclosure, there may be more or less options for LFNST/NSPT, and the number of transform kernels available for inter LFNST/NSPT may be different from the number of transform kernels available for intra LFNST/NSPT. Exemplarily, since there are more intra residual and less inter residual, one intra transform kernel set has 3 transform kernels and one inter transform kernel set has 2 transform kernels. Then, the encoding method of inter lfnst_nspt_idx is as shown in Table 8. From this, it can be seen that the binarization mode of inter lfnst_nspt_idx uses different bin string lengths, which is a truncated unary code. The two binary symbols may both be encoded by context models. The first (binIdx equals to 0) binary symbol uses a context model and the second (binIdx equals to 1) binary symbol uses a context model.

Here, the context model used by inter lfnst_nspt_idx is different from the context model used by intra lfnst_nspt_idx, or inter lfnst_nspt_idx and intra lfnst_nspt_idx do not share the context model. In addition, LFNST/NSPT may each use different syntax elements, and the principle of the above method remains unchanged.

Further, the transform kernel available for inter LFNST/NSPT may be the same as the transform kernel available for intra LFNST/NSPT, and if the number of transform kernels available for inter LFNST/NSPT is less than the number of transform kernels available for intra LFNST/NSPT, then the transform kernels available for inter LFNST/NSPT may be a subset of the transform kernels available for intra LFNST/NSPT. For example, inter prediction may use 2 transform kernels, while intra prediction may use 3 transform kernels. The transform kernels available for inter prediction may be the first two, the last two, or the first and third kernels among those available for intra prediction.

Further, the transform kernel available for the inter LFNST/NSPT may be different from the transform kernel available for the intra LFNST/NSPT, that is, the transform kernel is designed for inter and intra residual characteristics respectively, so that higher compression efficiency can be achieved. Three transform kernels may be used for inter prediction and three transform kernels may also be used for intra prediction, but the three transform kernels of inter prediction and the three transform kernels of intra prediction are partially or completely different.

Optionally, the available transform kernel refers to a transform kernel available in one transform kernel set. In the related art, intra prediction may correspond to one transform kernel set according to the intra prediction mode, and in this scheme, inter prediction may derive a virtual intra prediction mode (texture feature index) using a prediction block to correspond to one transform kernel set. Inter prediction may also derive different texture features than intra prediction, and correspondingly train the transform kernel with such texture features.

For example, at present, LFNST and NSPT train a relatively single texture feature, such as a texture in a specific direction, as shown in FIG. 42 A and FIG. 42B. It should be noted that this is only a schematic diagram, but for inter prediction, residuals appear more on the edges of objects. For example, if inter prediction often produces residuals with two directional textures, as shown in FIG. 42C, then such a transform kernel of LFNST/NSPT can also be trained. When analyzing the texture features of the current block (such as the process of deriving the virtual intra prediction mode described above), if it is found that the prediction block or the surrounding reconstructed area of the current block has textures in two directions, then the transform kernel with such texture features can be matched.

In the embodiment of the present disclosure, when the bitstream is parsed, the syntax element lfnst_nspt_idx of the LFNST precedes the syntax element mts_idx of the MTS. That is, first parse lfnst_nspt_idx. If lfnst_nspt_idx is 0 and the current situation meets the application conditions of MTS, then mts_idx is parsed. Here, mts_idx indicates which (primary) transform kernel is used for the horizontal/vertical direction of the current block, respectively. Similarly, in the case of intra encoding, lfnst_nspt_idx may be parsed before mts_idx, and whether mts_idx is parsed depends on the value of lfnst_nspt_idx.

In the embodiment of the present disclosure, at the time of inter encoding, the parsing of mts_idx precedes lfnst_nspt_idx, and whether lfnst_nspt_idx is parsed depends on the value of mts_idx. That is, parse mts_idx first. If mts_idx is 0 and the current situation meets the application conditions of LFNST/NSPT, then parse lfnst_nspt_idx.

It should be noted that in the embodiments of the present disclosure, “inter” may be understood as referring to a block, a coding unit, or a transform unit of inter coding, while “intra” may be understood as referring to a block, a coding unit, or a transform unit of intra coding.

It should also be noted that the present technical solution can also be applied to the IBC mode, and the above-described “inter” can be changed to IBC.

In the embodiment of the present disclosure, lfnst_nspt_idx is parsed only when certain conditions are met. One of the conditions is that the last non-zero coefficient position is greater than or equal to 1. The scanning of quantization coefficients is performed in a hierarchical diagonal scan mode. A coefficient block can be partitioned into 4×4 sub-blocks. The scanning between these 4×4 subblocks follows a diagonal scan order, and the scanning within each 4×4 subblock also follows a diagonal scan order. The position of the top-left corner (0, 0) of the current block is 0 in the scanning sequence, and the position of the last non-zero coefficient is greater than or equal to 1, which means that the current block has coefficients other than (0, 0). For the DCT2 transform, (0, 0) is the DC coefficient. That is to say, if the coefficients of the current block only have non-zero coefficients at the (0, 0) position or have no non-zero coefficients, then the syntax element lfnst_nspt_idx does not need to be parsed, and the default is 0. Because it is very unlikely that LFNST/NSPT can be used in this case, and this limitation can significantly reduce the unnecessary overhead of lfnst_nspt_idx. Moreover, the related art requires that the last non-zero coefficient position of all components is greater than or equal to 1. For example, for a single tree partitioned block in the YUV format, the last non-zero coefficient position of the three components Y, U, and V must be greater than or equal to 1.

In this way, for the inter coding block, the residual is originally less than that of the intra coding block, and considering that the quality requirement of chroma is much lower than that of luma, there will be more cases in the inter coding block in which luma has a certain coefficient while chroma has no coefficient. Since this condition of LFNST/NSPT is designed for intra coding, and at present, LFNST/NSPT can also be used for inter coding, but their coefficients and residual rules are different, so this restriction condition can be modified.

One possible implementation is to still use related techniques for intra coding blocks. That is, lfnst_nspt_idx is parsed only when the last non-zero coefficient position of all components is greater than or equal to 1. For inter coding blocks, lfnst_nspt_idx is parsed only when the last non-zero coefficient position of the Y component is greater than or equal to 1. The UV component is no longer required.

Another possible implementation is: for a dual tree partitioned block, lfnst_nspt_idx is parsed only when the last non-zero coefficient position of all its components is greater than or equal to 1. For a single tree partitioned block, lfnst_nspt_idx is parsed only when the last non-zero coefficient position of the Y component is greater than or equal to 1. The UV component is no longer required.

Further, in the related art, the judgment condition is set that the last non-zero coefficient position is greater than or equal to 1, that is, the minimum possible threshold is 1, which is referred to as the minimum threshold herein, and the minimum threshold may be set to a larger value, such as 2, 3, etc. Lfnst_nspt_idx is parsed only when the last non-zero coefficient position is greater than or equal to 2.

In the related art, lfnst_nspt_idx is parsed only when certain conditions are met. One of the conditions is that the position of the last non-zero coefficient cannot be greater than a threshold, which is the maximum possible number of coefficients of LFNST or NSPT minus one, which is referred to herein as the maximum threshold, and the maximum threshold can be determined according to the size of the block, that is, the length and width. For example, when the encoding end LFNST performs a secondary transform on a 4×4 block, the input of the LFNST is the 4×4 DCT2 transformed coefficients, and the output is 8 coefficients, that is, the output of the LFNST may only have 8 coefficients at most for a 4×4 block. Then, for the decoder, if the last non-zero coefficient position of a 4×4 block exceeds 7, i.e., (8−1), it is definitely not the output of the LFNST, so that the decoder may know that the current block definitely does not use the LFNST, and there is no need to parse its syntax elements. This limitation can significantly reduce the unnecessary overhead of lfnst_nspt_idx.

Furthermore, the related art requires that the last non-zero coefficient position of all components cannot be greater than its maximum threshold. For example, for a single tree partitioned block in YUV format, the last non-zero coefficient position of the three components Y, U, and V cannot be greater than its maximum threshold. Since this condition of LFNST/NSPT is designed for intra coding, and at present, LFNST/NSPT can also be used for inter coding, but their coefficients and residual rules are different, so this restriction condition can be modified.

One possible implementation is to still use related techniques for intra coding blocks. That is, lfnst_nspt_idx is parsed only when the last non-zero coefficient position of all components is not greater than its maximum threshold. For inter coding blocks, lfnst_nspt_idx is parsed only when the last non-zero coefficient position of the Y component is not greater than its maximum threshold. The UV component is no longer required.

Another possible implementation is: for a dual tree partitioned block, lfnst_nspt_idx is parsed only when the last non-zero coefficient position of all its components is not greater than its maximum threshold. For a single tree partitioned block, lfnst_nspt_idx is parsed only when the last non-zero coefficient position of the Y component is not greater than its maximum threshold. The UV component is no longer required.

In the embodiment of the present disclosure, the specific implementation of the foregoing embodiment is described in detail through the above embodiment, and it can be seen that according to the technical solution of the foregoing embodiment, on the one hand, different encoding methods are used for the LFNST/NSPT kernel index in intra and inter; different context models are used for the LFNST/NSPT index in intra and inter; the number of transform kernels available for LFNST/NSPT differs between intra and inter; the transform kernels available for LFNST/NSPT differ between intra and inter; the encoding order of LFNST/NSPT and MTS differs between inter and intra. On the other hand, depending on different conditions, lfnst_nspt_idx is parsed only when the last non-zero coefficient position of the Y component is greater than or equal to 1, and the UV component is no longer required; and depending on different conditions, lfnst_nspt_idx is parsed only when the last non-zero coefficient position of the Y component is not greater than the maximum threshold, and the UV component is no longer required. Thus, by applying the encoding method for the inter LFNST/NSPT kernel index that aligns with its statistical distribution, compression efficiency is improved, thereby enhancing overall encoding and decoding performance.

In still another embodiment of the present disclosure, based on the same inventive concept as the foregoing embodiments, see FIG. 50, which shows a schematic structural diagram of an encoder according to an embodiment of the present disclosure. As shown in FIG. 50, the encoder 500 may include a first determination unit 5001, a binarization unit 5002, and an encoding unit 5003.

The first determination unit 5001 is configured to determine a prediction mode of a current block, and determine at least one context model according to the prediction mode of the current block.

The binarization unit 5002 is configured to determine a value of first syntax identification information, and perform binarization processing on the value of the first syntax identification information to determine a bin string of the current block, where the bin string includes at least one binary symbol.

The encoding unit 5003 is configured to encode at least one binary symbol in the bin string according to the at least one context model, and signalling obtained encoded bits in a bitstream.

In some embodiments, the prediction mode of the current block includes: an inter prediction mode and/or an intra prediction mode. Accordingly, the first determination unit 5001 is further configured to determine that at least one context model corresponding to the inter prediction mode is different from at least one context model corresponding to the intra prediction mode.

In some embodiments, the binarization unit 5002 is further configured to: when the prediction mode of the current block is at least one of the intra prediction mode or the inter prediction mode, perform binarization processing on the value of the first syntax identification information based on a first mode to determine the bin string of the current block.

In some embodiments, the binarization unit 5002 is further configured to: when the prediction mode of the current block is the intra prediction mode, perform binarization processing on the value of the first syntax identification information based on a first mode to determine a first bin string of the current block; or when the prediction mode of the current block is the inter prediction mode, perform binarization processing on the value of the first syntax identification information based on a second mode to determine a second bin string of the current block. Here, the first mode is different from the second mode.

In some embodiments, the first mode is a fixed-length coding mode, and the second method is a truncated unary code mode.

In some embodiments, the first determination unit 5001 is further configured to: in a case that the current block does not use a first transform mode, determine that the value of the first syntax identification information is a first value; in a case that the current block uses the first transform mode, determine that the value of the first syntax identification information is a second value.

In some embodiments, referring to FIG. 50, the encoder 500 may further include a transform unit 5004.

The first determination unit 5001 is further configured to determine a transform kernel of the current block when the current block uses a first transform mode.

The transform unit 5004 is configured to determine a residual block of the current block, and transform the residual block of the current block according to the transform kernel to determine transform coefficients of the current block.

The encoding unit 5003 is further configured to encode the transform coefficients of the current block, and signal the obtained encoded bits in the bitstream.

In some embodiments, the first determination unit 5001 is further configured to: determine a transform kernel set of the current block; determine a transform kernel of the current block according to the transform kernel set and the value of the first syntax identification information, where when the current block uses the first transform mode, the value of the first syntax identification information further indicates a number of the transform kernel of the current block in the transform kernel set.

In some embodiments, the first determination unit 5001 is further configured to: when the prediction mode of the current block is the intra prediction mode, determine that the transform kernel set includes M candidate transform kernels; or when the prediction mode of the current block is the inter prediction mode, determine that the transform kernel set includes N candidate transform kernels. Where M and N are both positive integers, and M is greater than or equal to N.

In some embodiments, the first determination unit 5001 is further configured to: when M is greater than N, set the N candidate transform kernels to be a subset of the M candidate transform kernels; or when M is equal to N, set the N candidate transform kernels to be at least partially different from the M candidate transform kernels.

In some embodiments, the first determination unit 5001 is further configured to: determine at least one texture feature of the current block; and perform transform kernel training according to the at least one texture feature to determine the transform kernel set of the current block.

In some embodiments, the first determination unit 5001 is further configured to determine a value of the second syntax identification information of the current block. Where the second syntax identification information indicates whether the current block uses the multiple transform selection mode. The encoding unit 5003 is further configured to encode the value of the second syntax identification information, and signalling the obtained encoded bits in the bitstream.

In some embodiments, the first determination unit 5001 is further configured to: when the current block does not use the multiple transform selection mode and the current block meets a use condition of a first transform mode, perform the operation of determining the value of the first syntax identification information.

In some embodiments, the first determination unit 5001 is further configured to: when the current block does not use a first transform mode and the current block meets a use condition of a multiple transform selection mode, perform an operation of determining a value of second syntax identification information of the current block.

In some embodiments, the first determination unit 5001 is further configured to determine a value of the third syntax identification information of the current block. Where the third syntax identification information indicates whether the current block uses the non-separable primary transform mode. The encoding unit 5003 is further configured to encode the value of the third syntax identification information, and signalling the obtained encoded bits in the bitstream.

In some embodiments, the first determination unit 5001 is further configured to determine a value of the fourth syntax identification information of the current block. Where the fourth syntax identification information indicates whether the current block uses the low frequency non-separable transform mode. The encoding unit 5003 is further configured to encode the value of the fourth syntax identification information, and signalling the obtained encoded bits in the bitstream.

In some embodiments, referring to FIG. 50, the encoder 500 may further include a quantization unit 5005, which is configured to quantize the transform coefficients of the current block to determine the quantization coefficients of the current block. The encoding unit 5003 is further configured to encode the quantization coefficients of the current block, and signal the obtained encoded bits in the bitstream.

In some embodiments, the binarization unit 5002 is further configured to: when a last non-zero coefficient position among the transform coefficients of the current block meets a preset condition, perform the operations of determining the value of the first syntax identification information, and perform binarization processing on the value of the first syntax identification information to determine the bin string of the current block.

In some embodiments, the first determination unit 5001 is further configured to: when the prediction mode of the current block is an intra prediction mode, a last non-zero coefficient position of all colour components in the transform coefficients of the current block is greater than or equal to a first threshold; or when the prediction mode of the current block is an inter prediction mode, a last non-zero coefficient position of a luma component in the transform coefficients of the current block is greater than or equal to the first threshold.

In some embodiments, the first determination unit 5001 is further configured to: when a partition type of the current block is dual tree partition, a last non-zero coefficient position of all colour components in the transform coefficients of the current block is greater than or equal to a first threshold; or when the partition type of the current block is single tree partition, a last non-zero coefficient position of a luma component in the transform coefficients of the current block is greater than or equal to the first threshold.

In some embodiments, the first determination unit 5001 is further configured to: when the prediction mode of the current block is an intra prediction mode, a last non-zero coefficient position of all colour components in the transform coefficients of the current block is less than or equal to a second threshold; or when the prediction mode of the current block is an inter prediction mode, a last non-zero coefficient position of a luma component in the transform coefficients of the current block is less than or equal to the second threshold.

In some embodiments, the first determination unit 5001 is further configured to: when a partition type of the current block is dual tree partition, a last non-zero coefficient position of all colour components in the transform coefficients of the current block is less than or equal to a second threshold; or when the partition type of the current block is single tree partition, a last non-zero coefficient position of a luma component in the transform coefficients of the current block is less than or equal to the second threshold.

In some embodiments, the first determination unit 5001 is further configured to determine the second threshold according to the size parameter of the current block.

In some embodiments, the first determination unit 5001 is further configured to set the second threshold to a difference between a maximum value of the number of coefficients in the transform coefficients of the current block and one.

In some embodiments, the first determination unit 5001 is further configured to: determine a prediction block of the current block; and determine the residual block of the current block according to an original block of the current block and the prediction block of the current block.

In some embodiments, the transform unit 5004 is further configured to perform non-separable primary transform on the residual block of the current block according to the transform kernel to determine the transform coefficients of the current block.

In some embodiments, the transform unit 5004 is further configured to: perform discrete cosine transform on the residual block of the current block to determine a transform block of the current block; and perform low frequency non-separable transform on the transform block of the current block according to the transform kernel to determine the transform coefficients of the current block.

It may be understood that in the embodiment of the disclosure, the “unit” may be a part of a circuit, a part of a processor, a part of a program or software, etc. Of course, the “unit” may be a module, or may be non-modular. Furthermore, various components in the embodiment may be integrated into a processing unit, or each unit may physically exist separately, or two or more units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the technical solution of the embodiment substantially, or parts making contributions to the related art, or all or part of the technical solution may be embodied in a form of software product, and the computer software product is stored in a storage medium, and includes several instructions configured to enable a computer device (which may be a personal computer, a server, a network device, etc.) or a processor to perform all or part of operations of the method described in the embodiment. The foregoing storage medium includes various media capable of storing program codes, such as a U disk, a mobile hard disk, a Read Only Memory (ROM), a Random Access Memory (RAM), a magnetic disk, or an optical disk, etc.

Therefore, an embodiment of the disclosure provides a computer-readable storage medium, the computer-readable storage medium is applied to the encoder 500. The computer-readable storage medium has stored thereon a computer program, and when the computer program is executed by a first processor, the method described in any one of the foregoing embodiments is implemented.

Based on compositions of the encoder 500 and the computer-readable storage medium, with reference to FIG. 51, a schematic diagram of specific hardware structures of the encoder 500 provided in an embodiment of the disclosure is shown. As shown in FIG. 51, the encoder 500 may include a first communication interface 5101, a first memory 5102 and a first processor 5103, various components are coupled together through a first bus system 5104. It may be understood that the first bus system 5104 is configured to achieve connection and communication between these components. The first bus system 5104 includes a power bus, a control bus and a status signal bus, besides a data bus. However, for the sake of clear explanations, various buses are marked as the first bus system 5104 in FIG. 51.

The first communication interface 5101 is configured to receive and send signals in a process of receiving/sending information from/to other external network elements.

The first memory 5102 is configured to store a computer program executable on the first processor 5103.

The first processor 5103 is configured to: when it executes the computer program, perform operations of:
determining a prediction mode of a current block; determining at least one context model according to the prediction mode of the current block; determining a value of first syntax identification information, and performing binarization processing on the value of the first syntax identification information to determine a bin string of the current block, where the bin string includes at least one binary symbol; and encoding at least one binary symbol in the bin string according to the at least one context model, and signalling obtained encoded bits in a bitstream.

It may be understood that the first memory 5102 in the embodiment of the disclosure may be a volatile memory or a non-volatile memory, or may include both volatile and non-volatile memories. The non-volatile memory may be a ROM, a Programmable ROM (PROM), an Erasable PROM (EPROM), an electrically EPROM (EEPROM), or a flash memory. The volatile memory may be a RAM, which is used as an external cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The first memory 5102 of the system and method described in the disclosure is intended to include, but is not limited to these memories and any other suitable types of memories.

The first processor 5103 may be an integrated circuit chip with a signal processing capability. During implementation, each operation of the above method may be completed by an integrated logical circuit in a form of hardware in the first processor 5103 or instructions in a form of software. The above first processor 5103 may be a general purpose processor, a Digital Signal Processor (DSP), an Application Specific Integrated Circuit (ASIC), a Field Programmable Gate Array (FPGA) or other programmable logical devices, a discrete gate or transistor logical device, a discrete hardware component, etc. Various methods, operations and logic block diagrams disclosed in the embodiments of the disclosure may be implemented or performed. The general purpose processor may be a microprocessor, or the processor may be any conventional processor, etc. Operations in the methods disclosed in combination with the embodiments of the disclosure may be directly embodied as being performed and completed by a hardware decoding processor, or performed and completed by a combination of hardware in the decoding processor and a software module. The software module may be located in a mature storage medium in this field such as a RAM, a flash memory, a ROM, a PROM or an EEPROM, a register, etc. The storage medium is located in the first memory 5102, and the first processor 5103 reads information in the first memory 5102, and completes the operations in the above methods in combination with the hardware thereof.

It may be understood that these embodiments described in the disclosure may be implemented by hardware, software, firmware, middleware, microcode or a combination thereof. As to implementation by hardware, the processing unit may be implemented in one or more ASICs, DSPs, DSP Devices (DSPDs), Programmable Logic Devices (PLDs), FPGAs, general purpose processors, controllers, microcontrollers, microprocessors, other electronic units configured to perform functions described in the disclosure, or combinations thereof. As to implementation by software, technologies described in the disclosure may be implemented by modules (such as processes, functions, etc.) performing the functions described in the disclosure. Software codes may be stored in a memory and executed by a processor. The memory may be implemented in or out of the processor.

Optionally, as another embodiment, the first processor 5103 is further configured to perform the method described in any one of the foregoing embodiments when it executes the computer program.

The present embodiment provides an encoder, which first determines at least one context model according to the prediction mode of the current block, and then encodes the bin string corresponding to the first syntax identification information according to the determined at least one context model. That is, different context models can be selected for the intra prediction mode or the inter prediction mode, so that the encoding method conforming to the distribution characteristics of the bin string of LFNST/NSPT in the inter prediction mode can be used, thereby not only improving the compression efficiency, but also improving the encoding and decoding performance.

Based on the same inventive concept as the foregoing embodiments, see FIG. 52, which shows a schematic structural diagram of a decoder according to an embodiment of the present disclosure. As shown in FIG. 52, the decoder 520 may include a second determination unit 5201, a decoding unit 5202, an inverse binarization unit 5203, and an inverse transform unit 5204.

The second determination unit 5201 is configured to determine a prediction mode of a current block, and determine at least one context model according to the prediction mode of the current block.

The decoding unit 5202 is configured to decode a bitstream according to the at least one context model to determine a bin string of the current block, where the bin string includes at least one binary symbol.

The inverse binarization unit 5203 is configured to perform inverse binarization processing on the bin string to determine a value of first syntax identification information.

The inverse transform unit 5204 is configured to, when the first syntax identification information indicates that the current block uses a first transform mode, determine a transform kernel of the current block, and perform inverse transform on transform coefficients of the current block according to the transform kernel to determine a residual block of the current block.

In some embodiments, the prediction mode of the current block includes: an inter prediction mode and/or an intra prediction mode. Accordingly, the second determination unit 5201 is further configured to determine that at least one context model corresponding to the inter prediction mode is different from at least one context model corresponding to the intra prediction mode.

In some embodiments, the inverse binarization unit 5203 is further configured to: when the prediction mode of the current block is at least one of the intra prediction mode or the inter prediction mode, perform the inverse binarization processing on the bin string based on a first mode to determine the value of the first syntax identification information.

In some embodiments, the inverse binarization unit 5203 is further configured to: when the prediction mode of the current block is the intra prediction mode, perform the inverse binarization processing on the bin string based on a first mode to determine the value of the first syntax identification information; or when the prediction mode of the current block is the inter prediction mode, perform the inverse binarization processing on the bin string based on a second mode to determine the value of the first syntax identification information. Here, the first mode is different from the second mode.

In some embodiments, the second determination unit 5201 is further configured to: when the prediction mode of the current block is an intra prediction mode, decode the bitstream according to at least one first context model and a fixed-length decoding mode to determine a first bin string of the current block; or, when the prediction mode of the current block is an inter prediction mode, decode the bitstream according to at least one second context model and a truncated unary code mode to determine a second bin string of the current block. Where the at least one first context model is different from the at least one second context model.

In some embodiments, the second determination unit 5201 is further configured to: determine a transform kernel set of the current block; determine a transform kernel of the current block according to the transform kernel set and the value of the first syntax identification information, where when the current block uses the first transform mode, the value of the first syntax identification information further indicates a number of the transform kernel of the current block in the transform kernel set.

In some embodiments, the second determination unit 5201 is further configured to: when the prediction mode of the current block is the intra prediction mode, determine that the transform kernel set includes M candidate transform kernels; or when the prediction mode of the current block is the inter prediction mode, determine that the transform kernel set includes N candidate transform kernels. Where M and N are both positive integers, and M is greater than or equal to N.

In some embodiments, the second determination unit 5201 is further configured to: when M is greater than N, set the N candidate transform kernels to be a subset of the M candidate transform kernels; or when M is equal to N, set the N candidate transform kernels to be at least partially different from the M candidate transform kernels.

In some embodiments, the second determination unit 5201 is further configured to: determine at least one texture feature of the current block; and perform transform kernel training according to the at least one texture feature to determine the transform kernel set of the current block.

In some embodiments, the decoding unit 5202 is further configured to decode the bitstream to determine a value of the second syntax identification information of the current block. The inverse binarization unit 5203 is further configured to: when the second syntax identification information indicates that the current block does not use a multiple transform selection mode and the current block meets a use condition of the first transform mode, perform the operations of: decoding the bitstream according to the at least one context model to determine the bin string of the current block, and performing inverse binarization processing on the bin string to determine the value of the first syntax identification information.

In some embodiments, the decoding unit 5202 is further configured to: when the first syntax identification information indicates that the current block does not use the first transform mode and the current block meets a use condition of a multiple transform selection mode, decode the bitstream to determine a value of a second syntax identification information of the current block. The inverse transform unit 5204 is further configured to: when the second syntax identification information indicates that the current block uses the multiple transform selection mode, determine a plurality of transform kernels of the current block, and perform inverse transform on the transform coefficients of the current block according to the plurality of transform kernels to determine the residual block of the current block.

In some embodiments, the second determination unit 5201 is further configured to decode the bitstream according to at least one third context model to determine a third bin string of the current block. The inverse binarization unit 5203 is further configured to perform inverse binarization processing on the third bin string to determine a value of third syntax identification information.

The inverse transform unit 5204 is further configured to: when the third syntax identification information indicates that the current block uses a non-separable primary transform mode, determine the transform kernel of the current block, and perform inverse transform on the transform coefficients of the current block according to the transform kernel to determine the residual block of the current block.

In some embodiments, the second determination unit 5201 is further configured to decode the bitstream according to at least one fourth context model to determine a fourth bin string of the current block. The inverse binarization unit 5203 is further configured to perform inverse binarization processing on the fourth bin string to determine a value of fourth syntax identification information.

The inverse transform unit 5204 is further configured to: when the fourth syntax identification information indicates that the current block uses a low frequency non-separable transform mode, determine the transform kernel of the current block, and perform inverse transform on the transform coefficients of the current block according to the transform kernel to determine the residual block of the current block.

In some embodiments, referring to FIG. 52, the decoder 500 further includes an inverse quantization unit 5005.

The decoding unit 5202 is further configured to decode the bitstream to determine quantization coefficients of the current block.

The inverse quantization unit 5005 is further configured to perform inverse quantization on the quantization coefficients of the current block to determine the transform coefficients of the current block.

In some embodiments, the inverse binarization unit 5203 is further configured to: when a last non-zero coefficient position among the transform coefficients of the current block meets a preset condition, perform the operations of: decoding the bitstream according to the at least one context model to determine the bin string of the current block, and performing inverse binarization processing on the bin string to determine the value of the first syntax identification information.

In some embodiments, the second determination unit 5201 is further configured to: when the prediction mode of the current block is an intra prediction mode, a last non-zero coefficient position of all colour components in the transform coefficients of the current block is greater than or equal to a first threshold; or when the prediction mode of the current block is an inter prediction mode, a last non-zero coefficient position of a luma component in the transform coefficients of the current block is greater than or equal to the first threshold.

In some embodiments, the second determination unit 5201 is further configured to: when a partition type of the current block is dual tree partition, a last non-zero coefficient position of colour components in the transform coefficients of the current block is greater than or equal to a first threshold; or when the partition type of the current block is single tree partition, a last non-zero coefficient position of a luma component in the transform coefficients of the current block is greater than or equal to the first threshold.

In some embodiments, the second determination unit 5201 is further configured to: when the prediction mode of the current block is an intra prediction mode, a last non-zero coefficient position of all colour components in the transform coefficients of the current block is less than or equal to a second threshold; or when the prediction mode of the current block is an inter prediction mode, a last non-zero coefficient position of a luma component in the transform coefficients of the current block is less than or equal to the second threshold.

In some embodiments, the second determination unit 5201 is further configured to: when a partition type of the current block is dual tree partition, a last non-zero coefficient position of all colour components in the transform coefficients of the current block is less than or equal to a second threshold; or when the partition type of the current block is single tree partition, a last non-zero coefficient position of a luma component in the transform coefficients of the current block is less than or equal to the second threshold.

In some embodiments, the second determination unit 5201 is further configured to determine the second threshold according to the size parameter of the current block.

In some embodiments, the second determination unit 5201 is further configured to set the second threshold to a difference between a maximum value of the number of coefficients in the transform coefficients of the current block and one.

In some embodiments, the second determination unit 5201 is further configured to: determine a prediction block of the current block; and determine a reconstructed block of the current block according to the prediction block of the current block and the residual block of the current block.

It may be understood that in the embodiment, the “unit” may be a part of a circuit, a part of a processor, a part of a program or software, etc. Of course, the “unit” may be a module, or may be non-modular. Furthermore, various components in the embodiment may be integrated into a processing unit, or each unit may physically exist separately, or two or more units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium.

Based on such understanding, the embodiment provides a computer-readable storage medium, the computer-readable storage medium is applied to the decoder 520. The computer-readable storage medium has stored thereon a computer program, and when the computer program is executed by a second processor, the method described in any one of the foregoing embodiments is implemented.

Based on compositions of the encoder 520 and the computer-readable storage medium, with reference to FIG. 53, a schematic diagram of specific hardware structures of the encoder 520 provided in an embodiment of the disclosure is shown. As shown in FIG. 53, the decoder 520 may include a second communication interface 5301, a second memory 5302 and a second processor 5303, various components are coupled together through a second bus system 5304. It may be understood that the second bus system 5304 is configured to achieve connection and communication between these components. The second bus system 5304 includes a power bus, a control bus and a status signal bus, besides a data bus. However, for the sake of clear explanations, various buses are marked as the second bus system 5304 in FIG. 53.

The second communication interface 5301 is configured to receive and send signals in a process of receiving/sending information from/to other external network elements.

The second memory 5302 is configured to store a computer program executable on the second processor 5303.

The second processor 5303 is configured to: when it executes the computer program, perform operations of:
determining a prediction mode of a current block; determining at least one context model according to the prediction mode of the current block; decoding a bitstream according to the at least one context model to determine a bin string of the current block, where the bin string includes at least one binary symbol; performing inverse binarization processing on the bin string to determine a value of first syntax identification information; and when the first syntax identification information indicates that the current block uses a first transform mode, determining a transform kernel of the current block, and performing inverse transform on transform coefficients of the current block according to the transform kernel to determine a residual block of the current block.

Optionally, as another embodiment, the second processor 5303 is further configured to perform the method described in any one of the foregoing embodiments when it executes the computer program.

It may be understood that hardware functions of the second memory 5302 are similar to those of the first memory 5102, and hardware functions of the second processor 5303 are similar to those of the first processor 5103, which will not be described in detail here.

The present embodiment provides a decoder, which first determines at least one context model according to the prediction mode of the current block, and then decodes the bin string corresponding to the first syntax identification information according to the determined at least one context model. That is, different context models can be selected for the intra prediction mode or the inter prediction mode, so that the decoding method conforming to the distribution characteristics of the bin string of LFNST/NSPT in the inter prediction mode can be used, thereby not only improving the compression efficiency, but also improving the encoding and decoding performance.

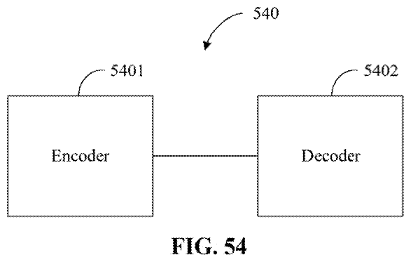

In yet another embodiment of the disclosure, with reference to FIG. 54, a schematic diagram of compositional structures of an encoding and decoding system provided in an embodiment of the disclosure is shown. As shown in FIG. 54, the encoding and decoding system 540 may include an encoder 5401 and a decoder 5402.

In the embodiment of the disclosure, the encoder 5401 may be the encoder described in any one of the foregoing embodiments, and the decoder 5402 may be the decoder described in any one of the foregoing embodiments.

Embodiments of the present disclosure provide a method for encoding, a method for decoding, a bitstream, an encoder, a decoder, and a storage medium, which can improve compression efficiency.

Technical solutions of the present disclosure may be implemented as follows.

According to a first aspect, an embodiment of the present disclosure provides a method for decoding, which is applied to a decoder, and includes the following operations.

A prediction mode of a current block is determined.

At least one context model is determined according to the prediction mode of the current block.

A bitstream is decoded according to the at least one context model to determine a bin string of the current block, where the bin string includes at least one binary symbol.

Inverse binarization processing is performed on the bin string to determine a value of first syntax identification information.

When the first syntax identification information indicates that the current block uses a first transform mode, a transform kernel of the current block is determined, and inverse transform is performed on transform coefficients of the current block according to the transform kernel to determine a residual block of the current block.

According to a second aspect, an embodiment of the present disclosure provides a method for encoding, which is applied to an encoder, and includes the following operations.

A prediction mode of a current block is determined.

At least one context model is determined according to the prediction mode of the current block.

A value of first syntax identification information is determined, and binarization processing is performed on the value of the first syntax identification information to determine a bin string of the current block, where the bin string includes at least one binary symbol.

At least one binary symbol in the bin string is encoded according to the at least one context model, and obtained encoded bits are signalled in a bitstream.

According to a third aspect, an embodiment of the present disclosure provides a bitstream, which is generated by bit encoding according to to-be-encoded information, where the to-be-encoded information includes at least one of: quantization coefficients of a current block, a value of first syntax identification information, a value of second syntax identification information, a value of third syntax identification information, or a value of fourth syntax identification information.

The first syntax identification information indicates whether the current block uses a first transform mode, the second syntax identification information indicates whether the current block uses a multiple transform selection mode, the third syntax identification information indicates whether the current block uses a non-separable primary transform mode, and the fourth syntax identification information indicates whether the current block uses a low frequency non-separable transform mode.

According to a fourth aspect, an embodiment of the present disclosure provides an encoder, which includes a first determination unit, a binarization unit, and an encoding unit.

The first determination unit is configured to determine a prediction mode of a current block, and determine at least one context model according to the prediction mode of the current block.

The binarization unit is configured to determine a value of first syntax identification information, and perform binarization processing on the value of the first syntax identification information to determine a bin string of the current block, where the bin string includes at least one binary symbol.

The encoding unit is configured to encode at least one binary symbol in the bin string according to the at least one context model, and signalling obtained encoded bits in a bitstream.

According to a fifth aspect, an embodiment of the present disclosure provides an encoder, which includes a first memory and a first processor.

The first memory is configured to store a computer program executable on the first processor.

The first processor is configured to perform the method as described in the second aspect when it executes the computer program.

According to a sixth aspect, an embodiment of the present disclosure provides a decoder, which includes a second determination unit, a decoding unit, an inverse binarization unit, and an inverse transform unit.

The second determination unit is configured to determine a prediction mode of a current block, and determine at least one context model according to the prediction mode of the current block.

The decoding unit is configured to decode a bitstream according to the at least one context model to determine a bin string of the current block, where the bin string includes at least one binary symbol.

The inverse binarization unit is configured to perform inverse binarization processing on the bin string to determine a value of first syntax identification information.

The inverse transform unit is configured to, when the first syntax identification information indicates that the current block uses a first transform mode, determine a transform kernel of the current block, and perform inverse transform on transform coefficients of the current block according to the transform kernel to determine a residual block of the current block.

According to a fifth aspect, an embodiment of the present disclosure provides an decoder, which includes a second memory and a second processor.

The second memory is configured to store a computer program executable on second first processor.

The second processor is configured to perform the method as described in the first aspect when it executes the computer program.

According to an eighth aspect, an embodiment of the present disclosure provides a computer-readable storage medium storing a computer program that, when executed by at least one processor, implements the method according to the first aspect or the method according to the second aspect.

The embodiments of the present disclosure provide a method for encoding, a method for decoding, a bitstream, an encoder, a decoder, and a storage medium. At the encoding end, a prediction mode of a current block is determined; at least one context model is determined according to the prediction mode of the current block; a value of first syntax identification information is determined, and binarization processing is performed on the value of the first syntax identification information to determine a bin string of the current block, where the bin string includes at least one binary symbol; and at least one binary symbol in the bin string is encoded according to the at least one context model, and obtained encoded bits are signalled in a bitstream. At the decoding end, a prediction mode of a current block is determined; at least one context model is determined according to the prediction mode of the current block; a bitstream is decoded according to the at least one context model to determine a bin string of the current block, where the bin string includes at least one binary symbol; inverse binarization processing is performed on the bin string to determine a value of first syntax identification information; and when the first syntax identification information indicates that the current block uses a first transform mode, a transform kernel of the current block is determined, and inverse transform is performed on transform coefficients of the current block according to the transform kernel to determine a residual block of the current block. In this way, both the encoder side and the decoder side first determine at least one context model according to the prediction mode of the current block, and then encode/decode the bin string corresponding to the first syntax identification information according to the determined at least one context model. That is, different context models can be selected for the intra prediction mode or the inter prediction mode, so that the encoding and decoding method conforming to the distribution characteristics of the bin string of LFNST/NSPT in the inter prediction mode can be used, thereby not only improving the compression efficiency, but also improving the encoding and decoding performance.

It should be noted that in the disclosure, terms “include”, “include” or any other variants thereof are intended to encompass a non-exclusive inclusion, such that a process, method, article or apparatus including a series of elements includes not only those elements, but also other elements which are not explicitly listed, or elements inherent to such process, method, article or apparatus.

Without further limitation, an element defined by a statement “including a . . . ” does not preclude presence of additional identical elements in a process, method, article or apparatus including the element.

The above serial numbers of the embodiments of the disclosure are only for the purpose of descriptions, and do not represent advantages and disadvantages of the embodiments.

The methods disclosed in several method embodiments provided in the disclosure may be arbitrarily combined without conflict, to obtain new method embodiments.

The features disclosed in several product embodiments provided in the disclosure may be arbitrarily combined without conflict, to obtain new product embodiments.

The features disclosed in several method or device embodiments provided in the disclosure may be arbitrarily combined without conflict, to obtain new method or device embodiments.

The above descriptions are only specific implementations of the disclosure, however, the scope of protection of the disclosure is not limited thereto. Variation or replacement easily conceived by any technician familiar with this technical field within the technical scope disclosed in the disclosure, should fall within the scope of protection of the disclosure. Therefore, the scope of protection of the disclosure should be subject to the scope of protection of the claims.

### INDUSTRIAL APPLICABILITY

In the embodiment of the present disclosure, at the encoding end, a prediction mode of a current block is determined; at least one context model is determined according to the prediction mode of the current block; a value of first syntax identification information is determined, and binarization processing is performed on the value of the first syntax identification information to determine a bin string of the current block, where the bin string includes at least one binary symbol; and at least one binary symbol in the bin string is encoded according to the at least one context model, and obtained encoded bits are signalled in a bitstream. At the decoding end, a prediction mode of a current block is determined; at least one context model is determined according to the prediction mode of the current block; a bitstream is decoded according to the at least one context model to determine a bin string of the current block, where the bin string includes at least one binary symbol; inverse binarization processing is performed on the bin string to determine a value of first syntax identification information; and when the first syntax identification information indicates that the current block uses a first transform mode, a transform kernel of the current block is determined, and inverse transform is performed on transform coefficients of the current block according to the transform kernel to determine a residual block of the current block. In this way, both the encoder side and the decoder side first determine at least one context model according to the prediction mode of the current block, and then encode/decode the bin string corresponding to the first syntax identification information according to the determined at least one context model. That is, different context models can be selected for the intra prediction mode or the inter prediction mode, so that the encoding and decoding method conforming to the distribution characteristics of the bin string of LFNST/NSPT in the inter prediction mode can be used, thereby not only improving the compression efficiency, but also improving the encoding and decoding performance.

1. A method for decoding, applied to a decoder, the method comprising:
determining a prediction mode of a current block;
determining at least one context model according to the prediction mode of the current block;
decoding a bitstream according to the at least one context model to determine a bin string of the current block, wherein the bin string comprises at least one binary symbol;
performing inverse binarization processing on the bin string to determine a value of first syntax identification information; and
when the first syntax identification information indicates that the current block uses a first transform mode, determining a transform kernel of the current block, and performing inverse transform on transform coefficients of the current block according to the transform kernel to determine a residual block of the current block.

2. The method of claim 1, wherein the prediction mode of the current block comprises at least one of an inter prediction mode or an intra prediction mode, and the method further comprises:
determining that at least one context model corresponding to the inter prediction mode is different from at least one context model corresponding to the intra prediction mode.

3. The method of claim 2, wherein performing the inverse binarization processing on the bin string to determine the value of the first syntax identification information comprises:
when the prediction mode of the current block is at least one of the intra prediction mode or the inter prediction mode, performing the inverse binarization processing on the bin string based on a first mode to determine the value of the first syntax identification information.

4. The method of claim 2, wherein performing the inverse binarization processing on the bin string to determine the value of the first syntax identification information comprises:
when the prediction mode of the current block is the intra prediction mode, performing the inverse binarization processing on the bin string based on a first mode to determine the value of the first syntax identification information; or
when the prediction mode of the current block is the inter prediction mode, performing the inverse binarization processing on the bin string based on a second mode to determine the value of the first syntax identification information,
wherein the first mode is different from the second mode.

5. The method of claim 1, wherein decoding the bitstream according to the at least one context model to determine the bin string of the current block comprises:
when the prediction mode of the current block is an intra prediction mode, decoding the bitstream according to at least one first context model and a fixed-length decoding mode to determine a first bin string of the current block; or
when the prediction mode of the current block is an inter prediction mode, decoding the bitstream according to at least one second context model and a truncated unary code mode to determine a second bin string of the current block,
wherein the at least one first context model is different from the at least one second context model.

6. The method of claim 1, wherein determining the transform kernel of the current block comprises:
determining a transform kernel set of the current block; and
determining a transform kernel of the current block according to the transform kernel set and the value of the first syntax identification information, wherein when the current block uses the first transform mode, the value of the first syntax identification information further indicates a number of the transform kernel of the current block in the transform kernel set.

7. The method of claim 6, wherein determining the transform kernel set of the current block comprises:
when the prediction mode of the current block is the intra prediction mode, determining that the transform kernel set comprises M candidate transform kernels; or
when the prediction mode of the current block is the inter prediction mode, determining that the transform kernel set comprises N candidate transform kernels, wherein M and N are both positive integers, and M is greater than or equal to N.

8. The method of claim 7, further comprising:
when M is greater than N, setting the N candidate transform kernels to be a subset of the M candidate transform kernels;
or
when M is equal to N, setting the N candidate transform kernels to be at least partially different from the M candidate transform kernels.

9. The method of claim 1, further comprising:
when the first syntax identification information indicates that the current block does not use the first transform mode and the current block meets a use condition of a multiple transform selection mode, decoding the bitstream to determine a value of a second syntax identification information of the current block; and
when the second syntax identification information indicates that the current block uses the multiple transform selection mode, determining the transform kernel of the current block from a plurality of transform kernels, and performing inverse transform on the transform coefficients of the current block according to the transform kernel of the current block to determine the residual block of the current block.

10. The method of claim 1, further comprising:
decoding the bitstream to determine quantization coefficients of the current block; and
performing inverse quantization on the quantization coefficients of the current block to determine the transform coefficients of the current block.

11. The method of claim 10, wherein the method further comprises:
when a last non-zero coefficient position among the transform coefficients of the current block meets a preset condition, performing the operations of: decoding the bitstream according to the at least one context model to determine the bin string of the current block, and performing inverse binarization processing on the bin string to determine the value of the first syntax identification information.

12. The method of claim 11, wherein the last non-zero coefficient position among the transform coefficients of the current block meets the preset condition comprises:
when the prediction mode of the current block is an intra prediction mode, a last non-zero coefficient position of all colour components in the transform coefficients of the current block is greater than or equal to a first threshold; or
when the prediction mode of the current block is an inter prediction mode, a last non-zero coefficient position of a luma component in the transform coefficients of the current block is greater than or equal to the first threshold.

13. The method of claim 11, wherein the last non-zero coefficient position among the transform coefficients of the current block meets the preset condition comprises:
when the prediction mode of the current block is an intra prediction mode, a last non-zero coefficient position of all colour components in the transform coefficients of the current block is less than or equal to a second threshold; or
when the prediction mode of the current block is an inter prediction mode, a last non-zero coefficient position of a luma component in the transform coefficients of the current block is less than or equal to the second threshold.

14. The method of claim 13, further comprising:
determining the second threshold according to a size parameter of the current block.

15. The method of claim 13, further comprising:
setting the second threshold to be a difference between a maximum number of coefficients in the transform coefficients of the current block and one.

16. A method for encoding, applied to an encoder, the method comprising:
determining a prediction mode of a current block;
determining at least one context model according to the prediction mode of the current block;
determining a value of first syntax identification information, and performing binarization processing on the value of the first syntax identification information to determine a bin string of the current block, wherein the bin string comprises at least one binary symbol; and
encoding at least one binary symbol in the bin string according to the at least one context model, and signalling obtained encoded bits in a bitstream.

17. The method of claim 16, wherein the prediction mode of the current block comprises at least one of an inter prediction mode or an intra prediction mode, and the method further comprises:
determining that at least one context model corresponding to the inter prediction mode is different from at least one context model corresponding to the intra prediction mode.

18. The method of claim 17, wherein performing binarization processing on the value of the first syntax identification information to determine the bin string of the current block comprises:
when the prediction mode of the current block is the intra prediction mode, performing binarization processing on the value of the first syntax identification information based on a first mode to determine a first bin string of the current block; or
when the prediction mode of the current block is the inter prediction mode, performing binarization processing on the value of the first syntax identification information based on a second mode to determine a second bin string of the current block,
wherein the first mode is different from the second mode.

19. The method of claim 18, wherein the first mode is a fixed-length coding mode, and the second mode is a truncated unary code mode.

20. A non-transitory computer-readable storage medium, having a computer program and a bitstream stored thereon, wherein the computer program, when executed by a processor, enables the processor to perform operations to generate the bitstream, wherein the operations comprise:
determining a prediction mode of a current block;
determining at least one context model according to the prediction mode of the current block;
determining a value of first syntax identification information, and performing binarization processing on the value of the first syntax identification information to determine a bin string of the current block, wherein the bin string comprises at least one binary symbol; and
encoding at least one binary symbol in the bin string according to the at least one context model, and signalling obtained encoded bits in the bitstream.
